(19) United States
(12) Patent Application Publication
(10) Pub. No.: US 2025/0378327 A1
(43) Pub. Date: Dec. 11, 2025

(54) SYSTEMS AND METHODS FOR DIRECTED OPTIMIZATION OF FIRST MACHINE LEARNING MODEL USING SECOND MACHINE LEARNING MODEL

(71) Applicant: Lukasz R. Kiljanek, Chesapeake Beach, MD (US)

(72) Inventor: Lukasz R. Kiljanek, Chesapeake Beach, MD (US)

(21) Appl. No.: 19/232,841

(22) Filed: Jun. 9, 2025

Related U.S. Application Data
(60) Provisional application No. 63/657,834, filed on Jun. 8, 2024.

(51) Int. Cl. G06N 3/08

(52) U.S. Cl. CPC G06N 3/08

(57) ABSTRACT

Systems and methods are disclosed for optimizing a first machine learning (ML) model using a second ML model. In some examples, a system generates modifications to the first ML model. Each of the modifications is associated with a respective node of the first ML model. The system tracks a processing characteristic corresponding to modified variants of the first ML model (corresponding to the modifications) processing a test dataset to generate respective results. In some examples, the system trains the second ML model based on context (the modifications and the respective changes). The system identifies, using the second ML model and based on the context (e.g., the training), a modification to the first ML model that adjusts the processing characteristic of the first ML model in a predetermined direction. The system modifies the first ML model according to the modification to generate a modified first ML model.

### CROSS-REFERENCE TO RELATED APPLICATIONS

The present application claims the priority benefit of U.S. provisional application No. 63/657,834 filed Jun. 8, 2024 and entitled “Improving generalization of neural network using drop-out organized with machine learning techniques and otherwise,” the disclosure of which is hereby incorporated by reference.

### TECHNICAL FIELD

This disclosure relates to optimizing a trained machine learning model using an artificial intelligence system, and more particularly, for systems using artificial intelligence algorithms to identify a modification to a trained machine learning model (e.g., dropping out a specific neuron or other unit) that improves a processing characteristic of the trained machine learning model (e.g., increase accuracy, decrease processing time) to optimize the trained machine learning model.

### BACKGROUND

Data platforms can include enormous volumes of data that can be difficult to parse through. Data platforms can be used to store sales data, health data, transaction data, location data, vehicle data, and/or other types of data. In some cases, data platforms can receive data continuously, and at a faster rate than any human could process such data.

Artificial intelligence (AI) refers to a class of computer algorithms that can process data and make intelligent decisions, for instance based on rules, heuristics, and/or prior learning. Machine learning (ML) models are a subset of AI algorithms. ML models learn how to process input datasets to generate desired output datasets based on training data, which can for instance include examples of appropriate output datasets for different possible input datasets. In some cases, ML models can continue to learn over time. Neural networks (NNs) are a type of ML model with interconnected layers of nodes (referred to as “neurons”) that are used to process information.

### SUMMARY

Systems and methods are disclosed for optimizing a first machine learning (ML) model (e.g., a neural network) using a second ML model. In some examples, an optimization system generates, during an exploration phase, a plurality of modifications to the first ML model (e.g., NN). Each of the plurality of modifications is associated with at least one respective unit (e.g., neuron, node, leaf, branch, layer) of the first ML model (e.g., NN). The optimization system tracks, during the exploration phase, one or more processing characteristics corresponding to a plurality of modified variants of the first ML model (e.g., NN) processing a test dataset to generate a plurality of respective results. Each of the plurality of modified variants of the first ML model (e.g., NN) corresponds to one of the plurality of modifications to the first ML model (e.g., NN). In some aspects, the optimization system trains the second ML model based on context (the plurality of modifications and the respective changes to the one or more processing characteristics). The optimization system identifies, using the second ML model and during an optimization phase and based on the context (e.g., based on the training of the second machine learning model), a modification to the first ML model (e.g., NN) that adjusts the one or more processing characteristics of the first ML model (e.g., NN) in a predetermined direction (e.g., to increase or decrease each of the one or more processing characteristics). The optimization system modifies the first ML model (e.g., NN) according to the modification to generate a modified first ML model (e.g., NN) for which the one or more processing characteristics are modified (e.g., improved) in the predetermined direction.

In an example, a method is provided for optimizing a first machine learning model using a second machine learning model. The method includes generating, during an exploration phase, a plurality of modifications to the first machine learning model. Each of the plurality of modifications is associated with at least one respective unit of the first machine learning model. The method includes tracking, during the exploration phase, respective changes to a processing characteristic corresponding to a plurality of modified variants of the first machine learning model processing a test dataset to generate a plurality of respective results. Each of the plurality of modified variants of the first machine learning model corresponds to one of the plurality of modifications to the first machine learning model. The method includes identifying, using a second machine learning model and during an optimization phase and based on context, a modification to the first machine learning model that adjusts the processing characteristic of the first machine learning model in a predetermined direction. The context is associated with the plurality of modifications and the respective changes to the processing characteristic. The method includes modifying the first machine learning model according to the modification to generate a modified first machine learning model.

In another example, a system is provided for optimizing a first machine learning model using a second machine learning model. The system includes a memory storing instructions and a processor that executes the instructions. Execution of the instructions by the processor causes the processor to perform operations. The operations include generating, during an exploration phase, a plurality of modifications to the first machine learning model. Each of the plurality of modifications is associated with at least one respective unit of the first machine learning model. The operations include tracking, during the exploration phase, respective changes to a processing characteristic corresponding to a plurality of modified variants of the first machine learning model processing a test dataset to generate a plurality of respective results. Each of the plurality of modified variants of the first machine learning model corresponds to one of the plurality of modifications to the first machine learning model. The operations include identifying, using a second machine learning model and during an optimization phase and based on context, a modification to the first machine learning model that adjusts the processing characteristic of the first machine learning model in a predetermined direction. The context is associated with the plurality of modifications and the respective changes to the processing characteristic. The operations include modifying the first machine learning model according to the modification to generate a modified first machine learning model.

In another example, a non-transitory computer readable storage medium is provided, having embodied thereon a program. The program is executable by a processor to perform a method of optimizing a first machine learning model using a second machine learning model. The method includes generating, during an exploration phase, a plurality of modifications to the first machine learning model. Each of the plurality of modifications is associated with at least one respective unit of the first machine learning model. The method includes tracking, during the exploration phase, respective changes to a processing characteristic corresponding to a plurality of modified variants of the first machine learning model processing a test dataset to generate a plurality of respective results. Each of the plurality of modified variants of the first machine learning model corresponds to one of the plurality of modifications to the first machine learning model. The method includes identifying, using a second machine learning model and during an optimization phase and based on context, a modification to the first machine learning model that adjusts the processing characteristic of the first machine learning model in a predetermined direction. The context is associated with the plurality of modifications and the respective changes to the processing characteristic. The method includes modifying the first machine learning model according to the modification to generate a modified first machine learning model.

In another example, a system is provided for optimizing a neural network using a machine learning model. The system includes means for receiving user data corresponding to a plurality of users. The system includes means for generating, during an exploration phase, a plurality of modifications to the first machine learning model. Each of the plurality of modifications is associated with at least one respective unit of the first machine learning model. The system includes means for tracking, during the exploration phase, respective changes to a processing characteristic corresponding to a plurality of modified variants of the first machine learning model processing a test dataset to generate a plurality of respective results. Each of the plurality of modified variants of the first machine learning model corresponds to one of the plurality of modifications to the first machine learning model. The system includes means for identifying, using a second machine learning model and during an optimization phase and based on context, a modification to the first machine learning model that adjusts the processing characteristic of the first machine learning model in a predetermined direction. The context is associated with the plurality of modifications and the respective changes to the processing characteristic. The system includes means for modifying the first machine learning model according to the modification to generate a modified first machine learning model.

This summary is not intended to identify key or essential features of the claimed subject matter, nor is it intended to be used in isolation to determine the scope of the claimed subject matter.

### BRIEF DESCRIPTION OF THE DRAWINGS

Illustrative embodiments of the present application are described in detail below with reference to the following figures:

FIG. 1 is a block diagram illustrating a process for optimizing a first machine learning model using a second machine learning model, in accordance with some examples;

FIG. 2 is a block diagram illustrating a system architecture of a machine learning model optimization system, in accordance with some examples;

FIG. 3 is a block diagram illustrating an example of a machine learning system for training, use of, and/or updating of one or more machine learning model(s) that are used to generate dropout configuration(s), parameter value(s), and/or predicted processing characteristic(s), in accordance with some examples;

FIG. 4 is a block diagram illustrating a RAG system that may be used to implement some aspects of the technology, in accordance with some examples.

FIG. 5 is a conceptual diagram illustrating a process for dynamically updating an output (that is generated using ML model(s)) in a continuous fashion as further data continues to be received over time, in accordance with some examples.

FIG. 6 is a flow diagram illustrating a process for neural network optimization, in accordance with some examples; and

FIG. 7 is a block diagram of an exemplary computing device that may be used to implement some aspects of the technology.

### DETAILED DESCRIPTION

Neural networks are an important type of machine learning (ML) model that is powerful and flexible, able to provide accurate results for a large number of applications, such as image recognition, natural language processing, and more. A neural network includes layers of interconnected nodes (referred to as neurons). Each connection represents a weight that is adjusted during the training process. Training a neural network involves using a dataset to adjust these weights so that the network can accurately predict outputs from given inputs

A significant challenge in training neural networks is overfitting. Overfitting refers to a model learning the detail and noise in its training data to an extent that it negatively impacts the performance of the model on new data. This is particularly problematic as networks become deeper and more complex. Techniques such as early stopping, regularization, and dropout can be used to reduce, prevent, or limit overfitting.

Dropout is traditionally performed randomly, and is therefore often referred to as random dropout. Random dropout involves randomly selecting neurons (e.g., a specific fraction or percentage of all neurons in a given layer) of a neural network, and disabling those selected neurons during training. Dropout can prevent complex co-adaptations on training data, which can lead to overfitting. Dropout can force the network to learn more robust features and improving generalization.

While random dropout can provide minor improvements to a neural network, random dropout applies a static, uniformly random rule that lacks adaptation to the individual characteristics of the data or network architecture. In contrast, systems and methods disclosed herein provide more sophisticated approaches that dynamically and intelligently manage dropout during the training of neural networks in a manner that is responsive to the specific learning context and the data being processed. The systems and methods disclosed herein produce more generalized and robust neural network models, leading to improved performance on unseen data. The systems and methods disclosed herein also intelligently identify parameters (and/or hyperparameters) to change and/or set. In these ways (and others discussed herein), the systems and methods disclosed herein can optimize a neural network (or other type of machine learning model) to improve performance of the neural network in processing characteristics and/or performance metrics such as accuracy, processing time, generalization error, energy efficiency, heat generation, other processing characteristics and/or performance metrics discussed herein, or combinations thereof.

Systems and methods are disclosed for optimizing a first machine learning (ML) model (e.g., a neural network) using a second ML model. In some examples, an optimization system generates, during an exploration phase, a plurality of modifications to the first ML model (e.g., NN). Each of the plurality of modifications is associated with at least one respective unit (e.g., neuron, node, leaf, layer) of the first ML model (e.g., NN). The optimization system tracks, during the exploration phase, one or more processing characteristics corresponding to a plurality of modified variants of the first ML model (e.g., NN) processing a test dataset to generate a plurality of respective results. Each of the plurality of modified variants of the first ML model (e.g., NN) corresponds to one of the plurality of modifications to the first ML model (e.g., NN). In some aspects, the optimization system trains the second ML model based on context (the plurality of modifications and the respective changes to the one or more processing characteristics). The optimization system identifies, using the second ML model and during an optimization phase and based on the context (e.g., based on the training of the second machine learning model), a modification to the first ML model (e.g., NN) that adjusts the one or more processing characteristics of the first ML model (e.g., NN) in a predetermined direction (e.g., to increase or decrease each of the one or more processing characteristics). The optimization system modifies the first ML model (e.g., NN) according to the modification to generate a modified first ML model (e.g., NN) for which the one or more processing characteristics are modified (e.g., improved) in the predetermined direction.

For instance, in some examples, the systems and methods disclosed herein use a trained machine learning model that intelligently selects a specific neuron, or set of neurons, of a machine learning model to drop out—and/or intelligently selects changes to certain parameters and/or hyperparameters—in order to improve the processing characteristic(s) (e.g., increase accuracy, decrease processing time, increase energy efficiency) of the neural network. The changes to parameters can be associated with specific neurons, layers, weights, features, outcomes, outcome labels, leaves, trees, and/or the machine learning model as a whole.

The systems and methods disclosed herein solve a number of technical problems, and provide a number of technical improvements. For instance, the systems and methods described herein can improve the efficiency and effectiveness of machine learning model's training by dynamically adjusting parameters in real-time. This approach reduces the need for extensive manual tuning and allows for more rapid convergence to optimal solutions. Additionally, by leveraging machine learning models to guide the optimization process, the systems can adapt to various types of machine learning models and tasks, ensuring broad applicability and scalability. This results in enhanced model performance, reduced computational costs, and the ability to achieve high accuracy with less data and fewer resources. Furthermore, by machine learning models to guide the optimization process, specific processing characteristics can be targeted for improvement and/or optimization (e.g., increase accuracy, decrease processing time, increase energy efficiency), which improves over less sophisticated techniques such as random dropout in which the effect on any given processing characteristic for any instance of random dropout is not predicted prior to dropout.

In some examples, the systems and methods disclosed herein optimize dropout in machine learning models to enhance model generalization and reduce overfitting, using a structured approach to intelligently manage the configuration and application of dropout and/or other parameters of training, and/or network architecture, during training.

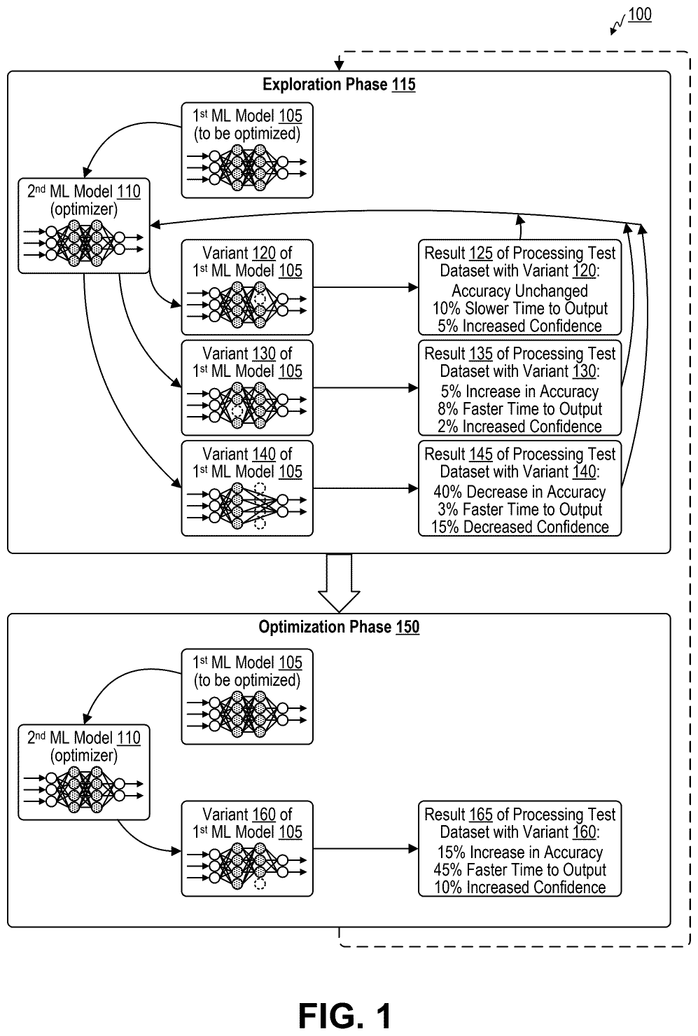

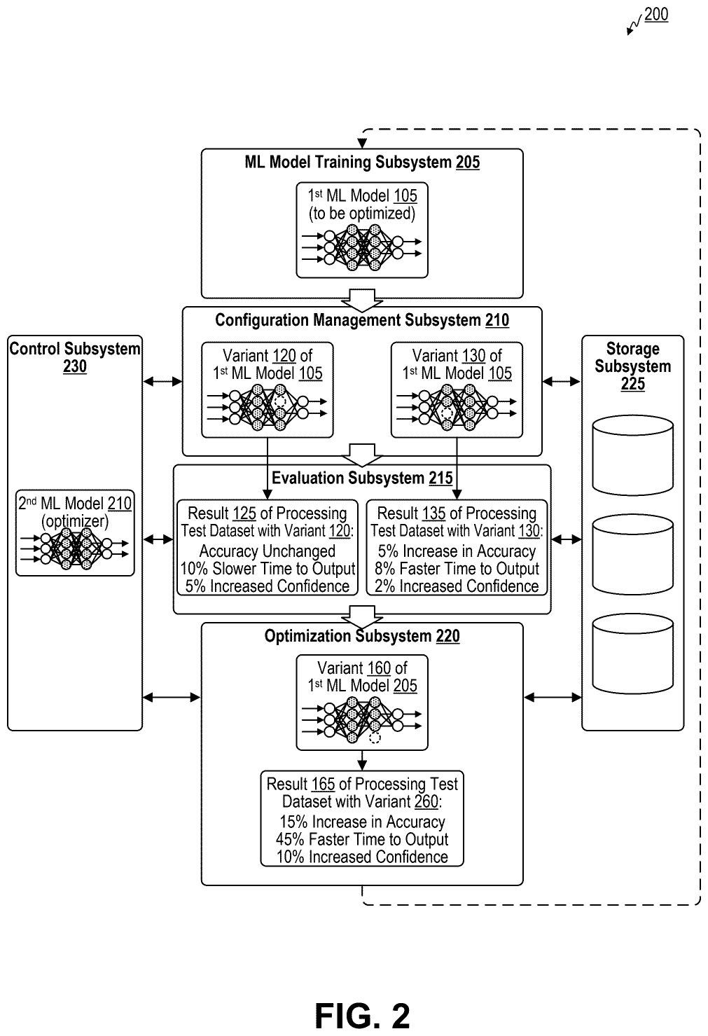

FIG. 1 is a block diagram illustrating a process 100 for optimizing a first machine learning model 105 using a second machine learning model 110. The process 100 includes an exploration phase 115 and an optimization phase 150. The process 100 is performed by a machine learning model optimization system, such as the machine learning model optimization system 200 of FIG. 2.

Within FIG. 1, graphics representing the first machine learning model 105 and the second machine learning model 110 each illustrate a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions. It should be understood that the illustrated architecture is illustrative. In some examples, the first machine learning model 105 and/or second machine learning model 110 can have a different structure and/or architecture, such as one or more trees, or other structures and/or architectures associated with other types of ML models discussed herein.

During the exploration phase 115, the machine learning model optimization system (e.g., machine learning model optimization system 200) can make various modifications to the first machine learning model 105 to generate various variants of the first machine learning model 105. The variants of the first machine learning model 105 include a variant 120 of the first machine learning model 105, a variant 130 of the first machine learning model 105, and a variant 140 of the first machine learning model 105. In some examples, the modifications can be identified by the second machine learning model 110. In some examples, the modifications can be identified and/or selected by the machine learning model optimization system (e.g., machine learning model optimization system 200) at random, for instance as in random dropout. During the exploration phase 115, the machine learning model optimization system can test each of the variants of the first machine learning model 105 by processing a test dataset using each of the variants of the first machine learning model 105, and comparing processing characteristics of each of the variants of the first machine learning model 105 against the processing characteristics of the first machine learning model 105 itself. The test dataset can be referred to as a validation dataset. For instance, the machine learning model optimization system can compare how quickly the variants of the first machine learning model 105 produced an output compared to the first machine learning model 105 itself; how accurate the outputs of the variants of the first machine learning model 105 are compared to the output of the first machine learning model 105 itself; how confident the variants of the first machine learning model 105 are in their respective outputs compared to the confidence of the first machine learning model 105 itself in its output(s); or a combination thereof.

The variant 120 of the first machine learning model 105 includes a single neuron (node) dropped out, illustrated as a dashed circle with no connections or weights. In particular, the variant 120 of the first machine learning model 105, as indicated in the graphic, has the second neuron (node) from the top in the second hidden layer dropped out. A neuron (node) being dropped out, means that the neuron (node) will not be used in training or taken into consideration, and/or it would have specified value (e.g., “NA” or not available, or 0 “zero”). The value, weights, and/or connections of the neuron (node) are ignored by the variant 120 of the first machine learning model 105. The impact of the neuron (node) on other neurons (nodes) is ignored. The machine learning model optimization system processes the test dataset using the variant 120 of the first machine learning model 105 and measures results 125 of the processing indicating that the accuracy of the variant 120 is unchanged compared to the first machine learning model 105, that the variant 120 was 10% slower (took 10% more time) to produce its output compared to the first machine learning model 105, and that the variant 120 had 5% increased confidence in its output compared to the confidence of the first machine learning model 105 in its output.

The variant 130 of the first machine learning model 105 includes a single neuron (node) dropped out, illustrated as a dashed circle with no connections or weights. In particular, the variant 130 of the first machine learning model 105, as indicated in the graphic, has the third neuron (node) from the top in the first hidden layer dropped out. The machine learning model optimization system processes the test dataset using the variant 130 of the first machine learning model 105 and measures results 135 of the processing indicating that the accuracy of the variant 130 is increased by 5% compared to the first machine learning model 105, that the variant 130 was 8% faster (took 8% less time) to produce its output compared to the first machine learning model 105, and that the variant 130 had 2% increased confidence in its output compared to the confidence of the first machine learning model 105 in its output.

The variant 140 of the first machine learning model 105 includes an entire layer of neurons (nodes) dropped out (e.g., so that for the output layer would ne receive inputs from first hidden layer, before the drooped-out layer) illustrated as a column of dashed circles with no connections or weights. In particular, the variant 140 of the first machine learning model 105, as indicated in the graphic, has the entire second hidden layer of neurons (nodes) dropped out. The machine learning model optimization system processes the test dataset using the variant 140 of the first machine learning model 105 and measures results 145 of the processing indicating that the accuracy of the variant 140 is decreased by 40% compared to the first machine learning model 105, that the variant 140 was 3% faster (took 3% less time) to produce its output compared to the first machine learning model 105, and that the variant 140 had 15% decreased confidence in its output compared to the confidence of the first machine learning model 105 in its output.

In some examples, dropout configuration and/or parameter configuration can be specific to one or more layers, features, and/or neurons. In this way, the drop out configuration or and/or parameter configuration need not be uniform across the whole first machine learning model 105—each neuron can have its own dropout (or activation) behavior, or any node or tree can have its own configurable (e.g., learnable optimal) behavior that can be learned as needed to optimize the first machine learning model 105 (e.g., and/or to optimize specific neurons, features, and/or layers of the first machine learning model 105). In an illustrative example, the 4^{th} neuron from the 2^{nd} layer can dropout ¼ and have a different activation function (e.g. linear) when it interacts with: the 2^{nd} neuron from 1^{st} layer and/or with the 2^{nd} output neuron, and different dropout (e.g., every 9^{th}) and have a another different activation function (Tanh) when it interacts with: the 1^{st} neuron from the 1^{st} layer and/or with the 1^{st} output neuron, and so on, with different functions and/or different neurons. In some examples, if the first machine learning model 105 is a random forest training algorithm, the 6^{th} level (by depth) nodes can use different parameters (e.g., min_samples_split-minimum amount of samples a node has to have before splitting) than the 2^{nd} level (by depth) nodes. The whole 5^{th} tree can have a different max_depth (maximal allowed depth for a tree to grow parameter) than the 1^{st} tree. For example, the feature “age” can behave as “dropped out” every time 5^{th} tree tries to use it, but can only drop out every 2^{nd} time every 10^{th} tree tries to use it.

During the exploration phase 115, the second machine learning model 110 receives and processes the results 125 of the variant 120 of the first machine learning model 105, the results 135 of the variant 120 of the first machine learning model 105, and the results 135 of the variant 120 of the first machine learning model 105 (in comparison with the results of the first machine learning model 105 without variants, not shown). Eventually, with enough experimental data, the second machine learning model 110 learns to predict what effect(s) different modifications to the first machine learning model 105 will have on different on processing characteristics of the first machine learning model 105.

Next, the process 100 transitions from the exploration phase 115 to the optimization phase 150, in which the second machine learning model 110 is used to make a modification that makes a specific optimization to the first machine learning model 105. The optimization phase 150 can also be referred to as the exploitation phase, in that the second machine learning model 110 exploits the knowledge and/or learning that the second machine learning model 110 obtained from the exploration phase 115 to identify a modification to make a specific (e.g., requested) change to the first machine learning model 105, for instance to improve a specific processing characteristic (e.g., to increase accuracy of output, to decrease processing time required to generate the output, and/or to increase confidence in the output).

For example, during the optimization phase 150 the second machine learning model 110 can be directed to generate a variant of the first machine learning model 105 that improves processing characteristics over the first machine learning model 105 itself—an increased accuracy and a faster time to output. The second machine learning model 110 can, based on its learnings from the exploration phase 115, identify a modification to the first machine learning model 105 that produces the variant 160 of the first machine learning model 105. The variant 160 of the first machine learning model 105 includes a single neuron (node) dropped out, illustrated as a dashed circle with no connections or weights. In particular, the variant 160 of the first machine learning model 105, as indicated in the graphic, has the fourth neuron (node) from the top in the second hidden layer dropped out. The machine learning model optimization system processes the test dataset using the variant 160 of the first machine learning model 105 and measures results 165 of the processing indicating that the accuracy of the variant 160 is improved (increased) by 15% compared to the first machine learning model 105, that the variant 160 was 45% faster (took 45% less time) to produce its output compared to the first machine learning model 105, and that the variant 160 had 10% increased confidence in its output compared to the confidence of the first machine learning model 105 in its output.

In some examples, the process 100 can restart after the optimization subsystem 220 identifies the variant 160 of the first machine learning model 105 as being a more optimized variant of the first machine learning model 105. For instance, the process 100 can return to the exploration phase 115, but this time with the variant 160 taking the place of the first machine learning model 105, with further exploration done using the variant 160 as a base. In this way, the machine learning model optimization system can identify a first optimization, then a second optimization that builds on the first optimization, then a third optimization that builds on the first and second optimizations, and so forth.

While the exploration phase 115 and the optimization phase 150 are illustrated as separate phases in FIG. 1, in some examples, the exploration phase 115 and the optimization phase 150 can overlap, and/or can happen at the same time. For example, in some examples, the process 100 can include iterations that include both the exploration phase 115 and the optimization phase 150, and can gradually shift from doing more exploration per iteration (and less optimization per iteration) to doing more optimization per iteration (and less exploration per iteration). For instance, in some examples, if the machine learning model optimization system 200 is optimizing 4 models and exploring for 3 models, then over time, the machine learning model optimization system 200 can shift more and more models from the exploration phase 115 to the optimization phase 150, until all of them are in the optimization phase 150 or have completed optimization (e.g., target thresholds for processing characteristics, like accuracy, have been reached or crossed). In some examples, the slope of increasing optimization and/or decreasing exploration is configurable (e.g., fully configurable). In an illustrative example, at a first stage, for first 10 iterations, the machine learning model optimization system 200 does only exploration (e.g., the exploration phase 115). At a second stage, for the next 10 iterations, the machine learning model optimization system 200 does 9 explorations (e.g., exploration phase 115) and 1 optimization (e.g., optimization phase 150). At a third stage, for the next 10 iterations, the machine learning model optimization system 200 does 8 explorations and 2 optimizations. At a fourth stage, for the next 10 iterations, the machine learning model optimization system 200 does 7 explorations and 3 optimizations—and so forth, until eventually, the machine learning model optimization system 200 does 1 exploration and 9 optimizations, or only optimizations (e.g., optimization phase 150). In some examples, the machine learning model optimization system 200 has an early stop to experimentation and/or optimization, for example if after 30 iterations, optimizations do not improve the accuracy by more than 10% within next 30 iterations, the machine learning model optimization system 200 can stop the process—or if the optimizations do not improve the accuracy by more than 10% within next 30 iterations, the machine learning model optimization system 200 can increase the frequency of exploration to 3 out of 10, and leave 7 out of 10 for optimization. In some examples, the machine learning model optimization system 200 can continue optimizing for a predefined amount of time, number of iterations, amount of energy consumed by model training, or a combination thereof (e.g., 200 iterations, 10 minutes, a specific amount of energy in kilowatt hours (KWH) or another energy unit, or a combination thereof).

Examples of activation functions include sigmoid functions, filters Rectified Linear Unit (ReLU) functions, leaky ReLU functions, parametric ReLU (PRELU) functions, softmax functions, swish (SiLU) functions, exponential linear unit (ELU) functions, gaussian error linear unit (GELU) functions, filters, or combinations thereof. In some examples, the second machine learning model 110 can optimize the activation functions of the first machine learning model 105, for instance by modifying parameters of the activation functions. For instance, for leaky ReLU functions, the second machine learning model 110 can modify the αmax (αx,x) parameter; for leaky ReLU or PRELU or ELU functions, the second machine learning model 110 can modify the aa parameter; and for swish (SiLU) functions, the second machine learning model 110 can modify the ββ parameter. The second machine learning model 110 can optimize these parameters in the first machine learning model 105 through backpropagation and/or other optimization techniques discussed herein (e.g., gradient descent) to minimize the loss function (e.g., generalization error). In some examples, the second machine learning model 110 (e.g., which may include Adam or SGD) updates the parameter in the direction that reduces the loss, similar to how weights are updated. After a number of iterations, the learnable parameters converge to values that help the network perform better on the task

FIG. 2 is a block diagram illustrating a system architecture of a machine learning model optimization system 200. The machine learning model optimization system 200 includes an ML model training subsystem 205. This subsystem handles the main architecture of the machine learning model (e.g., neural network) including multiple hidden layers where dropout can be applied. A similar approach can be used to optimize any parameter of any AI/ML algorithm. Referring back to the example illustrated in FIG. 1, the ML model training subsystem 205 can perform the initial training and generation of the first machine learning model 105.

The machine learning model optimization system 200 includes a configuration management subsystem 210 that manages the dropout process and/or parameter change process through the exploration of various dropout configurations and/or parameter configurations (e.g., during the exploration phase 115). For instance, referring back to the example illustrated in FIG. 1, in some examples, the configuration management subsystem 210 can be used to select modifications to the first machine learning model 105 to produce variants of the first machine learning model 105, such as the variant 120, the variant 130, and the variant 140.

The machine learning model optimization system 200 includes an evaluation subsystem 215 that assesses the impact of different dropout configurations and/or parameter configurations on model performance using a test dataset and/or validation dataset. For instance, the evaluation subsystem 215 can process the test dataset and/or validation dataset using the variant 120 of the first machine learning model 105, and can evaluate processing characteristics of how the variant 120 performed this processing, to produce the results 125. Similarly, the evaluation subsystem 215 can process the test dataset and/or validation dataset using the variant 130 of the first machine learning model 105, and can evaluate processing characteristics of how the variant 130 performed this processing, to produce the results 135. The evaluation subsystem 215 can also process the test dataset and/or validation dataset using the variant 130 of the first machine learning model 105, and can evaluate processing characteristics of how the variant 130 performed this processing, to produce the results 135.

The machine learning model optimization system 200 includes an optimization subsystem 220 that utilizes various optimization techniques such as Contextual Multi-Arm Bandit, Multi-Arm Bandit, Supervised Learning, Reinforcement Learning, Gradient Descent Optimization, Monte Carlo methods, and/or other techniques to find the optimal modifications to the first machine learning model 105 (e.g., the optimal dropout configuration and/or parameter configuration for the first machine learning model 105) to improve the first machine learning model 105 in one or more specific processing characteristics, in the optimization phase 150. For instance, referring back to the example illustrated in FIG. 1, the ML model training subsystem 205 can identify a modification to the first machine learning model 105 to generate the variant 160 of the first machine learning model 105. In some examples, the optimization subsystem 220 (e.g., in collaboration with the evaluation subsystem 215) can evaluate the variant 160 of the first machine learning model 105. For instance, the optimization subsystem 220 and/or the evaluation subsystem 215 can process the test dataset and/or validation dataset using the variant 160 of the first machine learning model 105, and can evaluate processing characteristics of how the variant 160 performed this processing, to produce the results 165, and can ensure that the results 165 indicate that the variant 160 shows an improvement in at least in the processing characteristics (e.g., that may be previously selected for optimization) over the first machine learning model 105.

The machine learning model optimization system 200 includes a storage subsystem 225 that stores the tested dropout configurations and/or parameter configurations (e.g., tested by the configuration management subsystem 210 and/or the evaluation subsystem 215) along with the corresponding performance metrics (e.g., accuracy of output, time to generate output, confidence in output, generalization error) from the evaluation phase (e.g., by the evaluation subsystem 215 and/or the optimization subsystem 220). In some examples, the storage subsystem 225 also stores the generated dropout configurations and/or parameter configurations (e.g., generated by the optimization subsystem 220 for the variant 160) along with the corresponding performance metrics (e.g., accuracy of output, time to generate output, confidence in output, generalization error) from the evaluation phase (e.g., the results 165). In some examples, the storage subsystem 225 includes, or otherwise has access to, one or more data stores, such as databases, tables, heaps, hashmaps, arrays, linked lists, stacks, queues, trees, graphs, tries, sets, tuples, queues, caches, records, or a combination thereof.

The machine learning model optimization system 200 includes a control subsystem 230 that interfaces with the configuration management subsystem 210, the evaluation subsystem 215, and/or the optimization subsystem 220 to adjust dropout configurations and/or parameter configurations dynamically based on predefined criteria or performance thresholds. In some examples, the control subsystem 230 includes a second trained machine learning model, such as the second machine learning model 110 of FIG. 1.

In some examples, the first machine learning model 105 is a neural network. In such examples, the ML model training subsystem 205 handles the main architecture of the neural network, including multiple hidden layers where dropout can be applied. In some examples, the ML model training subsystem 205 controls the core architecture of the neural network (e.g., the first machine learning model 105), which includes one or more hidden layers where adaptive dropout techniques or configurations and/or parameter configurations are systematically integrated. The ML model training subsystem 205 dictates the structural design, learning mechanisms, and dynamic modification of dropout configurations and/or parameter configurations during the training process.

In some examples, the neural network (e.g., the first machine learning model 105) includes an input layer, multiple hidden layers, and an output layer. The number, type, and size of these layers are designed based on the specific requirements of the application (e.g., image recognition, natural language processing). Each layer utilizes appropriate activation functions like Rectified Linear Unit (ReLU), Sigmoid, or Tanh to introduce non-linearity into the learning process, aiding in complex pattern recognition. In some examples, initially, a dropout configurations (e.g., random dropout) technique and/or parameter configurations is implemented (e.g., by the machine learning model optimization system 200) where individual neurons in a layer are randomly dropped (made inactive) during training to prevent overfitting. This dropout rate is adjustable and can be modified dynamically in subsequent processes. Information on which neurons are dropped-out is referred to as the dropout configuration.

The machine learning model optimization system 200 can change parameter configurations (e.g., sets of values for the various parameters and/or hyperparameters of the first machine learning model 105). For instance, the machine learning model optimization system 200 can change parameters such as, for instance, temperature (e.g., influencing level creativity and/or randomness), top P (e.g., influencing level creativity and/or randomness), frequency penalty (e.g., to prevent repetitive language between one of the output(s) and another), presence penalty (e.g., to encourage the first machine learning model 105 to introduce new data in its output(s)), learning rate, activation type, regularization type, regularization strength, number of iterations, maximum threshold number of iterations, tolerance values, selection strategies, kernel types, weight types, other types of parameters and/or hyperparameters discussed herein, or a combination thereof.

The ML model training subsystem 205 can train the first machine learning model 105 through a number of learning mechanisms. In some cases, the learning mechanisms can also be used by other subsystems of the machine learning model optimization system 200, such as the configuration management subsystem 210, the evaluation subsystem 215, the optimization subsystem 220, and/or the control subsystem 230. The learning mechanisms can include forward propagation. Under forward propagation, input data passes through the network from the input layer to the output layer. At each hidden layer, dropout masks (e.g., randomly chosen subsets of active neurons, as in random dropout) and/or dropout configurations (e.g., not random dropout) techniques and/or parameter configurations can be used to modify the layer output. The learning mechanisms can include feed-forward looping, backpropagation, and optimization, under which errors between predicted and actual outputs are computed and propagated back through the network to adjust weights. The ML model training subsystem 205 uses optimizer function(s), such as Stochastic Gradient Descent (SGD), Adaptive Moment Estimation (Adam), and/or Root Mean Square Propagation (RMSprop), to minimize loss functions, with considerations for the impact of dropout masks. The learning mechanisms can include dynamic dropout modification and/or parameter modification. Based on evaluation metrics (e.g., generalization error) or specific criteria set forth in the optimization algorithms (e.g., Contextual Multi-Arm Bandit or Monte Carlo methods), the dropout rate and pattern (and/or parameter configurations) are dynamically adjusted-either increasing complexity or simplification, depending on the modeled system feedback. In some cases, some of the learning mechanisms (e.g., dynamic dropout modification, dynamic parameter modification) can be employed by the optimization subsystem 220, at the optimization phase 150.

The machine learning model optimization system 200 (e.g., the optimization subsystem 220 and/or the control subsystem 230) can provide adaptive dropout techniques and/or adaptive parameter change techniques. These adaptive dropout techniques and/or adaptive parameter change techniques include context-sensitive dropout adaptation and/or context-sensitive parameter adaptation. In some examples, the machine learning model optimization system 200 (e.g., the optimization subsystem 220 and/or the control subsystem 230) can incorporate one or more trained ML models (e.g., the second machine learning model 110) that help select a dropout configuration and/or parameter configuration for the first machine learning model 105. In some examples, the trained ML models (e.g., the second machine learning model 110) that help select a dropout configuration and/or parameter configuration for the first machine learning model 105 can include a Contextual Multi-Arm Bandit model that dynamically adjusts dropout configurations and/or parameter configurations for the first machine learning model 105 based on currently dropped-out neurons, current parameter configurations and/or inputs, external contexts like epoch number, batch identity, step, iteration, cycle, and/or round, and/or requests indicating which processing characteristic are to be optimized. For instance, the processing characteristic (or performance metric) to be modified can include accuracy, time to generate output, confidence, generalization error, heat generation, power usage, need for heat dissipation (e.g., heatsinks, fans, or other coolers), fan speed, longevity of equipment (e.g., drives, RAM, ROM, GPU, CPU, cores), specific desired load for processing elements (e.g., cores, CPU, GPU), memory use, hard drive write or read rate, hard drive errors, RAM errors, number of cores (e.g., CPU and/or GPU) needed, number of files saved to and/or read from storage, time of training, loss, area under the curve (AUC), other accuracy measures, sensitivity, specificity, false positives, false negatives, learning rate, context length, accuracy in long context (e.g. for LLM, transformers, autoencoders, GANs), accuracy in short context (e.g., for LLM, transformers, autoencoders, GANs), accuracy evaluated for a specific type of length of context (e.g., for LLM, transformers, autoencoders, GANs), GAN rejection rate, GAN rejection instances, other processing characteristics or performance metrics discussed herein, or a combination thereof. This contextual sensitivity enhances learning efficiency by adapting dropout configurations and/or parameter configurations to specific training scenarios and to given production scenarios, as feedback from production, for example energy consumption, can also be used to optimize training of 105// by 110//.

The adaptive dropout techniques and adaptive parameter change techniques provided by the machine learning model optimization system 200 (e.g., the optimization subsystem 220 and/or the control subsystem 230) can be based on learning from experience. The machine learning model optimization system 200 leverages reinforcement learning (RL), Contextual Multi-Arm Bandit, Multi-Arm Bandit, Supervised Learning, Reinforcement Learning, Gradient Descent Optimization, Monte Carlo methods, and/or other types of models, as examples, using learning and/or training techniques such as supervised learning, unsupervised learning, and/or semi-supervised learning to learn optimal dropout configurations and/or parameter configurations over time, for instance over the course of the exploration phase 115. For instance, in some examples, using a Q-learning framework, the machine learning model optimization system 200 iteratively refines the probability of dropping out particular neurons based on the historical success rates recorded in achieving lower generalization errors, improved accuracy, improved speed of generating outputs, and/or other optimizations and/or improvements.

The adaptive dropout techniques and/or adaptive parameter change techniques provided by the machine learning model optimization system 200 (e.g., the optimization subsystem 220 and/or the control subsystem 230) can include predictive dropout orchestration and/or predictive parameter change orchestration. In some examples, the machine learning model optimization system 200 (e.g., the optimization subsystem 220 and/or the control subsystem 230) can use techniques such decision trees and/or auxiliary neural networks, to predict the most effective dropout patterns and/or parameter configurations before applying them, based on previous training and/or feedback loops. In some examples, the machine learning model optimization system 200 can use these techniques to predict the generalization error for some dropout configurations and/or parameter configurations, and forgo testing for dropout configurations and/or parameter configurations which are less likely to be provide generalization.

The adaptive dropout techniques and/or adaptive parameter change techniques provided by the machine learning model optimization system 200 (e.g., the optimization subsystem 220 and/or the control subsystem 230) can undergo continuous evaluation and/or adjustment. In some examples, at periodic intervals, the machine learning model optimization system 200 assesses if the dynamic adaptations systematically improve model robustness against overfitting (e.g., reduce generalization error, heat generation, power usage, increase accuracy, reduce time to generate output, increase confidence), by comparing with a validation set. In some examples, the machine learning model optimization system 200 can make adjustments to dropout patterns are based on predefined performance thresholds regarding improvements in accuracy or generalization errors.

The machine learning model optimization system 200 (e.g., the ML model training subsystem 205, evaluation subsystem 215, the optimization subsystem 220, and/or the control subsystem 230) make use of several types of evaluation Metrics and stopping criteria in training, modifying, and/or optimizing the first machine learning model 105. In some examples, for instance, the machine learning model optimization system 200 uses specific metrics such as accuracy, loss, generalization error, heat generation, power usage, and the F1 score for performance evaluation. The machine learning model optimization system 200 employs various stopping criteria (e.g., thresholds) for these metrics, which the machine learning model optimization system 200 can set to limit or cease dropout adjustments and/or parameter adjustments when marginal gains fall below a designated threshold, when loss or error exceeds a loss threshold, and/or when the relative improvement meets a threshold corresponding to strategic objectives (e.g., for learning and/or model optimization). In some examples, the machine learning model optimization system 200 can restart the dropout adjustments and/or parameter adjustments to perform multiple rounds of optimizations. The restarting could be triggered by an operator (user) through an interactive user interface, on demand; automatically when conditions change or reach a threshold (e.g., new data, different GPUs, different RAM, different power usage conditions, different electricity price), when accuracy is low (e.g., below a threshold) and needs to be improved, when the system takes too long to produce an output (e.g., more than a threshold amount of time), when error increases (e.g., above a threshold), or a combination of.

The machine learning model generation, training, and optimization process performed by the machine learning model optimization system 200 includes a number of operations. These operations include initialization, in which the ML model training subsystem 205 sets the initial conditions, hyperparameters, and dropout settings for an ML model (e.g., a neural network). This includes initializing historical data storage for recording dropout trials and parameter changes, and related metrics. The training cycle begins with the ML model training subsystem 205 performing a model training process, where during each epoch, batch, step, iteration, cycle, stage, round, and/or time unit, the ML model training subsystem 205 applies a specific dropout configuration and/or parameter configuration to various layers based on instructions (e.g., from the configuration management subsystem 210, the optimization subsystem 220, and/or control subsystem 230). The ML model training subsystem 205 perform training operations, which can include forward propagation and/or backward propagation, with the applied dropout settings and/or parameter changes. In some examples, each of the steps or cycles can include a cross validation fold.

After completing each training epoch, batch, step, iteration, cycle, stage, round, and/or time unit, the evaluation subsystem 215 tests the model by having the model process a test dataset and/or validation dataset to determine performance metrics and/or processing characteristics such as generalization error, heat generation, power usage, accuracy, time to generate output, confidence, need for heat dissipation (e.g., heatsinks, fans, or other coolers), fan speed, longevity of equipment (e.g., drives, RAM, ROM, GPU, CPU, cores), specific desired load for processing elements (e.g., cores, CPU, GPU), memory use, hard drive write or read rate, hard drive errors, RAM errors, number of cores (e.g., CPU and/or GPU) needed, number of files saved to and/or read from storage, time of training, loss, area under the curve (AUC), other accuracy measures, sensitivity, specificity, false positives, false negatives, learning rate, context length, accuracy in long context (e.g. for LLM, transformers, autoencoders, GANs), accuracy in short context (e.g., for LLM, transformers, autoencoders, GANs), accuracy evaluated for a specific type of length of context (e.g., for LLM, transformers, autoencoders, GANs), GAN rejection rate, GAN rejection instances, other processing characteristics or performance metrics, or combinations thereof. The results of the dropout configuration and/or parameter configuration, along with the performance metrics and/or processing characteristics, are stored in the storage subsystem 225. The optimization subsystem 220 then reviews historical data and current performance to suggest an optimized dropout configuration and/or an optimized parameter configuration. Optimization strategies used by the optimization subsystem 220 can include a Contextual Multi-Arm Bandit approach, which uses context such as epoch count, batch identifier, step number, iteration number, cycle number, and/or round number, and previous dropout configurations and/or parameter configurations to probabilistically select the most promising dropout settings and/or parameter values. Optimization strategies used by the optimization subsystem 220 can include supervised machine learning approaches, for instance by training models like Random Forests or Neural Networks on historical data, and predicting the most effective dropout configurations and/or parameter configurations based on training context. In some examples, the optimization subsystem 220 can predict the generalization error for some dropout configurations and/or parameter configurations, and forgo testing for dropout configurations and/or parameter configurations which are less likely than a threshold to provide desired performance metrics and/or processing characteristics (e.g., predicted to have less than a threshold probability of providing values for performance metrics and/or processing characteristics that improve over the first machine learning model 105). Optimization strategies used by the optimization subsystem 220 can include reinforcement learning techniques, like Q-learning, which the optimization subsystem 220 can apply to adaptively modify dropout configuration and/or parameter configurations to maximize a reward function defined in terms of model performance on the validation dataset.

The optimization subsystem 220 can adjust dropout configurations and/or parameter configurations dynamically. For instance, in some examples, the optimization subsystem 220 can modify dropout configurations and/or parameter configurations based on recommendations from the optimization subsystem. The changes to the dropout configurations and/or parameter configurations can be implemented (e.g., by the ML model training subsystem 205) for subsequent epochs, batches, steps, iterations, cycles, samples, features, and/or rounds of the ML model (e.g., subsequent epochs, batches, steps, iterations, cycles, samples, features, and/or rounds can stem from the variant 160 of the first machine learning model 105). The process of optimizing dropout and/or parameters can be terminated when specific conditions are met, such as when the improvement in generalization error, heat generation, power usage, accuracy, time to output, confidence, need for heat dissipation (e.g., heatsinks, fans, or other coolers), fan speed, longevity of equipment (e.g., drives, RAM, ROM, GPU, CPU, cores), specific desired load for processing elements (e.g., cores, CPU, GPU), memory use, hard drive write or read rate, hard drive errors, RAM errors, number of cores (e.g., CPU and/or GPU) needed, number of files saved to and/or read from storage, time of training, loss, area under the curve (AUC), other accuracy measures, sensitivity, specificity, false positives, false negatives, learning rate, context length, accuracy in long context (e.g. for LLM, transformers, autoencoders, GANs), accuracy in short context (e.g., for LLM, transformers, autoencoders, GANs), accuracy evaluated for a specific type of length of context (e.g., for LLM, transformers, autoencoders, GANs), GAN rejection rate, GAN rejection instances, other processing characteristics or performance metrics (e.g., assessed between intervals (e.g., epochs, batches, steps, iterations, cycles, samples, features, and/or rounds) and/or between ranges such as comparison with a minimum threshold and a target threshold), or a combination thereof. Upon meeting stopping criteria, the model training is finalized with the best dropout configuration and/or parameter configuration (e.g., the variant 160 of the first machine learning model 105), and the final model performance is validated on an independent test set. Finally, the machine learning model optimization system 200 deploys the optimized model (e.g., the variant 160 of the first machine learning model 105) into production or other real-world applications.

In some examples, the machine learning model optimization system 200 can stop exploring and/or optimizing manually and/or automatically. For instance, in some examples, if any of the processing characteristics (e.g., accuracy, processing time, generalization error, an outcome statistical measure, or a combination thereof) do not improve (or improve by less than a threshold amount) in the next N steps, rounds, iterations, batches, epochs, and/or stages—and/or if the machine learning model optimization system 200 receives an input through an interactive user interface-then the machine learning model optimization system 200 can stop exploring and/or optimizing further—and/or increase or decrease frequency of optimizing actions and/or decrease frequency of exploration actions.

In some examples, the machine learning model optimization system 200 can restart the model optimization process (e.g., process 100) after the optimization subsystem 220 identifies the variant 160 of the first machine learning model 105 as being a more optimized variant of the first machine learning model 105. For instance, the machine learning model optimization system 200 can return to the configuration management subsystem 210 (e.g., to restart the exploration phase 115), but this time with the variant 160 taking the place of the first machine learning model 105, with further exploration done using the variant 160 as a base. In this way, the machine learning model optimization system 200 can identify a first optimization, then a second optimization that builds on the first optimization, then a third optimization that builds on the first and second optimizations, and so forth.

The configuration management subsystem 210 is a component of the machine learning model optimization system 200 that intelligently manages and controls the application of dropout and/or parameter changes within a neural network during training. In the similar way any other ML model can be optimized. The configuration management subsystem 210 enhances the robustness and generalization capabilities of the ML model (e.g., neural network) that is to be optimized by systematically exploring and implementing various dropout configurations and/or parameter configurations across different layers and neurons.

The configuration management subsystem 210 can perform a number of operations. For instance, the configuration management subsystem 210 can implement a variety of dropout schemes and/or parameter configurations dynamically across different layers of the ML model (e.g., neural network) that is to be optimized. The configuration management subsystem 210 can coordinate with the evaluation subsystem 215 to receive feedback on the performance impact of different dropout configurations and/or parameter configuration or manual feedback from the operator (e.g., “I need even shorter time of execution, please optimize for shorter time of training or testing.”, “I need higher accuracy, please optimize for accuracy on validation or training datasets,” or any specified cost function being a function of time, amount of heat generated, accuracy loss, energy used and other processing characteristics). The processing characteristics can be referred to as performance metrics, processing metrics, performance parameters, processing parameters, or a combination thereof. The configuration management subsystem 210 can interact with the optimization subsystem 220 to refine and select optimal dropout patterns and/or parameter configuration based on the advanced optimization algorithms.

In some examples, the configuration management subsystem 210 can configure dropout rates and patterns, and/or changes to parameters, dynamically for each layer in the ML model (e.g., neural network) to be optimized (e.g., the first machine learning model 105). The configuration management subsystem 210 supports both random and systematic approaches to modifying dropout configurations and/or parameter configurations. This includes the capability to employ random dropout where dropout rates and affected neurons are randomly selected, and./or to randomly select values for parameters (or for changes to parameters). This also includes the capability to employ sequential exploration of dropout configurations and/or parameter configurations, systematically testing all possible combinations.

The configuration management subsystem 210 can use contextual adaptation. Leveraging contextual information such as current dropout configurations and/or parameter configurations, epoch number, batch number, step number, iteration number, cycle number, and/or round number, and prior performance metrics, the configuration management subsystem 210 adjusts dropout configurations and/or parameter configurations to best suit the training stage and observed network behavior. This adaptive approach helps in fine-tuning the dropout process and/or parameter change process to avoid overfitting, while promoting better generalization, higher accuracy, and reduced time to generate the output and/or optimizing other processing characteristics.

The configuration management subsystem 210 integrates with multiple optimization frameworks. These optimization frameworks include, for example, Contextual Multi-Arm Bandit, where dropout configurations and/or parameter configurations are treated as arms and the training context (e.g., batch number, epoch, step number, round number, iteration number) influences the arm selection. These optimization frameworks also include supervised learning models that predict the performance of dropout configurations and/or parameter configurations based on historical data. These optimization frameworks also include reinforcement learning, where the configuration management subsystem 210 learns the most effective dropout policies and/or parameter change policies through trial and error, guided by performance, processing characteristics and/or performance metrics (e.g., accuracy, speed, energy used), or loss function, or operator feedback.

The configuration management subsystem 210 can implement pre-determined dropout strategies, customized dropout strategies, pre-determined parameter change strategies, customized parameter change strategies, or a combination thereof. Aside from implementing predetermined dropout and parameters configurations and/or traditional dropout (e.g., random dropout) and parameters techniques, the configuration management subsystem 210 can generate custom dropout and parameters strategies. These can be based on specific patterns or ratios of units to be affected (e.g., of neurons, input features (as input data), output neurons, and/or entire layers to drop out), or sequence (e.g. per network, per node, per layer, per neuron, per feature, per weight, per tree, per leaf) applied during time units, including, but not limited, to steps, rounds, batches, epochs, iterations, intensity of dropout (e.g., high dropout rates in certain training phases such as early training phases and/or in certain layers, low dropout rates in certain training phases such as later training phases and/or in certain layers). These can lead to, for example, specific percentages or ratios of neurons in certain layers to be dropped out, and/or focused dropout application on layers that are more prone to overfitting.

The configuration management subsystem 210 can modify the ML model (e.g., neural network) using performance-driven updates. In some examples, the configuration management subsystem 210 updates dropout configurations and/or parameter configurations in real-time, driven by continuous performance assessments from the evaluation subsystem 215. In some examples, the configuration management subsystem 210 ensures that only effective dropout patterns and/or parameter configurations (e.g., dropout patterns and/or parameter configurations that improve a processing characteristic and/or performance metric) are used to improve the model throughout the training process.

In some examples, at the start of training, the configuration management subsystem 210 initializes with pre-defined or heuristic-based dropout configurations and/or parameter configurations. During training, the configuration management subsystem 210 applies certain dropout configurations and/or parameter configurations, which may be predetermined, randomly determined, and/or selected by the configuration management subsystem 210 because they are different from previously-tested configurations, and monitors their impact (e.g., their processing characteristics and/or performance metrics) using data from the evaluation subsystem 215 (e.g., the result 125 for the variant 120, the results 135 for the variant 130, and/or the results 145 for the variant 140).

In some examples, the configuration management subsystem 210 incorporates feedback. For instance, using feedback on model accuracy and/or generalization errors, the configuration management subsystem 210 adjusts the dropout configuration and/or other model parameters, striving for optimal balance between network complexity and training depth. In some examples, based on the performance data (e.g., the processing characteristics and/or performance metrics of the model variants as tracked by the evaluation subsystem 215), the configuration management subsystem 210 interacts with the optimization subsystem 220 to explore alternative configurations and to validate the efficacy of new dropout schemes and/or parameter configurations via simulations or historical data comparisons. In some examples, the configuration management subsystem 210 stores all tested and current dropout configurations and/or parameter configurations, along with their processing characteristics and/or performance metrics, and other contextual variables, using the storage subsystem 225 for future reference and analysis.

The evaluation subsystem 215 assesses the effectiveness of various dropout configurations and/or parameter configurations applied by the configuration management subsystem 210. The evaluation subsystem 215 evaluates the impact of the dropout configurations—and/or changes to parameters-on the performance of the ML model (e.g., neural network) that is to be optimized, particularly focusing on enhancing generalization, minimizing overfitting, improving (increasing) accuracy, improving speed (reducing time to generate outputs), improving (increasing) confidence, or a combination thereof.

The evaluation subsystem 215 calculates performance metrics such as generalization error, heat generation, power usage, accuracy, time to generate outputs, and/or the model's confidence in its outputs. In some examples, the evaluation subsystem 215 uses a separate, well-curated validation dataset that is not used in the training phase to ensure unbiased evaluation of the model's performance. Metrics are calculated after the model has been trained and/or modified with a specific dropout configuration and/or parameter configuration (e.g., calculating metrics for the variant 120, the variant 130, and the variant 140). In some examples, the loss function can be a function of heat generation, cost of training, time of training, longevity of equipment use, accuracy, and/or generalization (e.g., generalization error).

In some examples, the evaluation subsystem 215 uses a statistical analysis framework, for instance by employing statistical methods to ensure the reliability of the results. For instance, the evaluation subsystem 215 can employ techniques such as confidence interval calculation, hypothesis testing, or Analysis of Variance (ANOVA) to assess the statistical significance of observed performance differences across various configurations.

In some examples, the evaluation subsystem 215 can include a dynamic feedback mechanism. For instance, in some examples, based on the performance metrics, the evaluation subsystem 215 can provide feedback to the optimization subsystem 220. This feedback is crucial for adjusting the training process dynamically. For instance, if a particular dropout configuration and/or parameter configuration consistently results in lower generalization errors and/or increased accuracy, the optimization subsystem 220 can prioritize similar configurations in future training iterations.

In some examples, the evaluation subsystem 215 can implement real-time monitoring to track the model's performance over time (e.g., as the model, or variant thereof, continues to process different datasets over time). This can help in detecting any drifts in data or model performance, ensuring that the model remains robust in changing conditions.

In some examples, the first machine learning model 105 can be a production model (e.g., already in deployment), and the second machine learning model 110 can optimize processing characteristics associated with production in the first machine learning model 105. For example, the second machine learning model 110 can optimize processing characteristics in the first machine learning model 105 such as, for instance, time needed for predicting outcomes, energy consumption for model to predict outcomes, to be loaded, the size (e.g., in kilobytes) of the production model, the memory consumption of production model, the feedback and user satisfaction, the hallucinations. In some examples, these processing characteristics can be used as feedback to the second machine learning model 110 to optimize the first machine learning model 105. In some examples, the second machine learning model 110 can optimize for both processing characteristics associated with training and processing characteristics associated with production.

In some examples, the evaluation subsystem 215 incorporates criteria for model selection that take into account not only accuracy and error rates but also model complexity. This allows for balancing between model simplicity (to avoid overfitting) and performance.

In some examples, the evaluation subsystem 215 performs threshold-driven evaluation. For instance, by employing predefined thresholds for comparison against the performance metrics (or processing characteristics), the evaluation subsystem 215 can trigger alerts or actions (e.g., when a performance metric or processing characteristic reaches or crosses a threshold). For instance, if the generalization error decreases below a threshold, or the accuracy increases above a threshold, the evaluation subsystem 215 can request that the configuration management subsystem 210 try dropout configurations and/or parameter configurations with similar characteristics (e.g., dropping out nearby neurons that are adjacent to or otherwise close to a neuron dropped out in the current dropout configuration, dropping out neurons in the same layer as a neuron dropped out in the current dropout configuration, dropping out neurons that are directly connected or coupled to a neuron dropped out in the current dropout configuration, changing the same parameter that was previously changed, changing similar parameters to parameters that were previously changed, making a similar type of change to one or more parameters as a previous type of change, or a combination thereof). On the other hand, if the generalization error increases beyond a certain threshold, or the accuracy decreases below a certain threshold, the evaluation subsystem 215 can prompt a re-evaluation of the dropout configurations, halt further training until the issue is resolved, or request that the configuration management subsystem 210 try dropout configurations and/or parameter configurations with different characteristics (e.g., dropping out neurons that are farther away from a neuron dropped out in the current dropout configuration, dropping out neurons in different layers than a neuron dropped out in the current dropout configuration, dropping out neurons that are not directly connected or coupled to a neuron dropped out in the current dropout configuration, changing a different parameter than was previously changed, changing different types of parameters compared to parameters that were previously changed, making a different type of change (e.g., in a different direction) to one or more parameters than a previous type of change, or a combination thereof).

In some examples, the evaluation subsystem 215 has an automated reporting system. For instance, in some examples, the evaluation subsystem 215 automatically generates detailed reports (e.g., results 125, results 135, results 145) that document every tested configuration and their corresponding results. These reports can be accessed by the control subsystem 230 to provide insights into performance trends and guide strategic decisions (e.g., selection of other dropout configurations and/or parameter configurations in the exploration phase 115 and/or in the optimization phase 150).

The evaluation subsystem 215 is scalable, supporting different neural network architectures and sizes, making it suitable for a variety of applications. The focus on generalization ensures that the assessed performance closely estimates how the model will perform in real-world scenarios outside the validation set. In some examples, the evaluation subsystem 215 subsystem employs a holistic framework incorporating statistical analysis, real-time monitoring, feedback mechanisms, and automated reporting. This approach not only enhances the precision of dropout configuration assessment and/or parameter configuration assessment, but also contributes to the iterative improvement of the ML model (e.g., neural network) being optimized (e.g., first machine learning model 105).

The optimization subsystem 220 iteratively refines dropout configurations and/or parameter configurations to enhance model performance. In doing so, the optimization subsystem 220 systematically determines the dropout configuration and/or parameter configuration (e.g., variant 160) that yields the highest generalization ability of the ML model (e.g., neural network) (e.g., first machine learning model 105), thereby minimizing overfitting while optimizing predictive accuracy on new, unseen data.

In some examples, the optimization subsystem 220 integrates a Contextual Multi-Arm Bandit approach that treats each potential dropout configuration and/or parameter configuration as an ‘arm’ of a bandit. The ‘context’ is provided by parameters such as the current epoch count, batch identifier, step number, iteration number, cycle number, and/or round number, and specifics of the dropout and/or parameter values being used (e.g., which inputs are dropped). The optimization subsystem 220 uses this information to adaptively select configurations that seem to offer a balance between exploring new configurations and exploiting known to perform well configurations under similar circumstances.

In some examples, the optimization subsystem 220 integrates a supervised learning with contextual information approach in which the optimization subsystem 220 uses historical data from previous trials (e.g., dropout configurations and/or parameter configurations and their outcomes) to train an optimizer model (e.g., the second machine learning model 110), such as a random forest or a neural network, to predict the performance of future dropout configurations for the model being optimized (e.g., the first machine learning model 105). Inputs to the optimizer model can include features derived from the training context, including epoch number, batch number, step number, iteration number, cycle number, and/or round number, and/or specifics of the dropout configuration and/or parameter configuration. In some examples, the optimization subsystem 220 can improve the architecture of an ML model (e.g., first machine learning model 105), for instance to improve the size (e.g., number of neurons, nodes, layers) of the ML model.

In some examples, the optimization subsystem 220 integrates a reinforcement learning (RL) approach in which the dropout configurations and/or parameter configurations are treated as actions taken by an agent (the optimization subsystem 220) in a state (e.g., defined by the current status of neural network training). The reward is defined based on the performance improvement on the validation dataset. Methods like Q-learning or policy optimization can be applied to make decisions on which dropout configuration and/or parameter configuration to try next based on past experiences.

In some examples, the optimization subsystem 220 integrates gradient descent optimization approach. For instance, in some examples, gradient descent optimization can be adapted (as used by optimization subsystem 220) to refine continuous parameters of a dropout strategy (e.g., dropout rates) and/or a parameter change strategy (e.g., which parameters to change and by how much) by treating the generalization error as a loss function and iteratively adjusting dropout probabilities and/or parameter change probabilities using gradient-based methods.

In some examples, the optimization subsystem 220 integrates Monte Carlo methods in which the optimization subsystem 220 probabilistically evaluates and optimizes the expected outcome of different dropout configurations over many simulated runs, providing robust statistical insights into which configurations perform best across a wide range of possible scenarios.

The optimization subsystem 220 identifies (e.g., predicts and/or selects) the most promising dropout configuration and/or parameter configuration to apply in the next training epoch, batch, step, iteration, cycle, stage, round, and/or other units, based on the current state and historical performance data. In some examples, the optimization subsystem 220's decision-making process includes the optimization subsystem 220 generating predictions (e.g., using the second machine learning model 110). For instance, based on current and prior data, the optimization subsystem 220 can generate predictions about potential performance metrics for different configurations (e.g., using supervised learning models). In some examples, the optimization subsystem 220's decision-making process includes the optimization subsystem 220 evaluating trade-offs. For instance, in some examples, the optimization subsystem 220 can (e.g., using a Multi-Arm Bandit approach), balance the trade-off between exploring new configurations and exploiting known successful ones. In some examples, the optimization subsystem 220's decision-making process includes continuous learning by the optimization subsystem 220. For instance, the optimization subsystem 220 can continuously update the optimizer model (e.g., reinforcement learning model or supervised learning model) (e.g., second machine learning model 110) with new data from recent epochs or batches, allowing the system to adapt and improve its predictive accuracy over time. In some examples, the optimization subsystem 220's decision-making process includes the optimization subsystem 220 making a statistical assessment. For instance, in some examples, the optimization subsystem 220 can use Monte Carlo simulations to assess the reliability of different configurations under various scenarios (e.g. hypothetical scenarios).

In some examples, the optimization subsystem 220 critically assesses performance based on performance metrics and/or processing characteristics corresponding to attributes such as generalization error, heat generation, power usage, accuracy, speed of processing (time to generate output), need for heat dissipation (e.g., heatsinks, fans, or other coolers), fan speed, longevity of equipment (e.g., drives, RAM, ROM, GPU, CPU, cores), specific desired load for processing elements (e.g., cores, CPU, GPU), memory use, hard drive write or read rate, hard drive errors, RAM errors, number of cores (e.g., CPU and/or GPU) needed, number of files saved to and/or read from storage, time of training, loss, area under the curve (AUC), other accuracy measures, sensitivity, specificity, false positives, false negatives, learning rate, context length, accuracy in long context (e.g. for LLM, transformers, autoencoders, GANs), accuracy in short context (e.g., for LLM, transformers, autoencoders, GANs), accuracy evaluated for a specific type of length of context (e.g., for LLM, transformers, autoencoders, GANs), GAN rejection rate, GAN rejection instances, other processing characteristics or performance metrics (e.g., assessed between intervals and/or between ranges such as comparison with a minimum threshold and a target threshold), or a combination thereof—and can adjust strategies adaptively. For instance, if certain thresholds of performance improvement (e.g., specified by the user and/or derived from historical data trends) are met or exceeded, the subsystem may decide to ‘lock in’ a particular configuration as the configuration (e.g., dropout configuration and/or parameter values) to use to optimize the ML model (e.g., neural network) (e.g., first machine learning model 105). In some examples, if improvements plateau or diminish at, above, or below a certain threshold, the optimization subsystem 220 can trigger further exploratory actions (e.g., re-entering the exploration phase 115) and/or a reevaluation of the learning models used for prediction and/or optimization (e.g., of the second machine learning model 110).

The optimization subsystem 220 interacts with other subsystems, such as the configuration management subsystem 210 and the evaluation subsystem 215, receiving feedback and data to refine the strategies used by the optimization subsystem 220 for optimization. This inter-subsystem communication can be used by the optimization subsystem 220 for dynamic adjustments and for maintaining an efficient workflow in the training process for the ML model (e.g., neural network) (e.g., first machine learning model 105) that is being optimized.

One technique that can be used by the optimization subsystem 220 is Contextual Multi-Arm Bandit (CMAB). In some examples, the Contextual Multi-Arm Bandit (CMAB) technique can be used by the optimization subsystem 220 to navigate the trade-offs between exploration (e.g., trying new dropout configurations and/or parameter configurations in the exploration phase 115) and exploitation (e.g., leveraging known effective configurations in the optimization phase 150). This technique is helpful because it responds adaptively to the contextual specifics of the neural network training process. In some examples, the optimization subsystem 220 processes context data to generate dropout configurations, parameter values, and/or predicted processing characteristics (predicted performance metrics). The context data can include elements such as the current epoch number, batch identifier, step number, iteration number, cycle number, stage number, round number, tree number, tree depth, total number of trees, and/or particular details of previously applied dropout configurations and/or parameter configurations. The context data can dynamically shape the decision-making process in configuring dropout, configuring parameters, enhancing the relevance and timeliness of decisions. The optimization subsystem 220 can use the CMAB technique for adaptive decision making. For instance, the CMAB technique uses a probabilistic model to choose which “arm” (e.g., dropout configuration and/or parameter configuration) to pull next, based on past results and the current context. This ensures an ongoing adaptation to the evolving state of the neural network training, optimizing performance across diverse training scenarios. In some examples, as the network evolves, CMAB dynamically adjusts dropout strategies and/or parameter change strategies to better address emerging training patterns and dependencies, significantly reducing the risk of overfitting while maximizing generalization and improving other processing characteristics and/or performance metrics (e.g., accuracy, speed, confidence, and the like).

Another technique that can be used by the optimization subsystem 220 is reinforcement learning (RL) (e.g., Q-Learning and Policy Optimization). Reinforcement learning techniques, including Q-learning and policy optimization, can be used by the dropout and/or parameter optimization framework of the optimization subsystem 220, providing a mechanism to learn and improve dropout choices and/or parameter change choices through trial—and—error interactions with the network training environment. For instance, the optimization subsystem 220 can use Q-Learning, which uses a value-based approach where each dropout configuration and/or parameter configuration has an associated ‘value’ indicating its effectiveness. The optimization subsystem 220 continually updates these values based on the feedback (e.g., reward), which is the achieved improvement in generalization error (and/or improvements to other processing characteristics and/or performance metrics). The optimization subsystem 220 can use policy optimization, which focuses directly on improving the policy (strategy) of choosing dropout configurations and/or parameter configurations, for instance using a gradient descent and/or gradience descent method on the expected return from current policy decisions, for instance by optimizing to minimum loss and/or cost functions. These reinforcement learning techniques can enable the optimization subsystem 220 to learn from the outcomes of previous dropout applications and/or parameter configuration applications, continually refining the decision-making policies to favor configurations that yield the best performance. By learning the value of actions in different states or directly optimizing the selection policy, the optimization subsystem 220 efficiently identifies and applies the most promising dropout configurations and/or parameter configurations through the course of training.

Another technique that can be used by the optimization subsystem 220 is Monte Carlo prediction and/or Monte Carlo simulation, which can be used by the optimization subsystem 220 to manage the uncertainty and variability inherent in predicting the outcomes of dropout configurations and/or parameter configurations. By simulating a variety of outcomes based on different configurations, the optimization subsystem 220 can statistically estimate their potential impact on model performance. In some examples, the optimization subsystem 220 can use Monte Carlo predictions and/or Monte Carlo simulations to generate a broad range of possible results for different dropout configurations and/or parameter configurations by randomly sampling from the distribution of possible network states and data points. The optimization subsystem 220 can employ statistical methods to analyze the simulated data, estimating the expected performance and the variability of each dropout configuration and/or parameter configuration. Using Monte Carlo predictions and/or Monte Carlo simulations helps the optimization subsystem 220 in making well-informed, statistically backed decisions about which dropout configurations and/or parameter configurations are likely to perform best in various contexts. By understanding the range of potential outcomes, our system minimizes the risk of choosing sub-optimal dropout configurations and/or parameter configurations.

Another technique that can be used by the optimization subsystem 220 is supervised learning models, which the optimization subsystem 220 can use to predict the effectiveness of different dropout configurations and/or parameter configurations based on historical data. The second machine learning model 110 can be a supervised learning model, in some examples. In some examples, the machine learning model optimization system 200 trains the second machine learning model 110 (e.g., as a supervised learning model or otherwise) with features derived from previous training cycles and corresponding performance metrics. The machine learning model optimization system 200 can thus use historical data (e.g., contexts and corresponding performances) to build models (e.g., second machine learning model 110), such as supervised learning models (or other types of models), that can predict effectiveness of different dropout configurations and/or parameter values, for instance through simulations. In some examples, features processed by the models include contextual data like epoch number, batch number, step number, iteration number, cycle number, stage number, round number, and/or other temporal units, and/or specifics of the configurations applied, which help the model in making accurate predictions. In some examples, the optimization subsystem 220 can use these models to predict the likely outcome of a dropout configuration (and/or adjusted parameter values) before actually testing the dropout configuration (and/or adjusted parameter values). This preemptive insight allows the system to prioritize highly promising configurations over less effective ones, and can reduce computational and temporal costs by limiting the exploration to configurations that are likely to yield substantial benefits.

Incorporating the optimization techniques discussed herein into the machine learning model optimization system 200 (e.g., into the optimization subsystem 220) ensures an adaptive, robust, and efficient process of managing dropout configurations and/or parameter configurations. The machine learning model optimization system 200 therefore not only combats overfitting effectively but also improves the generalization capability of the optimized ML models on unseen data, and in some cases also improves the optimized ML models in other processing characteristics and/or performance metrics (e.g., accuracy, speed, confidence, and the like).

The storage subsystem 225 maintains a comprehensive record of all experimentations and evaluations (e.g., by the configuration management subsystem 210, the evaluation subsystem 215, and/or the optimization subsystem 220) concerning various dropout configurations and/or parameter configurations used during training of the model (e.g., the first machine learning model 105) (e.g., neural network). The storage subsystem 225 serves as the central repository of data that supports the learning and optimization processes of the machine learning model optimization system 200. The storage subsystem 225 captures and stores detailed data on every dropout configuration that has been tested during the exploration phase 115. This includes configurations across different epochs, batches, steps, iterations, cycles, samples, features, stages, rounds, other temporal units, and/or complete model training cycles. Post evaluation (e.g., by the evaluation subsystem 215), the dropout configurations and their respective outcomes (e.g., results 125, results 135, and/or results 145 cataloguing accuracy, speed, confidence, generalization error, heat generation, power usage, and/or other processing characteristics and/or performance metrics) are stored. This data is retrieved and used for subsequent analysis and decision-making processes by the optimization subsystem 220. Over time, the storage subsystem 225 builds a historical dataset that allows the machine learning model optimization system 200 to analyze trends and patterns in dropout effectiveness and/or parameter change effectiveness. This is especially valuable for contextual learning and long-term performance enhancement of the model (e.g., the first machine learning model 105). In some examples, each dropout configuration and/or parameter configuration tested is uniquely indexed within data store(s) of the storage subsystem 225 for quick retrieval. This aids in preventing redundant testing of configurations that have already been evaluated, saving computational resources and time.

In some examples, the storage subsystem 225 uses a database schema that handles diverse types of data, including categorical data (e.g., dropout techniques used, parameter changes made), continuous data (e.g., performance metrics), and temporal data (e.g., batch identifiers, epoch counts, step numbers, iteration numbers, round numbers, and/or other temporal units). The storage subsystem 225 can ensure accuracy and consistency of data through constraints and validation rules in the database, thus improving data integrity. The data store(s) of the storage subsystem 225 can be optimized for frequent queries from the optimization subsystem 220 (e.g., for use in optimization) and/or the configuration management subsystem 210 (e.g., to ensure certain dropout configurations and/or parameter configurations haven't already been tested). The storage subsystem 225 can employ indices and optimized query plans to ensure rapid retrieval of historical data. Given the large volume of data generated during the exploration phase 115 (and in some cases the optimization phase 150), in some examples, the storage subsystem 225 can utilize scalable cloud-based database solutions, which can dynamically adjust resources based on demand. In some examples, the storage subsystem 225 implements robust security measures, such as encrypted communications and/or storage, to protect sensitive data and ensure compliance with relevant data protection regulations.

The storage subsystem 225 communicates with the configuration management subsystem 210, the evaluation subsystem 215, and/or the optimization subsystem 220. The storage subsystem 225 also provides input data to the configuration management subsystem 210 and/or the optimization subsystem 220. The storage subsystem 225 can ensure a seamless flow of information across the machine learning model optimization system 200, enabling dynamic adjustments and optimization of dropout configurations and/or parameter configurations based on real-time and historical data insights.

In some examples, the storage subsystem 225 can include and/or use databases such as PostgreSQL® and/or MongoDB®. In some examples, the storage subsystem 225 can include and/or use cloud solutions like Amazon® DynamoDB® and/or Google® Cloud® Firestore®. For complex queries and larger datasets, the storage subsystem 225 can include and/or use data warehousing solutions like Amazon® Redshift® or Google® BigQuery®. In some examples, the storage subsystem 225 can employ messaging services such as Apache® Kafka® and/or Redis® to improve real-time data processing capabilities. The storage subsystem 225 can ultimately help provide a number of improvements for the machine learning model optimization system 200, such as improvements to data retrieval latency (e.g., reducing time taken to fetch data as required by other subsystems), improving data throughput (e.g., increasing the volume of data that can be handled per unit of time), and/or improving data integrity error rates (e.g., reducing frequency of data mismatches or corruptions).

The control subsystem 230 serves as a regulatory component for the machine learning model optimization system 200. The control subsystem 230 can interface dynamically with both the configuration management subsystem 210 and the optimization subsystem 220, orchestrating the adjustment of dropout configurations and/or parameter configurations in response to real-time performance feedback and predefined operational criteria. The control subsystem 230 can intelligently direct (e.g., through the second machine learning model 110) the execution flow and ensure that the dropout optimization process and/or parameter optimization process is efficient and effective, improving the generalization ability of the ML model (e.g., first machine learning model 105) (e.g., neural network) efficiently and without unnecessary computational overhead.

In some examples, the control subsystem 230 continually monitors the performance metrics received from the evaluation subsystem 215. The control subsystem 230 uses this data to make informed decisions about whether to maintain the current dropout configuration and/or parameter configuration, explore new configurations, or revert to previously successful configurations. The control subsystem 230 can dynamically adjust the dropout rates and patterns—and/or parameter configurations-across different layers of the network based on the feedback from the optimization subsystem 220, which continually analyzes the performance of various configurations using algorithms such as Contextual Multi-Arm Bandit (CMAB) or reinforcement learning. In some examples, the control subsystem 230 can compare based on predetermined performance thresholds, which act as criteria for adjustments in the dropout configuration and/or parameter configuration. The thresholds can be related to generalization error, heat generation, power usage, accuracy improvement, speed improvement, confidence improvement, and/or the comparative metrics between validation performance and/or training performance. The control subsystem 230 evaluates these thresholds and controls the optimization loop, for instance initiating further optimization if the thresholds are not met, or halting the optimization if the desired performance is achieved or if improvements plateau below a minimal threshold. In some examples, optimization halts when a specified generalization error is reached or when improvements in the generalization error (or accuracy, speed, confidence, or another performance metric) fall below a pre-defined minimal threshold. In some examples, the optimization subsystem 220 and/or control subsystem 230 can end optimization in response to achieving specific performance ratios between unseen data and training data, as customized by the user. In some examples, the control subsystem 230 schedules optimization tasks, deciding whether they should occur after every epoch, batch, step, iteration, cycle, stage, round, and/or other temporal units, or complete training of the model (e.g., of the first machine learning model 105 and/or its variants). This flexibility allows for fine-tuned control over the computational resources and the timing of optimization. The control subsystem 230 can manage the sequence of exploring dropout configurations and/or parameter configurations, choosing between random selection (e.g., of neurons for dropout, of parameters for changes, of parameter values) for initial broad explorations and more targeted approaches (e.g., using learned heuristics from previous optimizations) as patterns start to emerge.

In some examples, the control subsystem 230 can leverage the data stored in the storage subsystem 225, including historical performance metrics and configurations, to guide current and future decisions. This historical insight aids in avoiding redundant testing of ineffective dropout configurations and/or parameter configurations and prioritizes those with previously successful outcomes. In some examples, the control subsystem 230 provides interfaces (e.g., user interfaces) that can allow users to specify and/or adjust optimization parameters, including introduction of new criteria, modification of existing thresholds, and/or manual override of automated decisions. The control subsystem 230 supports customization that allows experienced users or systems to refine the optimization process according to specific operational needs or experimental designs. In some examples, the control subsystem 230 includes real-time monitoring and/or logging capabilities to track decisions and performance of the control subsystem 230 (and/or the ML model training subsystem 205, the configuration management subsystem 210, the evaluation subsystem 215, and/or the optimization subsystem 220), facilitating auditing and further refinement of model optimization by the machine learning model optimization system 200. The control subsystem 230 can update its decisions over time as new data is received, making the control subsystem 230 adaptive and responsive to evolving network behaviors and external conditions.

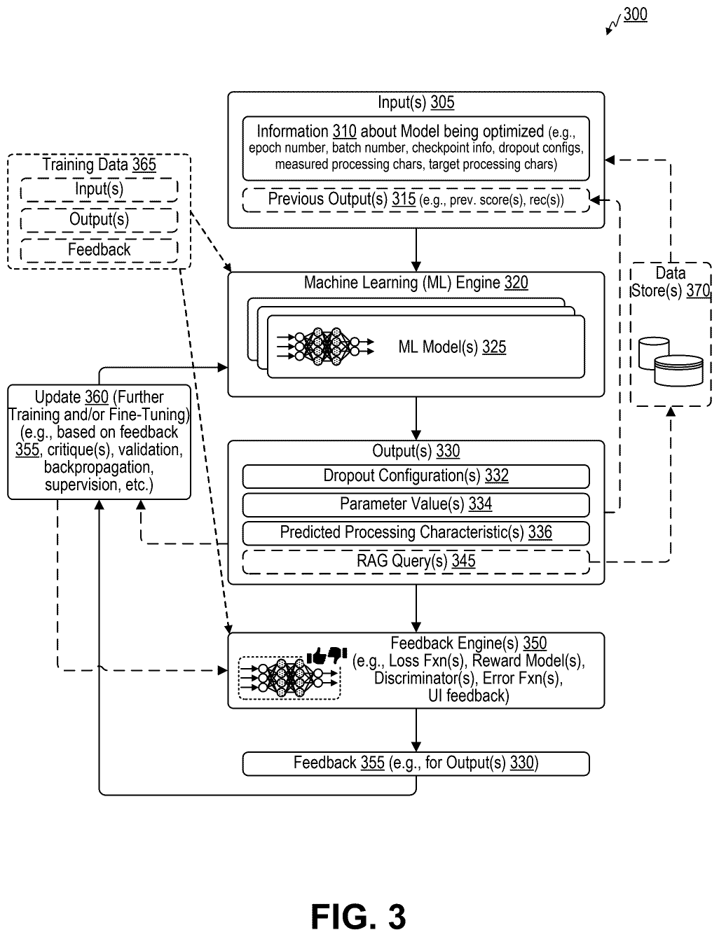

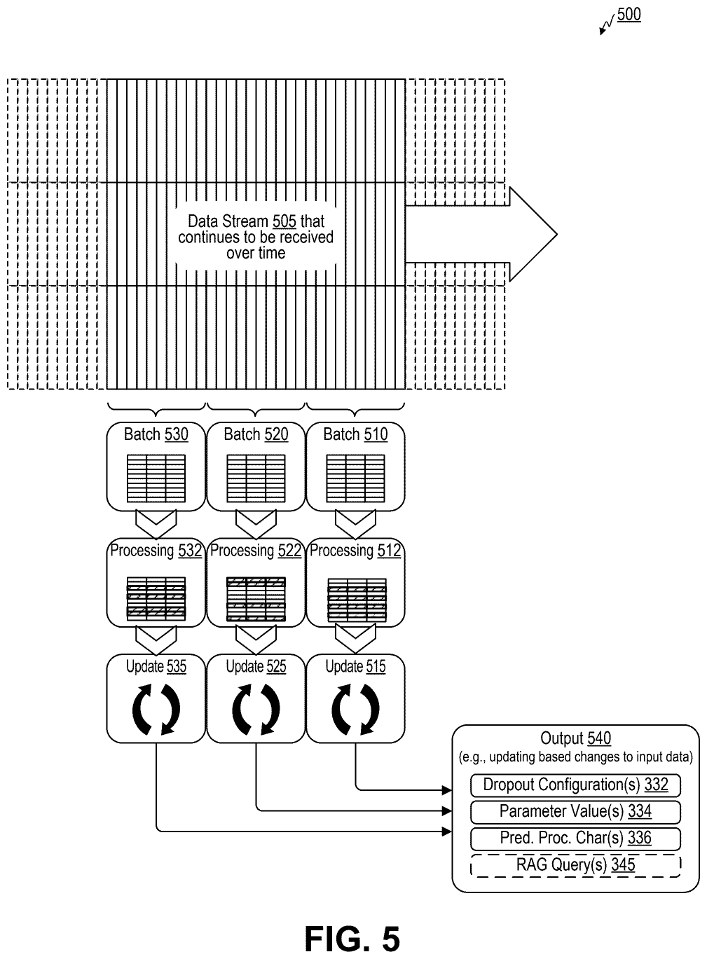

FIG. 3 is a block diagram illustrating an example of a machine learning system 300 for training, use of, and/or updating of one or more machine learning model(s) 325 that are used to generate dropout configuration(s) 332, parameter value(s) 334, and/or predicted processing characteristic(s) 336. The machine learning (ML) system 300 includes an ML engine 320 that generates, trains, uses, and/or updates one or more ML model(s) 325. In some examples, ML model(s) 325 may be example(s) of the first machine learning model 105, the second machine learning model 110, the ML model(s) 425, the ML model of FIG. 5, the neural network of FIG. 5, other neural networks discussed herein, other ML model(s) discussed herein, other AI algorithms discussed herein, or a combination thereof, or vice versa. In some examples, the system that performs the process 100, the machine learning model optimization system 200, the RAG system 400, the system that performs the process 500, the system that performs the process 600, and/or the computing system 700 includes the ML system 300, the ML engine 320, the ML model(s) 325, and/or the feedback engine(s) 350, or vice versa.

The ML model(s) 325 can include, for instance, one or more neural network(s) (NN(s)), one or more convolutional NN(s) (CNN(s)), one or more time delay NN(s) (TDNN(s)), one or more deep network(s) (DN(s)), one or more autoencoder(s) (AE(s)), one or more variational autoencoder(s) (VAE(s)), one or more deep belief net(s) (DBN(s)), one or more recurrent NN(s) (RNN(s)), one or more generative adversarial network(s) (GAN(s)), one or more conditional GAN(s) (cGAN(s)), one or more feed-forward network(s), one or more network(s) having fully connected layers, one or more support vector machine(s) (SVM(s)), one or more random forest(s) (RF), one or more computer vision (CV) system(s), one or more autoregressive (AR) model(s), one or more Sequence-to-Sequence (Seq2Seq) model(s), one or more large language model(s) (LLM(s)), one or more multimodal large language model(s) (MLLM(s)), one or more deep learning system(s), one or more classifier(s), one or more transformer(s), or a combination thereof.

In some examples, the ML model(s) 325 can include a U-Network (U-Net) structure and/or architecture that includes a contracting path and an expansive path. If the ML model(s) 325 is a U-Net, the ML model(s) 325 may include, for instance, combination of convolution, up-convolution, pooling and skip connections that allows the ML model(s) 325 to extract and capture complex features, while also keeping and reconstructing spatial information.

In examples where the ML model(s) 325 include LLMs and/or MLLMs, the LLMs and/or MLLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Google® Gemini®, Anthropic® Claude®, Anthropic® Claude® Sonnet®, Bidirectional Encoder Representations from Transformers (BERT), Anthropic® Claude®, Falcon (e.g., 40B, 7B, 1B), Orca, Phi-1, StableLM, DeepSeck® R1, Alibaba® Qwen®, ByteDance® Doubao®, another LLM or MLLM, variant(s) of any of the previously-listed LLMs or MLLMs, or a combination thereof.

Within FIG. 3, a graphic representing the ML model(s) 325 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 325 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 325 can include a feed-forward network, in which case there are no feedback connections where outputs of the network are fed back into itself. In some cases, the ML model(s) 325 can include a recurrent neural network, which can have loops that allow information to be carried across nodes while reading in input. In some cases, the network can include a convolutional neural network, which may not link every node in one layer to every other node in the next layer.

One or more input(s) 305 can be provided to the ML model(s) 325. The ML model(s) 325 can be trained by the ML engine 320 (e.g., based on training data 365) to generate one or more output(s) 330. In some examples, the input(s) 305 include information 310. The information 310 can include, for instance, epoch number, batch number, step number, iteration number, cycle number, stage number, round number, other temporal units information, tree number, tree depth, total number of trees, total number of models or checkpoints, checkpoint information, dropout configurations (e.g., tested in the exploration phase 115 by the configuration management subsystem 210), measured processing characteristics (e.g., evaluated during the configuration management subsystem 210 by the evaluation subsystem 215), target processing characteristics (e.g., target accuracy, generalization error, heat generation, power usage, speed, time to compute outputs, confidence, and/or other processing characteristics discussed herein) to be achieved as a goal of the optimization, or a combination thereof. In some examples, the input(s) 305 can include prompt(s) (e.g., to an LLM). In some examples, the input(s) 305 can include information retrieved from data store(s) 370, for instance via retrieval augmented generation (RAG) (e.g., via RAG query(s) 345). In some examples, the input(s) 305 can include prompt(s) that are modified and/or enhanced using information retrieved from data store(s) 370, for instance via retrieval augmented generation (RAG) (e.g., via RAG query(s) 345).

The output(s) 330 that ML model(s) 325 generate by processing the input(s) 305 (e.g., the information 310 and/or the previous output(s) 315) can include dropout configuration(s) 332, parameter value(s) 334, predicted processing characteristic(s) 336, and/or RAG query(s) 345. The dropout configuration(s) 332 can include, for instance, a dropout rate (e.g., percentage of neurons dropped and/or probability of a neuron being dropped), layer application (e.g., which layers the optimization system can drop neurons from), neuron selections (e.g., selections of specific neurons to be dropped or retained), layer selections (e.g., selections of specific layers to be dropped or retained), or combinations thereof. For instance, in the context of FIG. 1, the variant 120, the variant 130, the variant 140, and the variant 160 include examples of different dropout configurations applied to drop out different neurons (or sets of neurons) from the first machine learning model 105. The configuration(s) 332 can drop out one or more neurons, one or more layers, or a combination thereof.

The parameter value(s) 334 can include, for instance, values of hyperparameters and/or other parameters of the model being optimized. The hyperparameters and/or other parameters for which the parameter value(s) 334 can include values for can include, for instance, temperature (e.g., influencing level creativity and/or randomness), top P (e.g., influencing level creativity and/or randomness), frequency penalty (e.g., to prevent repetitive language between one of the output(s) of the optimized model and another), presence penalty (e.g., to encourage the ML model(s) being optimized to introduce new data in its output(s)), learning rate, activation type, regularization type, regularization strength, number of iterations, maximum threshold number of iterations, tolerance values, selection strategies, kernel types, weight types, learning rate, activation type, regularization type, regularization strength, number of iterations, maximum threshold number of iterations, tolerance values, selection strategies, kernel types, weight types, other types of parameters and/or hyperparameters discussed herein, or a combination thereof. For instance, a number of illustrative examples is provided herein of different types of models to be optimized (e.g., types for the first machine learning model 105) and different types of hyperparameters and/or other parameters for which the parameter value(s) 334 can include values for, depending on the model type.

In some examples, certain optimizations (e.g., dropout configuration(s) 332 and/or parameter value(s) 334) can be determined (e.g., by the ML model(s) 325 and/or the first machine learning model 105) and/or applied (e.g., to the second machine learning model 110 by the machine learning model optimization system 200 and/or the machine learning system 300) on a per layer basis, a per neuron basis, a per node basis, a per feature basis, a per input basis, a per output basis, a per leaf basis, a per tree basis, a per iteration basis, a per step basis, a per epoch basis, a per round basis, a per cycle basis, a per stage basis, a per iteration basis, a per batch basis, a per time unit basis, on the basis of multiple of any of the preceding elements, or a combination thereof. For instance, the dropout rate can be 0.2 for one layer, and 0.3 for another layer. Similarly, a specific parameter can be changed to one value for one layer or neuron, and another value for another layer or neuron. In some examples, certain optimizations (e.g., dropout configuration(s) 332 and/or parameter value(s) 334) can be determined (e.g., by the ML model(s) 325 and/or the first machine learning model 105) and/or applied (e.g., to the second machine learning model 110 by the machine learning model optimization system 200 and/or the machine learning system 300) every Nth iteration, ReLU activation, gamma activation, maxmin, softmax, or other function activation. In some examples, certain layers, neurons, nodes, features, leafs (leaves), interactions, epochs, batches, steps, cycles, iterations, rounds, stages, parameters, time units, or combinations thereof can be skipped.

The predicted processing characteristic(s) 336, can include, for instance, predicted values for accuracy of output, time to generate output, speed of generating output, confidence in output, generalization error, heat generation, power usage, need for heat dissipation (e.g., heatsinks, fans, or other coolers), fan speed, longevity of equipment (e.g., drives, RAM, ROM, GPU, CPU, cores), specific desired load for processing elements (e.g., cores, CPU, GPU), memory use, hard drive write or read rate, hard drive errors, RAM errors, number of cores (e.g., CPU and/or GPU) needed, number of files saved to and/or read from storage, time of training, loss, area under the curve (AUC), other accuracy measures, sensitivity, specificity, false positives, false negatives, learning rate, context length, accuracy in long context (e.g. for LLM, transformers, autoencoders, GANs), accuracy in short context (e.g., for LLM, transformers, autoencoders, GANs), accuracy evaluated for a specific type of length of context (e.g., for LLM, transformers, autoencoders, GANs), GAN rejection rate, GAN rejection instances, other processing characteristics or performance metrics (e.g., assessed between intervals and/or between ranges such as comparison with a minimum threshold and a target threshold), or a combination thereof. The predicted processing characteristic(s) 336 can be referred to as predicted performance metric(s). In some examples, the ML model(s) 325 run simulations of processing a test dataset and/or validation dataset through the modified model (e.g., with dropout applied according to the dropout configuration(s) 332 and/or with parameters set according to the parameter value(s) 334) to determine the predicted processing characteristic(s) 336. In some examples, the ML model(s) 325 determine the predicted processing characteristic(s) 336 based on the dropout configuration(s) 332, the parameter value(s) 334, and/or the input(s) 305, without running simulations of processing a test dataset and/or validation dataset through the modified model (e.g., with dropout applied according to the dropout configuration(s) 332 and/or with parameters set according to the parameter value(s) 334).

The ML model(s) 325 can generate each of the output(s) 330 based on the information 310, information from the data store(s) 370, and/or other types of input(s) 305 (e.g., previous output(s) 315).

In some examples, the ML model(s) 325 can identify something in the input(s) 305 about which the data store(s) 370 include additional information, and can fashion at least one query (e.g., the RAG query(s) 345) for the data store(s) 370 to retrieve the additional information from the data store(s) 370. For instance, if the information 310 references a specific model of device, the RAG query(s) 345 can include one or more queries of the data store(s) 370 for additional information about the specific model of device, for instance to retrieve its components, configurations, settings, firmware updates, ranges of optimal operating parameters (e.g., temperature, clock speed, and so forth), or a combination thereof. The additional information retrieved from the data store(s) 370 using the RAG query(s) 345 can be used as part of the input(s) 305 (e.g., as part of the information 310 and/or part of the previous output(s) 315) for further passes of data processing by the ML model(s) 325.

In some examples, certain output(s) 330 (e.g., the dropout configuration(s) 332, the parameter value(s) 334, the predicted processing characteristic(s) 336, and/or the RAG query(s) 345) can be used as part of the input(s) 305 to the ML model(s) 325 (e.g., as part of previous output(s) 315) for identifying other output(s) 330 (e.g., the dropout configuration(s) 332, the parameter value(s) 334, the predicted processing characteristic(s) 336, and/or the RAG query(s) 345). For instance, in an illustrative example, the dropout configuration(s) 332 can be processed, as previous output(s) 315, by the ML model(s) 325 to generate the parameter value(s) 334, the predicted processing characteristic(s) 336, the RAG query(s) 345, and/or other output(s) 330. In some examples, at least some of the previous output(s) 315 in the input(s) 305 represent previously-identified instances of some of the output(s) 330 that are input into the ML model(s) 325 to generate other types of the output(s) 330. In some examples, based on receipt of the input(s) 305, the ML model(s) 325 can select the output(s) 330 from a list of possible outputs, for instance by ranking the list of possible outputs by likelihood, probability, and/or confidence based on the input(s) 305. In some examples, based on receipt of the input(s) 305, the ML model(s) 325 can identify the output(s) 330 at least in part using generative artificial intelligence (AI) content generation techniques, for instance using an LLM to generate custom text and/or graphics identifying the output(s) 330. In some examples, the LLM-based output(s) 330 are conversationally responsive to a prompt in the input(s) 305 (e.g., in the information 310 and/or in the previous output(s) 315).

In some examples, the 325 can generate intermediate data based on the 305, and the 325 can generate the output(s) 330 based on the intermediate data. For instance, in some examples, the ML model(s) 325 can process the information 310 to generate a description of a user, to identify behaviors (or categories of behaviors) of the user, to identify an intent of the user, to identify short-term goals of the user, to identify long-term goals of the user, to categorize the user into one of a set of categories (e.g., by behavior, intent, demographics, goals, or a combination thereof), or a combination thereof. The ML model(s) 325 can then generate the output(s) 330 based on this intermediate data, for instance to improve customization and/or personalization of the output(s) 330 to user(s).

In some examples, the ML system repeats the process illustrated in FIG. 3 multiple times to generate the output(s) 330 in multiple passes, using some of the output(s) 330 from earlier passes as some of the input(s) 305 in later passes (e.g., as some of the previous output(s) 315). For instance, in a first illustrative example, in a first pass, the ML model(s) 325 can identify the dropout configuration(s) 332 and/or parameter value(s) 334 based on input of the information 310 into the ML model(s) 325. In a second pass, the ML model(s) 325 can identify the predicted processing characteristic(s) 336 based on input of the information 310 and the previous output(s) 315 (that includes the dropout configuration(s) 332 and/or the parameter value(s) 334 from the first pass) into the ML model(s) 325.

In some examples, the ML system includes one or more feedback engine(s) 350 that generate and/or provide feedback 355 about the output(s) 330. In some examples, the feedback 355 indicates how well the output(s) 330 align to corresponding expected output(s), how well the output(s) 330 serve their intended purpose, or a combination thereof. In some examples, the feedback engine(s) 350 include loss function(s), reward model(s) (e.g., other ML model(s) that are used to dropout configuration the output(s) 330), discriminator(s), error function(s) (e.g., in back-propagation), user interface feedback received via a user interface from a user, or a combination thereof and/or parameter configuration. In some examples, generalization error can be used as a loss function (e.g., as feedback 355 by the feedback engine(s) 350). In some examples, the feedback 355 can include one or more alignment dropout configuration(s) that dropout configuration a level of alignment between the output(s) 330 and the expected output(s) and/or intended purpose. and/or parameter configuration.

The ML engine 320 of the ML system can update (e.g., further train and/or fine-tune) the ML model(s) 325 based on the feedback 355 to perform an update 360 (e.g., further training and/or fine-tuning) of the ML model(s) 325 based on the feedback 355. In some examples, the feedback 355 includes positive feedback, for instance indicating that the output(s) 330 closely align with expected output(s) and/or that the output(s) 330 serve their intended purpose. In some examples, the feedback 355 includes negative feedback, for instance indicating a mismatch between the output(s) 330 and the expected output(s), and/or that the output(s) 330 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback in the feedback 355, the ML engine 320 can perform the update 360 to update the ML model(s) 325 to strengthen and/or reinforce weights (and/or connections and/or hyperparameters) associated with generation of the output(s) 330 to encourage the ML engine 320 to generate similar output(s) 330 given similar input(s) 305. In this way, the update 360 can improve the ML model(s) 325 itself by improving the accuracy of the ML model(s) 325 in generating output(s) 330 that are similarly accurate given similar input(s) 305. In response to negative feedback in the feedback 355, the ML engine 320 can perform the update 360 to update the ML model(s) 325 to weaken and/or remove weights (and/or connections and/or hyperparameters) associated with generation of the output(s) 330 to discourage the ML engine 320 from generating similar output(s) 330 given similar input(s) 305. In this way, the update 360 can improve the ML model(s) 325 itself by improving the accuracy of the ML model(s) 325 in generating output(s) 330 are more accurate given similar input(s) 305. In some examples, for instance, the update 360 can improve the accuracy of the ML model(s) 325 in generating output(s) 330 by reducing false positive(s) and/or false negative(s) in the output(s) 330.

For instance, here, if the dropout configuration(s) 332, parameter value(s) 334, and/or predicted processing characteristic(s) 336 are used to optimize a machine learning model (e.g., to optimize the first machine learning model 105 by identifying modification(s) that produce the variant 160 of the first machine learning model 105 that has improved performance characteristics over the first machine learning model 105), and the model optimization is successful (e.g., the resulting model indeed has improved performance characteristics over the first machine learning model 105), the success of the model optimization can be interpreted as feedback 355 that is positive (e.g., positive feedback). On the other hand, if the dropout configuration(s) 332, parameter value(s) 334, and/or predicted processing characteristic(s) 336 are used to optimize a machine learning model, and the model optimization fails or is unsuccessful (e.g., the resulting model has performance characteristics that are downgraded and/or not sufficiently improved over the first machine learning model 105), the failure or lack of success of the model optimization can be interpreted as feedback 355 that is negative (e.g., negative feedback). Either way, the update 360 can improve the machine learning system 300 and the overall system by improving the consistency with which the model optimization is successful.

In some examples, the ML engine 320 can also perform an initial training of the ML model(s) 325 before the ML model(s) 325 are used to generate the output(s) 330 based on the input(s) 305. During the initial training, the ML engine 320 can train the ML model(s) 325 based on training data 365. In some examples, the training data 365 includes examples of input(s) (of any input types discussed with respect to the input(s) 305), output(s) (of any output types discussed with respect to the output(s) 330), and/or feedback (of any feedback types discussed with respect to the feedback 355). In some cases, positive feedback in the training data 365 can be used to perform positive training, to encourage the ML model(s) 325 to generate output(s) similar to the output(s) in the training data given input of the corresponding input(s) in the training data. In some cases, negative feedback in the training data 365 can be used to perform negative training, to discourage the ML model(s) 325 from generating output(s) similar to the output(s) in the training data given input of the corresponding input(s) in the training data. In some examples, the training of the ML model(s) 325 (e.g., the initial training with the training data 365, update(s) 360 based on the feedback 355, and/or other modification(s)) can include fine-tuning of the ML model(s) 325, retraining of the ML model(s) 325, or a combination thereof.

In some examples, the ML model(s) 325 can include an ensemble of multiple ML models, and the ML engine 320 can curate and manage the ML model(s) 325 in the ensemble. The ensemble can include ML model(s) 325 that are different from one another to produce different respective outputs, which the ML engine 320 can average (e.g., mean, median, and/or mode) to identify the output(s) 330. In examples with ensembles and/or stacking, the ML engine 320 can, automatically, or later in training (e.g., or during training or every epoch, step, cycle, stage, batch, iteration, round, and/or time unit, or multiple thereof, or combination thereof), based on feedback 355 from production and/or training models (e.g., accuracy measures, cross-validation or other statistical analyses of processing characteristics such as accuracy or performance or loss function), adjust weights of each of the ML model(s) 325 from the ensemble and/or stack, being used to produce output(s) of the ML engine 320 and/or ML model(s) 325. For example, for optimizing production models, processing characteristics that can be optimized for can include time needed to predict, or memory consumption of production model to operate, size (e.g., in kb) of production model. In some examples, these can be used as production feedback. In some examples, the ML engine 320 can calculate the standard deviation of the respective outputs of the different ML model(s) 325 in the ensemble to identify a level of confidence in the output(s) 330. In some examples, the standard deviation can have an inverse relationship with confidence. For instance, if the respective outputs of the different ML model(s) 325 are very different from one another (and thus have a high standard deviation above a threshold), the confidence that the output(s) 330 are accurate may be low (e.g., below a threshold). On the other hand, if the respective outputs of the different ML model(s) 325 are equal or very similar to one another (and thus have a low standard deviation below a threshold), the confidence that the output(s) 330 are accurate may be high (e.g., above a threshold).

In some examples, the feedback 355 can be from operators, from robots, from other machine learning models, from other systems or subsystems, or a combination thereof. In some examples, the feedback 355 can related to processing characteristics, performance metrics, and/or production model (i.e. after deployment) characteristics (I,e. memory use, time to provide outputs, feedback, accuracy) of the first machine learning model 105. In some examples, the first machine learning model 105 can be a production model (e.g., already in deployment), and the ML model(s) 325 can optimize processing characteristics associated with production in the first machine learning model 105. For example, the ML model(s) 325 can optimize processing characteristics in the first machine learning model 105 such as, for instance, time needed for predicting outcomes, energy consumption for model to predict outcomes, to be loaded, the size (e.g., in kilobytes) of the production model, the memory consumption of production model, the feedback and user satisfaction, the hallucinations. In some examples, these processing characteristics can be used as feedback to the ML model(s) 325 to optimize the first machine learning model 105. In some examples, the ML model(s) 325 can optimize for both processing characteristics associated with training and processing characteristics associated with production.

In some examples, different ML models(s) 325 in the ensemble can include different types of models. For instance, in some examples, an ensemble can include a NN and a SVM that are both trained to process the input(s) 305 to generate at least a subset of the output(s) 330. In some examples, the ensemble may include different ML model(s) 325 that are trained to process different inputs of the input(s) 305 and/or to generate different outputs of the output(s) 330. For instance, in some examples, a first model (or set of models) can process the input(s) 305 to generate the dropout configuration(s) 332, a second model (or set of models) can process the input(s) 305 to generate the parameter value(s) 334, a third model (or set of models) can process the input(s) 305 to generate the predicted processing characteristic(s) 336, and a fourth model (or set of models) can process the input(s) 305 to generate the RAG query(s) 345. In some examples, the ML engine 320 can choose specific ML model(s) 325 to be included in the ensemble because the chosen ML model(s) 325 are effective at accurately processing particular types of input(s) 305, are effective at accurately generating particular types of output(s) 330, are generally accurate, process input(s) 305 quickly, generate output(s) 330 quickly, are computationally efficient, have higher or lower degrees of uncertainty than other models in the ensemble, or a combination thereof.

In some examples, one or more of the ML model(s) 325 can be initialized with weights, connections, and/or hyperparameters that are selected randomly. This can be referred to as random initialization. These weights, connections, and/or hyperparameters are modified over time through training (e.g., initial training with the training data 365 and/or update(s) 360 based on the feedback 355), but the random initialization can still influence the way the ML model(s) 325 process data, and thus can still cause different ML model(s) 325 (with different random initializations) to produce different output(s) 330. Thus, in some examples, different ML model(s) 325 in an ensemble can have different random initializations.

As an ML model (of the ML model(s) 325) is trained (e.g., along the initial training with the training data 365, update(s) 360 based on the feedback 355, and/or other modification(s)), different versions of the ML model at different stages of training can be referred to as checkpoints. In some examples, after each new update to a model (e.g., update 360) generates a new checkpoint for the model, the ML engine 320 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 320 produces a benchmark dropout configuration for one or more checkpoint(s) of one or more ML model(s) 325, and keeps the checkpoint(s) that have the best (e.g., highest or lowest) benchmark dropout configurations in the ensemble. In some examples, if a new checkpoint is worse than an older checkpoint, the ML engine 320 can revert to the older checkpoint. The benchmark dropout configuration for a can represent a level of accuracy of the checkpoint and/or number of errors (e.g., false positive or false negative) by the checkpoint during the testing (e.g., against the testing data and/or the validation data). In some examples, an ensemble of the ML model(s) 325 can include multiple checkpoints of the same ML model.

In some examples, the ML model(s) 325 can be trained and/or updated (e.g., with training data 365 and/or the update 360) over a number of epochs, where each epoch includes one or more batches of training data. A batch refers to a subset of the training data that is processed together in a single forward and backward pass during model training. Processing data in batches can improve computational efficiency and stabilize gradient updates. As training progresses across multiple epochs, batches, steps, iterations, cycles, samples, features, stages, rounds, and/or time units, the model parameters are iteratively refined, enabling the model to generalize better to unseen data. The use of multiple updates based on time unit (e.g., epochs, batches, steps, iterations, cycles, samples, features, stages, rounds) allows the model to progressively learn complex patterns and reduce prediction error, thereby improving accuracy and/or robustness of the ML model(s) 325 over time. The number of epochs, the batch size, the number of steps, the number of iterations, the number of cycles, the number of samples, the number of features, the number of stages, the number of rounds, and/or the number of time units may be predetermined or dynamically adjusted based on performance of the ML model(s) 325, convergence criteria, and/or available computational resources.

In some examples, the ML model(s) 325 can be modified, either through the initial training (with the training data 365), an update 360 based on the feedback 355, or another modification to introduce randomness, variability, and/or uncertainty into an ensemble of the ML model(s) 325. In some examples, such modification(s) to the ML model(s) 325 can include dropout (e.g., Monte Carlo dropout), in which one or more weights or connections are selected at random and removed. In some examples, dropout can also be performed during inference, for instance to modify the output(s) 330 generated by the ML model(s) 325. The term Bayesian Machine Learning (BML) can refer to random dropout, random initialization, and/or other randomization-based modifications to the ML model(s) 325. In some examples, the modification(s) to the ML model(s) 325 can include a hyperparameter search and/or adjustment of hyperparameters. The hyperparameter search can involve training and/or updating different ML models 325 with different values for hyperparameters and evaluating the relative performance of the ML models 325 (e.g., against testing data and/or validation data where the correct output(s) are known) to identify which of the ML models 325 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 330 and another), presence penalty (e.g., to encourage the ML model(s) 325 to introduce new data in the output(s) 330), other parameters or settings, or a combination thereof.

In some examples, the ML engine 320 can perform retrieval-augmented generation (RAG) using the model(s) 325. For instance, in some examples, the ML engine 320 can pre-process the input(s) 305 by retrieving additional information from one or more data store(s) 370 (e.g., any of the databases and/or other data structures discussed herein) and using the additional information to enhance the input(s) 305 before the input(s) 305 are processed by the ML model(s) 325 to generate the output(s) 330. For instance, in some examples, the enhanced versions of the input(s) 305 can include the additional information that the ML engine 320 retrieved from the one or more data store(s) 370. In some examples, the machine learning system 300 can retrieve the additional information from one or more data store(s) 370 by querying the data store(s) 370 using RAG query(s) 345 generated by the ML model(s) 325 (or extracted from the input(s) 305 using the ML model(s) 325). In some examples, this RAG process provides the ML model(s) 325 with more relevant information, allowing the ML model(s) 325 to generate more accurate and/or personalized output(s) 330.

In some examples, the output(s) 330 can include model optimizations between subsequent layers and/or adjacent layers, between non-subsequent layers and/or non-adjacent layers, or a combination thereof. In some examples, the model being optimized is a CNN. In some examples, the output(s) 330 can include add depth, pool, stride, and/or padding (forward and/or backward), for instance for three-dimensional convolution.

Referring back to the parameter value(s) 334, in some examples, the types of parameters for which values are determined by the ML model(s) 325 (e.g., second machine learning model 110) can depend on the type of the ML model(s) being optimized (e.g., the type of the first machine learning model 105).

In an illustrative example, the model being optimized can be a Linear Regression model. For such a model, the parameters and/or hyperparameters for which the parameter value(s) 334 are determined can include, but are not limited to, L1 and L2 regularization types such as L1 (Lasso), L2 (Ridge), Elastic Net, or none, optimization regularization strength with a penalty coefficient (e.g., 1.0), fit intercept to include bias (e.g., True or False), solver for optimization method (e.g., normal equations, SGD), and learning rate for SGD (e.g., 0.001). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be a Logistic Regression model. For such a model, the parameters and/or hyperparameters for which the parameter value(s) 334 are determined can include, but are not limited to, L1 and L2 regularization types such as L1 (Lasso), L2 (Ridge), Elastic Net, or none, optimization regularization strength with a penalty coefficient (e.g., 1.0), fit intercept to include bias (e.g., True or False), solver for optimization method (e.g., normal equations, SGD), and learning rate for SGD (e.g., 0.001). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be a Ridge Regression model. For such a model, the parameters and/or hyperparameters for which the parameter value(s) 334 are determined can include, but are not limited to, alpha for L2 regularization strength (e.g., 1.0), fit intercept to include bias (e.g., True or False), solver method (e.g., auto, SVD, least squares (LSQR)), max iterations for steps (e.g., 100), and tolerance for convergence threshold (e.g., 0.001). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be a Lasso Regression model. For such a model, the parameters and/or hyperparameters for which the parameter value(s) 334 are determined can include, but are not limited to, alpha for L1 regularization strength (e.g., 1.0), fit intercept to include bias (e.g., True or False), max iterations for steps (e.g., 1000), tolerance for convergence threshold (e.g., 0.0001), and selection for coordinate descent strategy (e.g., cyclic, random). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be an Elastic Net Regression model. For such a model, the parameters and/or hyperparameters for which the parameter value(s) 334 are determined can include, but are not limited to, alpha for overall regularization strength (e.g., 1.0), L1 ratio for balance between L1 and L2 (e.g., 0.5), fit intercept to include bias (e.g., True or False), max iterations for steps (e.g., 1000), tolerance for convergence threshold (e.g., 0.0001), and selection for coordinate descent strategy (e.g., cyclic). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be a Support Vector Machines (SVM) for classification. For such a model, the parameters and/or hyperparameters for which the parameter value(s) 334 are determined can include, but are not limited to, kernel type (e.g., Linear, radial basis function (RBF), Polynomial, Sigmoid), kernel parameters such as degree (polynomial) and gamma (RBF), C for regularization parameter (e.g., 1.0), gamma for kernel coefficient (e.g., scale, auto), tolerance for stopping criterion (e.g., 0.001), max iterations for steps (e.g., −1 for no limit), class weight for imbalanced classes (e.g., balanced), and decision function shape (e.g., one-versus-rest (OVR), one-versus-one (OVO) for multiclass). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be a Support Vector Regression (SVR) model. For such a model, the parameters and/or hyperparameters for which the parameter value(s) 334 are determined can include, but are not limited to, kernel type (e.g., Lincar, RBF, Polynomial, Sigmoid), kernel parameters such as degree and gamma, C for regularization parameter (e.g., 1.0), epsilon for margin for regression (e.g., 0.1), gamma for kernel coefficient (e.g., scale), tolerance for stopping criterion (e.g., 0.001), and max iterations for steps (e.g., −1). The model optimization process can optimize to maximize accuracy evaluated on the same or another training or validation set, or to minimize the time of training or testing, electric power consumption, or heat generation. This optimization can be applied every iteration or every Nth iteration during the gradient descent minimization iterations on the model parameters.

In another illustrative example, the model being optimized can be a K-Nearest Neighbors (KNN) model for classification. For such a model, the parameters and/or hyperparameters for which the parameter value(s) 334 are determined can include, but are not limited to, the number of neighbors as the K value (e.g., 5), distance metric (e.g., Euclidean, Manhattan), weights as uniform or distance-based, algorithm for search method (e.g., ball_tree, kd_tree), leaf size for tree-based search (e.g., 30), and P for Minkowski distance power (e.g., 2). The model optimization process can optimize to maximize accuracy evaluated on the same or another training or validation set, or to minimize the time of training or testing, electric power consumption, or heat generation. This optimization can be applied every iteration, every Nth iteration, or every data point during the distance calculation iterations on the model parameters.

In another illustrative example, the model being optimized can be a K-Nearest Neighbors (KNN) model for regression. For such a model, the parameters and/or hyperparameters for which the parameter value(s) 334 are determined can include, but are not limited to, the number of neighbors as the K value (e.g., 5), distance metric (e.g., Euclidean), weights as uniform or distance-based, algorithm for search method (e.g., kd_tree), leaf size for tree-based search (e.g., 30), and P for Minkowski distance power (e.g., 2). The model optimization process can optimize to maximize accuracy evaluated on the same or another training or validation set, or to minimize the time of training or testing, electric power consumption, or heat generation. This optimization can be applied every iteration, every Nth iteration, or every data point during the distance calculation iterations on the model parameters.

In another illustrative example, the model being optimized can be Decision Tree for classification. For such a model, the parameters and/or hyperparameters for which the parameter value(s) 334 are determined can include, but are not limited to, max depth for tree depth (e.g., None, 10), min samples split for min samples to split (e.g., 2), min samples leaf for min samples per leaf (e.g., 1), max features for features per split (e.g., None), criterion for splitting metric (e.g., Gini impurity index, entropy), splitter for strategy (e.g., best, random), max leaf nodes for leaf limit (e.g., None), and min impurity decrease for split threshold (e.g., 0.0). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a Decision Tree for regression. For such a model, the parameters and/or hyperparameters for which the parameter value(s) 334 are determined can include, but are not limited to, max depth for tree depth (e.g., None), min samples split for min samples to split (e.g., 2), min samples leaf for min samples per leaf (e.g., 1), max features for features per split (e.g., None), criterion for splitting metric (e.g., mean squared error (MSE), mean absolute error (MAE)), splitter for strategy (e.g., best), max leaf nodes for leaf limit (e.g., None), and min impurity decrease for split threshold (e.g., 0.0). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a Random Forest for classification. For such a model, the parameters and/or hyperparameters for which the parameter value(s) 334 are determined can include, but are not limited to, the number of trees for tree count (e.g., 100), max depth for per-tree depth (e.g., None), min samples split for min samples to split (e.g., 2), min samples leaf for min samples per leaf (e.g., 1), max features for features per split (e.g., sqrt), criterion for splitting metric (e.g., Gini), bootstrap for using bootstrapping (e.g., True or False), max samples for data fraction per tree (e.g., 0.8), and number of jobs for parallel trees (e.g., −1). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a Random Forest for regression. For such a model, the parameters and/or hyperparameters for which the parameter value(s) 334 are determined can include, but are not limited to, the number of trees for tree count (e.g., 100), max depth for per-tree depth (e.g., None), min samples split for min samples to split (e.g., 2), min samples leaf for min samples per leaf (e.g., 1), max features for features per split (e.g., sqrt), criterion for splitting metric (e.g., MSE), bootstrap for using bootstrapping (e.g., True or False), max samples for data fraction per tree (e.g., 0.8), and number of jobs for parallel trees (e.g., −1). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a Gradient Boosting model (e.g., Gradient Boosting Classifier/Regressor). For such a model, the parameters and/or hyperparameters for which the parameter value(s) 334 are determined can include, but are not limited to, the number of trees for boosting stages (e.g., 100), max depth for per-tree depth (e.g., 3), min samples split for min samples to split (e.g., 2), min samples leaf for min samples per leaf (e.g., 1), max features for features per split (e.g., None), learning rate for shrinkage rate (e.g., 0.1), subsample for fraction of data per tree (e.g., 1.0), loss for objective (e.g., deviance, MSE), criterion for splitting metric (e.g., friedman_mse), max leaf nodes for leaf limit (e.g., None), and min impurity decrease for split threshold (e.g., 0.0). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be an extreme Gradient Boosting (XGBoost) model. For such a model, the parameters and/or hyperparameters for which the parameter value(s) 334 are determined can include, but are not limited to, the number of trees for boosting rounds (e.g., 100), max depth for per-tree depth (e.g., 6), min child weight for min sum of instance weight (e.g., 1), max delta step for max step size for updates (e.g., 0), learning rate (cta) for shrinkage (e.g., 0.3), gamma for min loss reduction for split (e.g., 0), lambda for L2 regularization (e.g., 1), alpha for L1 regularization (e.g., 0), subsample for data fraction per tree (e.g., 0.8), colsample by tree for feature fraction per tree (e.g., 0.8), booster for type (e.g., gbtree, dart), and objective for loss function (e.g., binary:logistic). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a (Light Gradient Boosting Machine (LightGBM) model. For such a model, the parameters and/or hyperparameters for which the parameter value(s) 334 are determined can include, but are not limited to, the number of trees for boosting iterations (e.g., 100), max depth for per-tree depth (e.g., −1 for no limit), num leaves for max leaves per tree (e.g., 31), min data in leaf for min samples per leaf (e.g., 20), learning rate for shrinkage (e.g., 0.1), feature fraction for features per tree (e.g., 0.9), bagging fraction for data per tree (e.g., 0.8), lambda L1 for L1 regularization (e.g., 0), lambda L2 for L2 regularization (e.g., 0), min gain to split for min gain for split (e.g., 0), boosting type for method (e.g., gradient boosting decision tree (GBDT), dropouts meet multiple additive regression trees (DART)), and objective for loss function (e.g., binary, regression). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a CatBoost model. For such a model, the parameters and/or hyperparameters for which the parameter value(s) 334 are determined can include, but are not limited to, the number of trees for boosting iterations (e.g., 1000), depth for per-tree depth (e.g., 6), L2 leaf reg for leaf regularization (e.g., 3.0), learning rate for shrinkage (e.g., 0.03), bagging temperature for randomness control (e.g., 1.0), subsample for data fraction (e.g., 0.66), random selection ate (RSM) for feature fraction (e.g., 1.0), loss function for objective (e.g., Logloss, root mean squared error (RMSE)), border count for categorical features (e.g., 254), and feature border type for encoding method (e.g., Median). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be an AdaBoost model. For such a model, the parameters and/or hyperparameters for which the parameter value(s) 334 are determined can include, but are not limited to, the number of estimators for weak learners (e.g., 50), base estimator for weak learner type (e.g., DecisionTrec), max depth for tree-based estimators (e.g., 1), learning rate for weight adjustment (e.g., 1.0), algorithm for Stagewise Additive Modeling using a Multi-class Exponential loss (SAMME), SAMME with Real-valued Predictions (SAMME.R) for classification, and loss for regression (e.g., linear, square). The model optimization process can optimize to maximize accuracy evaluated on the same or another training or validation set, or to minimize the time of training or testing, electric power consumption, or heat generation. This optimization can be applied every process of addition or every Nth process of addition of leaf, branch, split, division, forest, or tree on the model parameters.

In another illustrative example, the model being optimized can be a K-Means Clustering model. For such a model, the parameters and/or hyperparameters for which the parameter value(s) 334 are determined can include, but are not limited to, the number of clusters as the K value (e.g., 3), initialization method for centroid init (e.g., k-means++, random), max iterations for steps (e.g., 300), number of initializations for runs (e.g., 10), tolerance for convergence threshold (e.g., 0.0001), and algorithm for variant (e.g., Lloyd, Elkan). The model optimization process can optimize to maximize accuracy evaluated on the same or another training or validation set, or to minimize the time of training or testing, electric power consumption, or heat generation. This optimization can be applied every data point or every Nth data point during the iteration on the model parameters.

In another illustrative example, the model being optimized can be a Hierarchical Clustering model. For such a model, the parameters and/or hyperparameters for which the parameter value(s) 334 are determined can include, but are not limited to, the number of clusters for desired clusters (e.g., 2), linkage for criterion (e.g., ward, complete, average), distance metric (e.g., Euclidean), affinity for distance measure (e.g., Euclidean), and compute full tree for full or partial tree (e.g., True or False). The model optimization process can optimize to maximize accuracy evaluated on the same or another training or validation set, or to minimize the time of training or testing, electric power consumption, or heat generation. This optimization can be applied every data point or every Nth data point during the iteration on the model parameters.

In another illustrative example, the model being optimized can be a Density-Based Spatial Clustering of Applications with Noise (DBSCAN) model. For such a model, the parameters and/or hyperparameters for which the parameter value(s) 334 are determined can include, but are not limited to, epsilon for max distance for neighbors (e.g., 0.5), min samples for min points for core point (e.g., 5), distance metric (e.g., Euclidean), algorithm for search method (e.g., ball_tree), leaf size for tree-based search (e.g., 30), and P for Minkowski distance power (e.g., 2). The model optimization process can optimize to maximize accuracy evaluated on the same or another training or validation set, or to minimize the time of training or testing, electric power consumption, or heat generation. This optimization can be applied every iteration or every Nth iteration during the distance calculation iterations on the model parameters.

In another illustrative example, the model being optimized can be a Gaussian Mixture Models (GMM) model. For such a model, the parameters and/or hyperparameters for which the parameter value(s) 334 are determined can include, but are not limited to, the number of components for Gaussians (e.g., 2), covariance type (e.g., full, tied, diag, spherical), max iterations for EM steps (e.g., 100), tolerance for convergence threshold (e.g., 0.001), initialization method for params init (e.g., kmeans), and number of initializations for runs (e.g., 1). The model optimization process can optimize to maximize accuracy evaluated on the same or another training or validation set, or to minimize the time of training or testing, electric power consumption, or heat generation. This optimization can be applied every data point or every Nth data point during the iteration on the model parameters.

In another illustrative example, the model being optimized can be a Principal Component Analysis (PCA) model. For such a model, the parameters and/or hyperparameters for which the parameter value(s) 334 are determined can include, but are not limited to, the number of components for dimensions to keep (e.g., 2), whiten for data (e.g., True or False), SVD solver for method (e.g., auto, full, arpack), tolerance for randomized solver (e.g., 0.0), and iterated power for power iterations (e.g., auto). The model optimization process can optimize to maximize accuracy evaluated on the same or another training or validation set, or to minimize the time of training or testing, electric power consumption, or heat generation. This optimization can be applied every principal component is added or every Nth principal component is added during the iteration on the model parameters.

In another illustrative example, the model being optimized can be a t-distributed Stochastic Neighbor Embedding (t-SNE) model. For such a model, the parameters and/or hyperparameters for which the parameter value(s) 334 are determined can include, but are not limited to, perplexity related to neighbors (e.g., 30), the number of components for output dimensions (e.g., 2), learning rate for optimization rate (e.g., 200), max iterations for steps (e.g., 1000), early exaggeration for cluster tightness (e.g., 12.0), metric for distance measure (e.g., Euclidean), and initialization for Principal Component Analysis (PCA) or random. The model optimization process can optimize to maximize accuracy evaluated on the same or another training or validation set, or to minimize the time of training or testing, electric power consumption, or heat generation. This optimization can be applied every or every Nth step of iteration on the model parameters.

In another illustrative example, the model being optimized can be a Uniform Manifold Approximation and Projection (UMAP) model. For such a model, the parameters and/or hyperparameters for which the parameter value(s) 334 are determined can include, but are not limited to, the number of neighbors for local connectivity (e.g., 15), the number of components for output dimensions (e.g., 2), minimum distance between points (e.g., 0.1), metric for distance measure (e.g., Euclidean), learning rate for optimization rate (e.g., 1.0), the number of epochs for training iterations (e.g., 200), and negative sample rate for negative samples per positive (e.g., 5). The model optimization process can optimize to maximize accuracy evaluated on the same or another training or validation set, or to minimize the time of training or testing, electric power consumption, or heat generation. This optimization can be applied every data point or every Nth data point during Nearest Neighbor Search on the model parameters.

In another illustrative example, the model being optimized can be a Feedforward Neural Network (FNN). For such a model, the parameters and/or hyperparameters for which the parameter value(s) 334 are determined can include, but are not limited to, the number of layers for input, hidden, output (e.g., 3), the number of neurons per layer for units (e.g., 128), activation function for non-linearity (e.g., ReLU), dropout rate for fraction dropped (e.g., 0.2), weight initialization for scheme (e.g., Xavier), bias for per-neuron bias (e.g., enabled or disabled), connectivity for fully connected or sparse, learning rate for update size (e.g., 0.001), learning rate for value (e.g., 0.001), optimizer for type (e.g., Adam), batch size for samples per update (e.g., 32), epochs for training passes (e.g., 100), momentum for Stochastic Gradient Descent (SGD) (e.g., 0.9), weight decay for L2 penalty (e.g., 0.0001), and learning rate schedule for decay type (e.g., step). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Multilayer Perceptrons (MLP) model. For such a model, the parameters and/or hyperparameters for which the parameter value(s) 334 are determined can include, but are not limited to, the number of hidden layers for count (e.g., 2), neurons per hidden layer for units (e.g., 256), activation function for non-linearity (e.g., ReLU), dropout rate for fraction dropped (e.g., 0.3), weight initialization for scheme (e.g., Glorot), bias for per-neuron bias, input/output dimensions for task-dependent, learning rate for update size (e.g., 0.001), learning rate for value (e.g., 0.001), optimizer for type (e.g., Adam), batch size for samples per update (e.g., 64), epochs for training iterations (e.g., 100), momentum for SGD (e.g., 0.9), weight decay for L2 penalty (e.g., 0.00001), and learning rate schedule for decay type (e.g., cosine). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Convolutional Neural Network (CNN). For such a model, the parameters and/or hyperparameters for which the parameter value(s) 334 are determined can include, but are not limited to, filter size for kernel size (e.g., 3×3), the number of filters for filters per layer (e.g., 64), stride for step size (e.g., 1), padding for type (e.g., same), dilation rate for kernel spacing (e.g., 1), input channels for input depth (e.g., 3), output channels for output feature maps, activation function for non-linearity (e.g., ReLU), weight initialization for scheme (e.g., He), bias for per-filter bias, groups for grouped convolutions (e.g., 1), pooling type for max or average, pooling size for kernel size (e.g., 2×2), pooling stride for step size (e.g., 2), dropout rate for fraction dropped (e.g., 0.3), learning rate for update size (e.g., 0.0001), learning rate for value (e.g., 0.0001), optimizer for type (e.g., Adam), batch size for samples per update (e.g., 32), epochs for training passes (e.g., 50), momentum for SGD (e.g., 0.9), weight decay for L2 penalty (e.g., 0.0001), and learning rate schedule for decay type (e.g., cosine). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Recurrent Neural Network (RNN). For such a model, the parameters and/or hyperparameters for which the parameter value(s) 334 are determined can include, but are not limited to, the number of recurrent layers for stacked layers (e.g., 2), hidden state size for units (e.g., 128), activation function for non-linearity (e.g., Tanh), dropout rate for fraction dropped (e.g., 0.2), weight initialization for scheme (e.g., Xavier), bias for input/recurrent connections, sequence length for max length, bidirectional for enabled/disabled, learning rate for update size (e.g., 0.0001), learning rate for update size (e.g., 0.0001), optimizer for type (e.g., Adam), batch size for samples per update (e.g., 32), epochs for training passes (e.g., 50), gradient clipping for max norm (e.g., 1.0), weight decay for L2 penalty (e.g., 0.00001), and learning rate schedule for decay type (e.g., exponential). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Long Short-Term Memory Network (LSTM). For such a model, the parameters and/or hyperparameters for which the parameter value(s) 334 are determined can include, but are not limited to, the number of LSTM layers for stacked layers (e.g., 2), hidden state size for units (e.g., 128), activation functions for sigmoid for gates, Tanh for output, dropout rate for fraction dropped (e.g., 0.2), weight initialization for scheme (e.g., Glorot), bias for gates (input, forget, output, cell), forget gate bias for initial bias (e.g., 1.0), sequence length for max length, bidirectional for enabled/disabled, learning rate for update size (e.g., 0.0001), learning rate for value (e.g., 0.0001), optimizer for type (e.g., Adam), batch size for samples per update (e.g., 32), epochs for training passes (e.g., 50), gradient clipping for max norm (e.g., 1.0), weight decay for L2 penalty (e.g., 0.00001), and learning rate schedule for decay type (e.g., cosine). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Gated Recurrent Units (GRU) model. For such a model, the parameters and/or hyperparameters for which the parameter value(s) 334 are determined can include, but are not limited to, the number of GRU layers for stacked layers (e.g., 2), hidden state size for units (e.g., 128), activation functions for sigmoid for gates, Tanh for candidate, dropout rate for fraction dropped (e.g., 0.2), weight initialization for scheme (e.g., Xavier), bias for update, reset, candidate gates, sequence length for max length, bidirectional for enabled/disabled, learning rate for update size (e.g., 0.0001), learning rate for value (e.g. 0.0001), optimizer for type (e.g., Adam), batch size for samples per update (e.g., 32), epochs for training passes (e.g., 50), gradient clipping for max norm (e.g., 1.0), weight decay for L2 penalty (e.g., 0.00001), and learning rate schedule for decay type (e.g., exponential). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Transformer. For such a model, the parameters and/or hyperparameters for which the parameter value(s) 334 are determined can include, but are not limited to, the number of layers for encoder/decoder layers (e.g., 6), the number of attention heads for heads (e.g., 8), type of attention heads, phase shifts in data, hidden size for embedding size (e.g., 512), feedforward dimension for feedforward size (e.g., 2048), dropout rate for fraction dropped (e.g., 0.1), activation function for feedforward non-linearity (e.g., gaussian error linear unit (GELU)), weight initialization for scheme (e.g., Xavier), attention type for self, cross, causal, positional encoding for type (sinusoidal, learned), layer normalization for epsilon (e.g., 0.00001), learning rate for update size (e.g., 0.00001), learning rate for value (e.g. 0.00001), optimizer for type (e.g., AdamW), batch size for samples per update (e.g., 16), epochs for training passes (e.g., 10), warmup steps for learning rate (e.g., 4000), weight decay for L2 penalty (e.g., 0.01), and learning rate schedule for type (e.g., cosine). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be an Autoencoder. For such a model, the parameters and/or hyperparameters for which the parameter value(s) 334 are determined can include, but are not limited to, the number of layers for encoder/decoder layers, layer sizes for neurons per layer (e.g., 256, 128), activation function for non-linearity (e.g., ReLU), dropout rate for fraction dropped (e.g., 0.2), weight initialization for scheme (e.g., Xavier), bias for per-layer bias, bottleneck size for latent size (e.g., 32), learning rate for update size (e.g., 0.001), learning rate for value (e.g., 0.001), optimizer for type (e.g., Adam), batch size for samples per update (e.g., 32), epochs for training passes (e.g., 50), weight decay for L2 penalty (e.g., 0.00001), learning rate schedule for decay type (e.g., step), and reconstruction loss for loss type (e.g., MSE). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Denoising Autoencoder. For such a model, the parameters and/or hyperparameters for which the parameter value(s) 334 are determined can include, but are not limited to, the number of layers for encoder/decoder layers, layer sizes for neurons per layer (e.g., 256), activation function for non-linearity (e.g., ReLU), dropout rate for fraction dropped (e.g., 0.2), weight initialization for scheme (e.g., Xavier), bias for per-layer bias, noise type for Gaussian, dropout, etc., noise level for intensity (e.g., 0.1), learning rate for update size (e.g., 0.001), learning rate for value (e.g., 0.001), optimizer for type (e.g., Adam), batch size for samples per update (e.g., 32), epochs for training passes (e.g., 50), weight decay for L2 penalty (e.g., 0.00001), learning rate schedule for decay type (e.g., cosine), and reconstruction loss for loss type (e.g., MSE). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Variational Autoencoder (VAE). For such a model, the parameters and/or hyperparameters for which the parameter value(s) 334 are determined can include, but are not limited to, the number of layers for encoder/decoder layers, layer sizes for neurons per layer (e.g., 256), activation function for non-linearity (e.g., ReLU), dropout rate for fraction dropped (e.g., 0.2), weight initialization for scheme (e.g., Xavier), bias for per-layer bias, latent dimension for latent size (e.g., 2), Kullback-Leibler (KL) divergence weight for scaling factor (e.g., 1.0), learning rate for update size (e.g., 0.0001), learning rate for value (e.g., 0.0001), optimizer for type (e.g., Adam), batch size for samples per update (e.g., 32), epochs for training passes (e.g., 50), weight decay for L2 penalty (e.g., 0.00001), learning rate schedule for decay type (e.g., warmup), and reconstruction loss for loss type (e.g., Mean Square Error (MSE)). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Graph Neural Network (GNN). For such a model, the parameters and/or hyperparameters for which the parameter value(s) 334 are determined can include, but are not limited to, the number of layers for message-passing layers (e.g., 2), hidden dimension for node feature size (e.g., 64), aggregation function for mean, sum, max, activation function for non-linearity (e.g., ReLU), dropout rate for fraction dropped (e.g., 0.2), weight initialization for scheme (e.g., Xavier), bias for per-layer bias, graph connectivity for adjacency matrix, learning rate for update size (e.g., 0.001), learning rate for value (e.g., 0.001), optimizer for type (e.g., Adam), batch size for graphs per update (e.g., 32), epochs for training passes (e.g., 50), weight decay for L2 penalty (e.g., 0.00001), and learning rate schedule for decay type (e.g., step). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Graph Convolutional Network (GCN). For such a model, the parameters and/or hyperparameters for which the parameter value(s) 334 are determined can include, but are not limited to, the number of layers for convolutional layers (e.g., 2), hidden dimension for node feature size (e.g., 32), aggregation function for normalized sum, activation function for non-linearity (e.g., ReLU), dropout rate for fraction dropped (e.g., 0.2), weight initialization for scheme (e.g., Glorot), bias for per-layer bias, adjacency matrix for graph structure, learning rate for update size (e.g., 0.001), learning rate for value (e.g., 0.001), optimizer for type (e.g., Adam), batch size for graphs per update (e.g., 32), epochs for training passes (e.g., 50), weight decay for L2 penalty (e.g., 0.00001), and learning rate schedule for decay type (e.g., cosine). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Graph Attention Network (GAT). For such a model, the parameters and/or hyperparameters for which the parameter value(s) 334 are determined can include, but are not limited to, the number of layers for attention layers (e.g., 2), hidden dimension for node feature size (e.g., 64), the number of attention heads for heads per layer (e.g., 8), attention mechanism for attention type (e.g., additive), activation function for non-linearity (e.g., ReLU), dropout rate for fraction dropped (e.g., 0.2), weight initialization for scheme (e.g., Xavier), bias for per-layer bias, adjacency matrix for graph structure, learning rate for update size (e.g., 0.001), learning rate for value (e.g., 0.001), optimizer for type (e.g., Adam), batch size for graphs per update (e.g., 32), epochs for training passes (e.g., 50), weight decay for L2 penalty (e.g., 0.00001), and learning rate schedule for decay type (e.g., cosine). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Q-Learning model. For such a model, the parameters and/or hyperparameters for which the parameter value(s) 334 are determined can include, but are not limited to, Q-table size for state-action space (discrete only), learning rate for update size (e.g., 0.1), learning rate for value (e.g., 0.1), discount factor for gamma (e.g., 0.99), epsilon for exploration rate (e.g., 0.1), epsilon decay for decay rate (e.g., 0.995), min epsilon for min exploration (e.g., 0.01), and episodes for training episodes (e.g., 1000). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Deep Q-Network (DQN). For such a model, the parameters and/or hyperparameters for which the parameter value(s) 334 are determined can include, but are not limited to, the number of layers for FNN layers (e.g., 3), the number of neurons per layer for units (e.g., 128), activation function for non-linearity (e.g., ReLU), dropout rate for fraction dropped (e.g., 0.2), weight initialization for scheme (e.g., Xavier), bias for per-neuron bias, learning rate for update size (e.g., 0.0001), learning rate for value (e.g., 0.0001), optimizer for type (e.g., Adam), batch size for samples per update (e.g., 32), episodes for training episodes (e.g., 1000), discount factor for gamma (e.g., 0.99), epsilon for exploration rate (e.g., 1.0), epsilon decay for decay rate (e.g., 0.995), target network update for steps (e.g., 1000), and replay buffer size for memory size (e.g., 1e6). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be a Policy Gradient Method model, such as REINFORCE (Reward Increment=Nonnegative Factor×Offset Reinforcement×Characteristic Eligibility). For such a model, the parameters and/or hyperparameters for which the parameter value(s) 334 are determined can include, but are not limited to, the number of layers for policy network layers (e.g., 2), the number of neurons per layer for units (e.g., 64), activation function for non-linearity (e.g., ReLU), dropout rate for fraction dropped (e.g., 0.2), weight initialization for scheme (e.g., Xavier), bias for per-neuron bias, learning rate for update size (e.g., 0.001), learning rate for value (e.g., 0.001), optimizer for type (e.g., Adam), batch size for trajectories per update (e.g., 32), episodes for training episodes (e.g., 1000), discount factor for gamma (e.g., 0.99), and baseline for using value function (e.g., True or False). The model optimization process can optimize to maximize accuracy evaluated on the same or another training or validation set, or to minimize the time of training or testing, electric power consumption, or heat generation. This optimization can be applied every epoch, batch, step, iteration, cycle, sample, feature, stage, round, and/or time unit during the iteration on the model parameters.

In another illustrative example, the model being optimized can be an Actor-Critic Methods model. For such a model, the parameters and/or hyperparameters for which the parameter value(s) 334 are determined can include, but are not limited to, actor layers for policy network layers (e.g., 2), critic layers for value network layers (e.g., 2), neurons per layer for units (e.g., 64), activation function for non-linearity (e.g., ReLU), dropout rate for fraction dropped (e.g., 0.2), weight initialization for scheme (e.g., Xavier), bias for per-neuron bias, learning rate actor for update size (e.g., 0.0001), learning rate critic for update size (e.g., 0.001), optimizer for type (e.g., Adam), batch size for trajectories per update (e.g., 32), episodes for training episodes (e.g., 1000), discount factor for gamma (e.g., 0.99), and entropy coefficient for exploration (e.g., 0.01). The model optimization process can optimize to maximize accuracy evaluated on the same or another training or validation set, or to minimize the time of training or testing, electric power consumption, or heat generation. This optimization can be applied every update, epoch, batch, step, iteration, cycle, sample, feature, stage, round, and/or time unit during the iteration on the model parameters.

In another illustrative example, the model being optimized can be a Proximal Policy Optimization (PPO) model. For such a model, the parameters and/or hyperparameters for which the parameter value(s) 334 are determined can include, but are not limited to, actor layers for policy network layers (e.g., 2), critic layers for value network layers (e.g., 2), neurons per layer for units (e.g., 64), activation function for non-linearity (e.g., ReLU), dropout rate for fraction dropped (e.g., 0.2), weight initialization for scheme (e.g., Xavier), bias for per-neuron bias, learning rate for update size (e.g., 0.0003), learning rate for value (e.g., 0.0003), optimizer for type (e.g., Adam), batch size for trajectories per update (e.g., 64), episodes for training episodes (e.g., 1000), discount factor for gamma (e.g., 0.99), clip parameter for policy update clip (e.g., 0.2), value loss coefficient for weight (e.g., 0.5), entropy coefficient for exploration (e.g., 0.01), and GAE lambda for advantage estimation (e.g., 0.95). The model optimization process can optimize to maximize accuracy evaluated on the same or another training or validation set, or to minimize the time of training or testing, electric power consumption, or heat generation. This optimization can be applied every update, epoch, batch, step, iteration, cycle, sample, feature, stage, round, and/or time unit during the iteration on the model parameters.

In some examples, the second machine learning model 110 can suggest for the first machine learning model 105 (e.g., which may initially be a random forest, for instance), to be completely regenerated as a different kind of ML model (e.g., neural network), when optimization and/or exploration and/or feedback and/or processing characteristics of first machine learning model 105 during training and/or in production do not meet expected processing characteristics thresholds.

In some examples, the model being optimized can be probabilistic model and/or Bayesian model. For instance, in another illustrative example, the model being optimized can be a Bayesian Linear Regression model. For such a model, the parameters and/or hyperparameters for which the parameter value(s) 334 are determined can include, but are not limited to, coefficients for feature weights (e.g., distribution), intercept for bias term (e.g., distribution), prior mean for mean for weights (e.g., 0), prior variance for variance for weights (e.g., 1.0), and noise variance for observation noise (e.g., 1.0). The model optimization process can optimize to maximize accuracy evaluated on the same or another training or validation set, or to minimize the time of training or testing, electric power consumption, or heat generation. This optimization can be applied every step, or every Zth step, of any iteration on the model parameters.

In another illustrative example, the model being optimized can be a Bayesian Neural Networks model. For such a model, the parameters and/or hyperparameters for which the parameter value(s) 334 are determined can include, but are not limited to, the number of layers for hidden layers (e.g., 2), neurons per layer for units (e.g., 128), activation function for non-linearity (e.g., ReLU), dropout rate for fraction dropped (e.g., 0.2, often variational), weight initialization for scheme (e.g., Xavier), bias for per-neuron bias, learning rate for update size (e.g., 0.001), learning rate for value (e.g., 0.001), optimizer for type (e.g., Adam), batch size for samples per update (e.g., 32), epochs for training passes (e.g., 100), prior variance for weight prior (e.g., 1.0), noise variance for observation noise (e.g., 0.1), and KL weight for scaling for KL term (e.g., 1.0). The model optimization process can optimize to maximize accuracy evaluated on the same or another training or validation set, or to minimize the time of training or testing, electric power consumption, or heat generation. This optimization can be applied every (or every Nth) update, epoch, batch, step, iteration, cycle, sample, feature, stage, round, and/or time unit during the iteration on the model parameters. The optimization can be done separately or independently for every feature, feed-forward process, back-propagation process, data point, neuron, layer, network, separately, or every step, or every Zth step of any other iteration.

In another illustrative example, the model being optimized can be a Hidden Markov Model (HMM). For such a model, the parameters and/or hyperparameters for which the parameter value(s) 334 are determined can include, but are not limited to, the number of states for hidden states (e.g., 3), the number of observations for observable symbols (e.g., 2), transition matrix for state transitions, emission matrix for observation probabilities, initial state distribution for starting probabilities, max iterations for Baum-Welch steps (e.g., 100), and tolerance for convergence threshold (e.g., 0.0001). The model optimization process can optimize to maximize accuracy evaluated on the same or another training or validation set, or to minimize the time of training or testing, electric power consumption, or heat generation. This optimization can be applied every (or every Nth) state, transition matrix, emission matrix, observation update, epoch, batch, step, iteration, cycle, sample, feature, stage, round, and/or time unit during the iteration on the model parameters. The optimization can be done separately or independently for every state, observation, transition matrix, emission matrix, feature, data point, neuron, network, separately, or every step, or every Zth step of any other iteration.

In another illustrative example, the model being optimized can be a Generative Adversarial Network (GAN). For such a model, the parameters and/or hyperparameters for which the parameter value(s) 334 are determined can include, but are not limited to, generator layers for FNN/CNN layers (e.g., 4), discriminator layers for FNN/CNN layers (e.g., 4), neurons/filters per layer for units/filters (e.g., 128), activation function for non-linearity (e.g., ReLU, LeakyReLU), dropout rate for fraction dropped (e.g., 0.3), weight initialization for scheme (e.g., Xavier), bias for per-layer bias, noise dimension for latent vector size (e.g., 100), learning rate generator for update size (e.g., 2e-4), learning rate discriminator for update size (e.g., 2e-4), optimizer for type (e.g., Adam), batch size for samples per update (e.g., 64), epochs for training passes (e.g., 100), beta1 for Adam parameter (e.g., 0.5), and loss type for GAN loss (e.g., minimax, Wasserstein). The model optimization process can optimize to maximize accuracy evaluated on the same or another training or validation set, or to minimize the time of training or testing, electric power consumption, or heat generation. This optimization can be applied every (or every Nth) epoch, batch, step, iteration, cycle, sample, feature, stage, round, and/or time unit during the iteration on the model parameters. The optimization can be done separately or independently for every feature, filter, feed-forward process, back-propagation process, data point, neuron, layer, separately, every step, or every Zth step of any other iteration.

In another illustrative example, the model being optimized can be a Conditional GAN. For such a model, the parameters and/or hyperparameters for which the parameter value(s) 334 are determined can include, but are not limited to, generator layers for FNN/CNN layers (e.g., 4), discriminator layers for FNN/CNN layers (e.g., 4), neurons/filters per layer for units/filters (e.g., 128), activation function for non-linearity (e.g., ReLU), dropout rate for fraction dropped (e.g., 0.3), weight initialization for scheme (e.g., Xavier), bias for per-layer bias, noise dimension for latent vector size (e.g., 100), condition dimension for label input size, learning rate generator for update size (e.g., 2e-4), learning rate discriminator for update size (e.g., 2e-4), optimizer for type (e.g., Adam), batch size for samples per update (e.g., 64), epochs for training passes (e.g., 100), beta1 for Adam parameter (e.g., 0.5), and loss type for GAN loss (e.g., minimax). The model optimization process can optimize to maximize accuracy evaluated on the same or another training or validation set, or to minimize the time of training or testing, electric power consumption, or heat generation. This optimization can be applied every (or every Nth) epoch, batch, step, iteration, cycle, sample, feature, stage, round, and/or time unit during the iteration on the model parameters. The optimization can be done separately or independently for every feature, filter, feed-forward process, back-propagation process, data point, neuron, layer, separately, or every step, or every Zth step, of any other iteration.

In another illustrative example, the model being optimized can be a Diffusion Model. For such a model, the parameters and/or hyperparameters for which the parameter value(s) 334 are determined can include, but are not limited to, the number of layers for U-Net or similar (e.g., 4), channels per layer for feature channels (e.g., 64), activation function for non-linearity (e.g., ReLU), dropout rate for fraction dropped (e.g., 0.1), weight initialization for scheme (e.g., Xavier), bias for per-layer bias, time steps for diffusion steps (e.g., 1000), learning rate for update size (e.g., 0.0001), learning rate for value (e.g., 0.0001), optimizer for type (e.g., Adam), batch size for sample and/or time units per update (e.g., 32), epochs for training passes (e.g., 100), beta schedule for noise schedule (e.g., linear, cosine), and weight decay for L2 penalty (e.g., 0.00001). The model optimization process can optimize to maximize accuracy evaluated on the same or another training or validation set, or to minimize the time of training or testing, electric power consumption, or heat generation. This optimization can be applied every (or every Nth) epoch, batch, step, iteration, cycle, sample, feature, stage, round, and/or time unit during the iteration on the model parameters. The optimization can be done separately or independently for every feature, neuron, filter, feed-forward process, back-propagation process, data point, neuron, layer, separately, or every step, or every Zth step, of any other iteration.

In another illustrative example, the model being optimized can be a Bagging model. For such a model, the parameters and/or hyperparameters for which the parameter value(s) 334 are determined can include, but are not limited to, the number of estimators for base models (e.g., 50), base estimator for model type (e.g., DecisionTree), max depth for tree-based (e.g., None), bootstrap for using bootstrapping (e.g., True or False), max samples for data fraction per model (e.g., 1.0), max features for feature fraction (e.g., 1.0), and number of jobs for parallel models (e.g., −1). The model optimization process can optimize to maximize accuracy evaluated on the same or another training or validation set, or to minimize the time of training or testing, electric power consumption, or heat generation. This optimization can be applied every (or every Nth) added base estimator or base model, epoch, batch, iteration, step, iteration, cycle, sample, feature, stage, round, and/or time unit during the iteration on the model parameters. The optimization can be done separately or independently for every base model, every cross validation fold for every base model, or base estimator, every step or iteration of training a base estimator or base model, or every step, or every Zth step, of any other iteration.

In another illustrative example, the model being optimized can be a Stacking model. For such a model, the parameters and/or hyperparameters for which the parameter value(s) 334 are determined can include, but are not limited to, base estimators for a list of models (e.g., SVM, RF), meta-learner for final model (e.g., LogisticRegression), cross-validation folds for meta-features (e.g., 5), and passthrough for including original features (e.g., True or False). The model optimization process can optimize to maximize accuracy evaluated on the same or another training or validation set, or to minimize the time of training or testing, electric power consumption, or heat generation. This optimization can be applied every added meta-learner or base model, every evaluation, every cross-validation fold, every step of training or iteration of base estimator or base model, every epoch, batch, iteration, step, iteration, cycle, sample, feature, stage, round, and/or time unit during the iteration on the model parameters. The optimization can be done separately or independently for every base model, every cross validation fold for every base model, or base estimator, every step or iteration of training a base estimator or base model, or every step, or every Zth step, of any other iteration.

In another illustrative example, the model being optimized can be a Meta-Learning model, such as a Model-Agnostic Meta-Learning (MAML) model. For such a model, the parameters and/or hyperparameters for which the parameter value(s) 334 are determined can include, but are not limited to, the number of layers for base model layers (e.g., 2), neurons per layer for units (e.g., 64), activation function for non-linearity (e.g., ReLU), dropout rate for fraction dropped (e.g., 0.2), weight initialization for scheme (e.g., Xavier), bias for per-layer bias, inner learning rate for task update (e.g., 0.01), outer learning rate for meta-update (e.g., 0.001), optimizer for type (e.g., Adam), batch size for tasks per update (e.g., 4), epochs for meta-training passes (e.g., 100), and the number of inner steps for task updates (e.g., 5). The model optimization process can optimize to maximize accuracy evaluated on the same or another training or validation set, or to minimize the time of training or testing, electric power consumption, or heat generation. This optimization can be applied every (or every Nth) added layer, base model layer, evaluation, cross-validation fold, step of training or iteration of base estimator or base model or base layer, epoch, batch, iteration, step, iteration, cycle, sample, feature, stage, round, and/or time unit, during the iteration on the model parameters. In some examples, the optimization can be done separately or independently for every neuron, layer, feature, data point, base model, every cross validation fold for every base model, or base model layer, every step or iteration of training a base model layer or base model, every back-propagation process, every forward-feed process, or every step, or every Zth step, of any other iteration.

In another illustrative example, the model being optimized can be a Neuro-Symbolic AI model. For such a model, the parameters and/or hyperparameters for which the parameter value(s) 334 are determined can include, but are not limited to, neural layers for FNN/CNN layers (e.g., 2), neurons per layer for units (e.g., 128), activation function for non-linearity (e.g., ReLU), dropout rate for fraction dropped (e.g., 0.2), symbolic rules for the number of rules (task-dependent), learning rate for update size (e.g., 0.001), learning rate for value (e.g., 0.001), optimizer for type (e.g., Adam), batch size for samples per update (e.g., 32), epochs for training passes (e.g., 50), weight decay for L2 penalty (e.g., 0.00001), and rule weight for symbolic loss weight (e.g., 1.0). The model optimization process can optimize to maximize accuracy evaluated on the same or another training or validation set, or to minimize the time of training or testing, electric power consumption, or heat generation. This optimization can be applied every (or every Nth) epoch, batch, step, iteration, cycle, sample, feature, stage, round, and/or time unit during the iteration on the model parameters. In some examples, the optimization can be done separately or independently for every feature, feed-forward process, back-propagation process, data point, neuron, layer, separately, or every step, or every Zth step, of any other iteration.

In another illustrative example, the model being optimized can be a Self-Organizing Maps (SOM) model. For such a model, the parameters and/or hyperparameters for which the parameter value(s) 334 are determined can include, but are not limited to, map size for grid dimensions (e.g., 10×10), input dimension for feature size, neighborhood function for type (e.g., Gaussian), learning rate for update size (e.g., 0.5), learning rate for value (e.g., 0.5), sigma for neighborhood width (e.g., 1.0), iterations for training steps (e.g., 1000), and decay rate for learning rate/sigma (e.g., 0.1). The model optimization process can optimize to maximize accuracy evaluated on the same or another training or validation set, or to minimize the time of training or testing, electric power consumption, or heat generation. This optimization can be applied every (or every Nth) step or update during the iteration on the model parameters. The optimization can be done separately or independently for every feature, step, data point, visible unit, hidden unit, separately, or every step, or every Zth step, of any other iteration.

In another illustrative example, the model being optimized can be a Restricted Boltzmann Machines (RBM) model. For such a model, the parameters and/or hyperparameters for which the parameter value(s) 334 are determined can include, but are not limited to, the number of visible units for input size, the number of hidden units for units (e.g., 128), weight initialization for scheme (e.g., Gaussian), bias for visible/hidden units, learning rate for update size (e.g., 0.001), learning rate for value (e.g., 0.001), batch size fstep, iteration, cycle, sample, feature, stage, round, and/or time units per update (e.g., 32), epochs for training passes (e.g., 50), K for Gibbs sampling steps (e.g., 1), and momentum for updates (e.g., 0.9). The model optimization process can optimize to maximize accuracy evaluated on the same or another training or validation set, or to minimize the time of training or testing, electric power consumption, or heat generation. This optimization can be applied every (or every Nth) pass, step sampling step, or update during the iteration on the model parameters. The optimization can be done separately or independently for every feature, step, data point, visible unit, hidden unit, separately, or every step, or every Zth step, of any other iteration.

In some examples, the ML model(s) 325 can optimize any transform, accuracies for long context, accuracies for short context, and/or accuracy optimization for any context length or type. In some examples, the optimization can be applied to any neuron, weight, and/or feature too, statically. In some examples, within an optimized ML model, a weight is not given to ML model 9 out of 10 times, or it is not given to model 3 out of 10 times, regardless of which neuron requests or wants to have the weight. In some examples, within the optimized ML model to whichever neuron asks for a specific weight, the model may give that weight, every 3rd time to neuron A and every 5^{th} time neuron B. This can apply, not only to dropout, but to any parameters discussed herein. For example, every time neuron A gets input from neuron B from a prior layer, it will activate with Linear ⅗ times, but ⅖ it will be other type of activation (e.g., ReLu), specified specifically—or another type of activation, or the activation type will switch in sequence (learned optimal). However, when neuron A gets input from neuron B from prior layer, it will activate with ReLu ⅕ times, but ⅘ it will be other type of activation, specified specifically Linear or Tang—or just another type of activation will switch in the learned best sequence. In some examples, the ML model(s) 325 can generate the output(s) 330 using a contextual bandit algorithm, including various ways to calculate rewards, including Upper Confidence Bound (UCB), linear upper confidence bound (LinUCB), Thompson Sampling, Neural bandits (which parameters of can be further optimized, recursively).

In some examples, the ML model(s) 325 can generate the output(s) 330 using multi-arm bandit algorithms, including various ways to calculate rewards, including Upper Confidence Bound (UCB), LinUCB, Thompson Sampling, Neural bandits (which parameters of can be further optimized, recursively).

In some examples, the ML model(s) 325 can generate the output(s) 330 using Reinforcement Learning (RL) with Function Approximation, Bayesian Optimization, Supervised Learning (e.g., Random Forest) with Exploration (e.g., for the exploration phase 115), or a combination thereof.

In some examples, for each optimization step in training of a model to be optimized (e.g., the first machine learning model 105, being of any of the model types discussed herein) the complete context (e.g., the dropout configuration(s) 332 and/or parameter value(s) 334 for all parameters, either for feature, neuron, layer, node, tree, data point feature) and the accuracy (e.g., calculated on training or separate validation data) of the model can be added to another separate dataset (e.g., that is part of the storage subsystem 225 and/or the data store(s) 370), which can be referred to as a parameters configuration accuracy dataset. In some examples, this dataset, is, in each iteration, used to train another AI/ML model (e.g., random forest)—which can be referred to as a parameters configuration accuracy model, to predict accuracy (or any other performance metric or processing characteristic) for any new parameters configuration. This model can be, for example, the second machine learning model 110 and/or the ML model(s) 325. This prediction can be, for example the predicted processing characteristic(s) 336 corresponding to a dropout configuration(s) 332 and/or parameter value(s) 334. Iteratively then, such prediction of accuracy based on current parameters configuration (e.g., dropout configuration(s) 332 and/or parameter value(s) 334) and done by the parameters configuration accuracy model, is compared to actual calculated accuracy. And once accuracy of the parameters configuration accuracy model achieves a high level of accuracy (e.g., above a threshold) within given preset accuracy threshold of actual accuracy, for N steps, this parameters configuration accuracy model can be then used to predict accuracy (e.g., predicted processing characteristic(s) 336) for all other combinations of parameters (e.g., for all other parameters configurations, for instance including other dropout configuration(s) 332 and/or parameter value(s) 334), allowing optimal dropout configuration(s) 332 and/or parameter value(s) 334 to be found very efficiently (e.g., without the need to train and evaluate the model to be optimized each time).

Additional models (in addition to the parameters configuration accuracy model) can be trained using the machine learning system 300. For example, the machine learning system 300 can train a model to predict heat generation during training, a model to predict electric power usage, a model to predict time of training, based on dropout configuration(s) 332 and/or parameter value(s) 334. In the case of accuracy (and/or other processing characteristics and/or performance metrics such as heat generation), the ML model(s) 325 accuracy of the ML model(s) 325 can be continuously and/or periodically verified. For instance, the ML model(s) 325 can, for every few predictions (e.g., predicted processing characteristic(s) 336), test the prediction against the measured or observed processing characteristic(s), and update the ML model(s) 325 (e.g., via the update 360) based on any difference (e.g., where the difference is used as feedback 355).

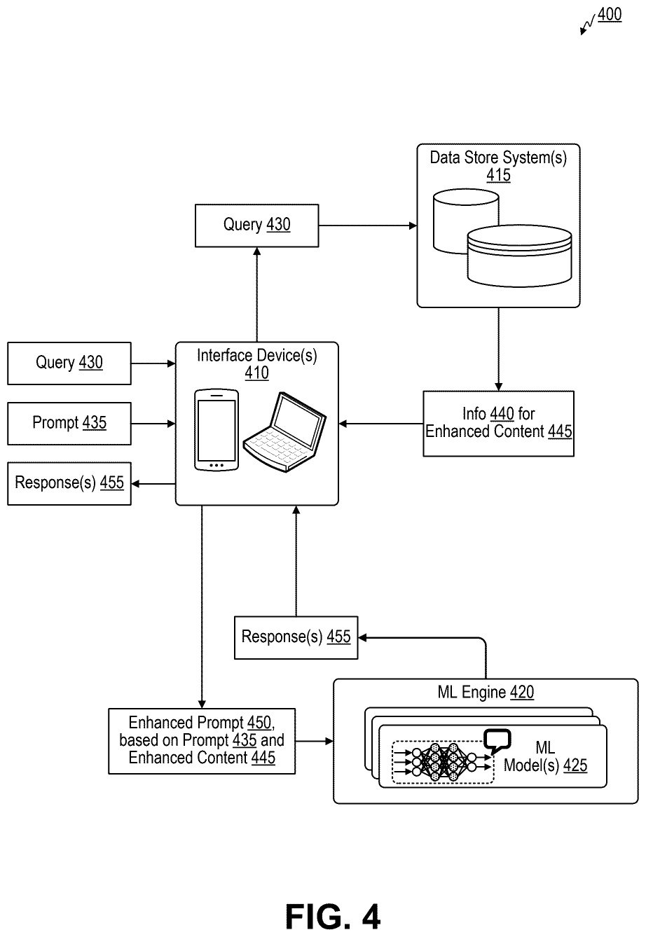

FIG. 4 is a block diagram illustrating a RAG system that may be used to implement some aspects of the technology. The RAG system 400 includes one or more interface device(s) 410 that can receive input(s) from a user and/or a user device, for instance by receiving a query 430 and/or a prompt 435 from the user and/or the system. The input(s) 305 can include, and/or be an example of, the prompt 435. The query 430 can be an example of the RAG query(s) 345 and/or a sub-query about a specific term in the input(s) 305 (e.g., in the prompt 435).

The interface device(s) 410 can send the query 430 to one or more data store system(s) 415 that include, and/or that have access to (e.g., over a network connection), various data store(s) (e.g., database(s), table(s), spreadsheet(s), tree(s), ledger(s), heap(s), and/or other data structure(s)). The data store system(s) 415 searches the data store(s) according to the query 430. In some examples, the interface device(s) 410 and/or the system(s) 415 convert the query 430 into tensor format (e.g., vector format and/or matrix format). In some examples, the data store system(s) 415 searches the data store(s) according to the query 430 by matching the query 430 with data in tensor format (e.g., vector format and/or matrix format) stored in the data store(s) that are accessible to the data store system(s) 415. The data store system(s) 415 retrieve, from the data store(s) and based on the query 430, information 440 that is relevant to generating enhanced content 445.

In some examples, the data store system(s) 415 provide the information 440 and/or the enhanced content 445 to the interface device(s) 410. In some examples, the data store system(s) 415 provide the information 440 to the interface device(s) 410, and the interface device(s) 410 generate the enhanced content 445 based on the information 440. The interface device(s) 410 provides the query 430, the prompt 435, the information 440, the enhanced content 445, and/or enhanced prompt 450 based on prompt 435 and enhanced content 445 to one or more ML model(s) 425 (e.g., ML model(s) 325) of an ML model engine 420 (e.g., ML engine 320). The ML model(s) 425 generate response(s) 455 that are responsive to the prompt 435. In some examples, the response(s) 455 may be, or may include, details and/or additional details of an object that the query is based on.

In some examples, the ML model(s) 425 generate the response(s) 455 (e.g., including the details of an object) based on the query 430, the prompt 435, the information 440, the enhanced content 445, and/or the enhanced prompt 450. In some examples, the ML model(s) 425 generate the response(s) 455 to include, or be based on, the information 440 and/or the enhanced content 445. The ML model(s) 425 provides the response(s) 455 to the interface device(s) 410. In some examples, the interface device(s) 410 output the response(s) 455 to the user (e.g., to the user device of the user) that provided the query 430 and/or the prompt 435. In some examples, the interface device(s) 410 output the response(s) 455 to the system (e.g., the other ML model) that provided the query 430 and/or the prompt 435 to the interface device(s) 410. In some examples, the data store system(s) 415 may include one or more ML model(s) that are trained to perform the search of the data store(s) based on the query 430.

In some examples, the system(s) 415 provides the information 440 and/or the enhanced content 445 directly to the ML model(s) 425, and the interface device(s) 410 provide the query 430 and/or the prompt 435 to the ML model(s) 425. The ML model engine 420 may be an example of the ML engine 320, or vice versa. The ML model(s) 425 may be example(s) of the first machine learning model 105, the second machine learning model 110, the ML model(s) 325, the ML model of FIG. 5, the neural network of FIG. 5, other neural networks discussed herein, other ML model(s) discussed herein, other AI algorithms discussed herein, or a combination thereof, or vice versa.

The data store system(s) 415 can output this information 440 to the interface device(s) 410 and/or the ML model engine 420. The data store system(s) 415, the interface device(s) 410, and/or the ML model engine 420 can modify the prompt 435 to add the enhanced content 445 and thereby generate the enhanced prompt 450. In some examples, the data store system(s) 415, the interface device(s) 410, and/or the ML model engine 420 adds or appends the information 440 and/or enhanced content 445 to the prompt 435 and/or the query 430 to generate the enhanced prompt 450. The data store system(s) 415, device(s) 410, and/or ML model engine 420 process the enhanced prompt 450 using the ML model(s) 425 to generate the response(s) 455. The response(s) 455 can be an example of the output data 195. In some cases, the response(s) 455 can include visualizations (e.g., as generated by the visualizer 185).

In an illustrative example, the interface device(s) 410 may receive the prompt 435 as one of the input(s) 305, requesting dropout configuration(s) 332, parameter value(s) 334, and/or predicted processing characteristic(s) 336 for a specific model to be optimized. The device(s) 410 extracts and/or generates the query 430 with information about the type of the model, and initiates a query of the data store system(s) 415 using the query 430 to retrieve information 440 for enhanced content 445, for instance indicating a list of types of parameters that can be modified (e.g., for the parameter value(s) 334) and/or any constraints on dropout (e.g., for the dropout configuration(s) 332) given the type of the model that is being optimized. The data store system(s) 415, the device(s) 410, the ML model engine 420, and/or another system can modify or enhance the prompt 435 to generate an enhanced prompt 450 that includes the enhanced content 445 (e.g., the additional context data about the parameters that can be modified for the model, and/or any constraints on dropout, given the type of the model). This enhanced prompt 450 is then processed using the ML model(s) 425 to generate the response(s) 455. In some examples, the ML model(s) 425 can use the information 440 and/or the enhanced content 445 (that is in the enhanced prompt 450) to help generate the response(s) 455.

FIG. 5 is a conceptual diagram illustrating a process 500 for dynamically updating an output 540 (that is generated using ML model(s)) in a continuous fashion as further data continues to be received over time, in accordance with some examples.

A data stream 505 is illustrated, and can represent, for instance, a stream of data to be input into the ML model(s) 325 to generate an output 540 (e.g., of one or more of the types of the output(s) 330, such as the dropout configuration(s) 332, the parameter value(s) 334, the predicted processing characteristic(s) 336, and/or the RAG query(s) 345). In some examples, the data stream 505 is an example of at least a portion of the information 310. In some examples, the data stream 505 can include any of the types of data discussed with respect to the information 310, such as user information, agent information, context information, or a combination thereof. The data stream 505 includes large quantities of data that continue to be received over a long period of time. For instance, the data stream 505 can include records of transactions that continue to occur over time. The output 540 can be an example of one or more of the output(s) 330, or vice versa.

In some examples, a system (e.g., the machine learning system 300, other systems discussed herein, or a combination thereof) can extract batches of data (e.g., batch 510, batch 520, batch 530) from the data stream 505 dynamically and in real-time (or near-real-time) as the data from the data stream 505 continues to be received by the system. In some examples, the system can process the batches of data (e.g., using the ML model(s) 325) dynamically and in real-time (or near-real-time) as the data from the data stream 505 continues to be received by the system to generate update(s) to an output 540 of the output(s) 330. For instance, the batch 510 undergoes processing 512 to generate the update 515. The batch 520 undergoes processing 522 to generate the update 525. The batch 530 undergoes processing 532 to generate the update 535. The system updates the output 540 (e.g., using the ML model(s) 325 of the machine learning system 300) based on the update 515, the update 525, and/or the update 535, sequentially, in parallel, and/or in further batches of updates. For instance, the batch 510, the batch 520, the batch 530, the update 515, the update 525, and/or the update 535 can be added into the information 310, the previous output(s) 315, and/or can otherwise be added into the input(s) 305. In this way, the system continues to update the output 540 as the data from the data stream 505 continues to be received by the system, so that the output 540 is up-to-date with the changes to the data stream 505.

In some examples, the data stream 505 may include, for instance, at least a portion of the information 310. In some examples, the processing 512, the processing 522, and/or the processing 532, can include processing operations applied by the ML model(s) 325 to the input(s) 305 to generate the output(s) 330. In some examples, the processing 512, the processing 522, and/or the processing 532, can include processing operations such as normalization, reformatting, conversion between data types, rearrangement of data, removal of outliers, correction of errors, or a combination thereof. In some examples, the processing 512, the processing 522, and/or the processing 532, can include processing operations using trained machine learning model(s) (e.g., the ML model(s) 325) to generate updates to the output 540. In some examples, the updates to the output 540 (e.g., update 515, update 525, update 535) can represent additional information (e.g., updates to the information 310) to be input into the ML model(s) 325 for analysis and updating of the output(s) 330 (e.g., the output 540). In some examples, the updates to the output 540 are each new and updated instances of the output 540. In some examples, the updates to the output 540 include differences compared to a previous instance of the output 540, so that the updates to the output 540 can be combined with the previous instance of the output 540 to generate an updated output 540.

In some examples, the updates (e.g., update 515, update 525, update 535) can include feedback 355, training data, fine-tuning data, context data, model parameters (e.g., temperature, top P, frequency penalty, presence penalty and/or other parameters or settings) for training, re-training, fine-tuning, and/or updating the ML model(s) 325 (e.g., as in the update 360) in addition to, or instead of, updating the output 540.

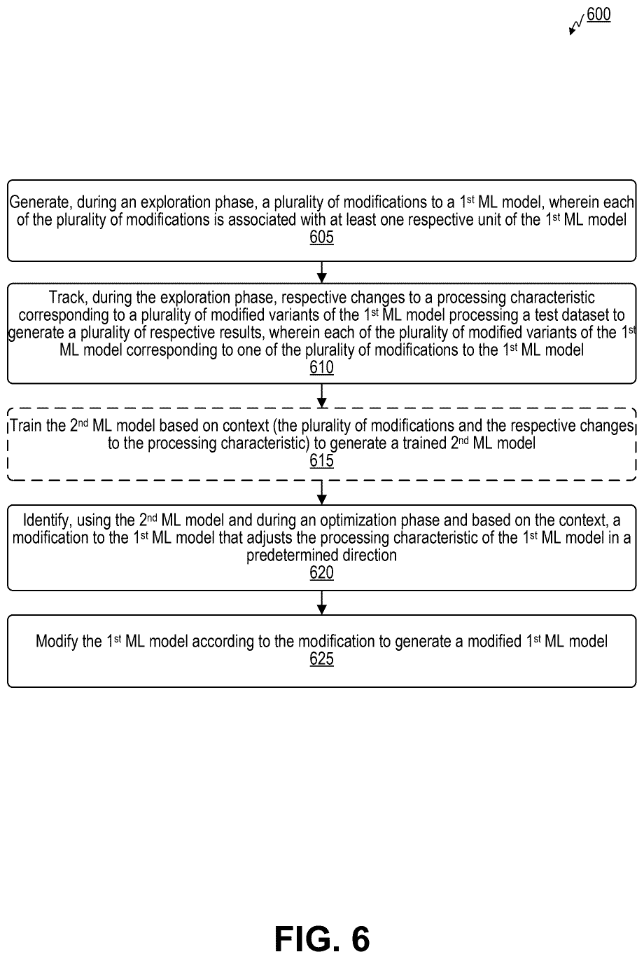

FIG. 6 is a flow diagram illustrating a process 600 for neural network optimization. The process 600 can be performed by an optimization system, such as a system that performs the process 100, the first machine learning model 105, the second machine learning model 110, the machine learning model optimization system 200, the ML model training subsystem 205, the configuration management subsystem 210, the evaluation subsystem 215, the optimization subsystem 220, the storage subsystem 225, the control subsystem 230, the machine learning system 300, the ML engine 320, the ML model(s) 325, the feedback engine(s) 350, the interface device(s) 410, the data store system(s) 415, the ML model engine 420, the ML model(s) 425, a computer system 700, a computing device, an apparatus, a processor executing instructions stored in a memory, a processor executing instructions stored in a non-transitory computer-readable storage medium, a component or sub-system of any of these systems, or a combination thereof.

At operation 605, the optimization system (or a subset or component thereof) is configured to, and can, generate, during an exploration phase (e.g., exploration phase 115), a plurality of modifications to a first machine learning model (e.g., the first machine learning model 105). Each of the plurality of modifications is associated with at least one respective unit (e.g., neuron, node, leaf, layer) of the first machine learning model. The first machine learning model may be any of the types of machine learning models discussed herein. In some aspects, the first machine learning model is a neural network. The first machine learning model can be referred to as the first trained machine learning model, or the trained first machine learning model. The unit may be referred to as an element, sub-unit, sub-element, or node. The unit may refer to a functional unit and/or a structural unit of the first machine learning model, such as a neuron, a node, a leaf (e.g., of a tree), a branch (e.g., of a tree), a layer, a connection, a weight, or some combination thereof.

The first machine learning model is an example of the first machine learning model 105, or vice versa. It should be understood that the first machine learning model of the process 600 can be another type of ML model, such as any of the types of ML models discussed with respect to FIG. 3. The modifications can include dropout configuration(s) and/or parameter value(s), such as the dropout configuration(s) that modify the first machine learning model 105 into the variant 120, the variant 130, the variant 140, and/or the variant 160.

At operation 610, the optimization system (or a subset or component thereof) is configured to, and can, track, during the exploration phase (e.g., exploration phase 115), respective changes to a processing characteristic corresponding to a plurality of modified variants of the first machine learning model processing a test dataset to generate a plurality of respective results. Each of the plurality of modified variants of the first machine learning model corresponds to one of the plurality of modifications to the first machine learning model.

The test dataset of operation 610 may be referred to as a validation dataset. The test dataset of operation 610 may be, or may include, a validation dataset instead of or in addition to the test dataset. In some aspects, the optimization system (or a subset or component thereof) is configured to, and can, compare the outputs of the

In some examples, at operation 615, the optimization system (or a subset or component thereof) is configured to, and can, train the second machine learning model based on context (e.g., the plurality of modifications and the respective changes to the processing characteristic) to generate a trained second machine learning model. Examples of the second machine learning model, and/or the trained second machine learning model, include the second machine learning model 110, the ML model(s) 325, the ML model(s) 425, stacked or blended ML models, other ML models discussed herein, or a combination thereof. The second machine learning model can be referred to as the second trained machine learning model, or the trained second machine learning model.

At operation 620, the optimization system (or a subset or component thereof) is configured to, and can, identify, using the (trained) second machine learning model and during an optimization phase (e.g., optimization phase 150) and based on context (e.g., the plurality of modifications and the respective changes to the processing characteristic), a modification to the first machine learning model that adjusts the processing characteristic of the first machine learning model in a predetermined direction (e.g., to increase or decrease each of the one or more processing characteristics). Examples of the modification include the dropout configuration(s) 332 and/or the parameter value(s) 334.

In some aspects, the processing characteristic is an accuracy, and the predetermined direction is an increase in the accuracy. In some aspects, the processing characteristic is a generalization error, and the predetermined direction is a decrease in the generalization error. In some aspects, the processing characteristic is a processing time to output generation, and the predetermined direction is a decrease in the processing time to output generation. In some aspects, the processing characteristic is a confidence, and the predetermined direction is an increase in the confidence. In some aspects, the processing characteristic is heat generation, and the predetermined direction is a decrease in the heat generation. In some aspects, the processing characteristic is power usage, and the predetermined direction is a decrease in the power usage.

At operation 625, the optimization system (or a subset or component thereof) is configured to, and can, modifying the first machine learning model according to the modification to generate a modified first machine learning model. The processing characteristic is further in the predetermined direction (e.g., higher if the predetermined direction is up, lower if the predetermined direction is down) in the modified first machine learning model than in the (unmodified) first machine learning model. The variant 160 of the first machine learning model 105 can be an example of the modified first machine learning model, or vice versa.

In some aspects, the modification to the first machine learning model includes removal of a unit (e.g., neuron, node, leaf, layer, or another subset of the first machine learning model) from the first machine learning model (e.g., dropout of the neuron, according to dropout configuration(s) 332), so that the unit is missing from the modified first machine learning model. In some aspects, the removal may be temporary. In some aspects, the removal may be permanent. In some aspects, the modification to the first machine learning model includes removal of at least a portion of a layer from the first machine learning model (e.g., dropout of at least the portion of the layer, according to dropout configuration(s) 332), so that at least the portion of the layer is missing from the modified first machine learning model. In some aspects, the removal may be temporary. In some aspects, the removal may be permanent.

In some aspects, the modification to the first machine learning model includes a change of a parameter of the first machine learning model from a first value to a second value (e.g., of the parameter value(s) 334), so that the parameter is set to the second value in the modified first machine learning model.

In some aspects, the optimization system (or a subset or component thereof) is configured to, and can, identify predicted changes to the processing characteristic (e.g., predicted processing characteristic(s) 336) for a plurality of modifications to the first machine learning model (e.g., different dropout configuration(s) 332 and/or parameter value(s) 334), and can select the modification (of operations 620-625) from the plurality of modifications based on the predicted changes to the processing characteristic.

In some aspects, the optimization system (or a subset or component thereof) is configured to, and can, identify, using the second machine learning model, a second modification to the first machine learning model that adjusts a second processing characteristic of the first machine learning model in a second predetermined direction. In some aspects, modifying the first machine learning model according to the modification (in operation 625) includes modifying the first machine learning model according to the modification and the second modification to generate the modified first machine learning model.

In some aspects, the optimization system (or a subset or component thereof) is configured to, and can, identify, using the second machine learning model, a second modification to the modified first machine learning model that adjusts the processing characteristic of the modified first machine learning model in the predetermined direction. The optimization system can modify the modified first machine learning model according to the second modification to generate a second modified first machine learning model.

In some aspects, the optimization system (or a subset or component thereof) is configured to, and can, identify, using the second machine learning model, a second modification to the modified first machine learning model that adjusts a second processing characteristic of the modified first machine learning model in a second predetermined direction. The optimization system can modify the modified first machine learning model according to the second modification to generate a second modified first machine learning model.

In some aspects, the optimization system (or a subset or component thereof) is configured to, and can, process an input dataset using the first machine learning model to produce a first output. In some aspects, the optimization system (or a subset or component thereof) is configured to, and can, process the input dataset using the modified first machine learning model to produce a second output. In some aspects, the first output is equivalent to the second output, but certain performance characteristics of the generation of the second output by the modified first machine learning model differ from performance characteristics of the generation of the first output by the first machine learning model (e.g., the modified first machine learning model generates the second output more quickly and/or efficiently than the first machine learning model generates the first output). In some aspects, the first output is different from the second output, for instance with the second output being more accurate than the first output.

In some aspects, the optimization system (or a subset or component thereof) is configured to, and can, process an input dataset using the modified first machine learning model to produce an output dataset. For instance, in some aspects, the modified first machine learning model (and the first machine learning model) is an LLM (or MLLM or GAN or transformer or similar type of model), the input dataset is a prompt, and the output dataset is a response that is conversationally responsive to the prompt, that summarizes the prompt, that generates new text and/or media data (e.g., images and/or video and/or audio) based on the prompt, or a combination thereof.

In some aspects, generating the plurality of modifications to the first machine learning model (in operation 605) includes generating the plurality of modifications based on one or more random values from a random number generator, generating the plurality of modifications using the second machine learning model (e.g., that determines modifications that are predicted to improve the processing characteristic and/or that haven't been previously tried), or a combination thereof.

In some aspects, the optimization system (or a subset or component thereof) is configured to, and can, generate a second plurality of modifications to the modified first machine learning model using the second machine learning model. The optimization system can track second changes to a second processing characteristic corresponding to a second plurality of modified variants of the modified first machine learning model. Each of the second plurality of modified variants of the modified first machine learning model corresponds to one of the second plurality of modifications. The optimization system can identify, using the second machine learning model and based on the second plurality of modifications, a second modification to the modified first machine learning model that adjusts the second processing characteristic of the modified first machine learning model in a second predetermined direction. The optimization system can modifying the modified first machine learning model according to the second modification to generate a second modified first machine learning model. In this way, the optimization system can perform a second round of exploration and/or optimization of the first machine learning model (e.g., first machine learning model 105), with the benefits of the second machine learning model (e.g., second machine learning model 110) already having chosen the modification of operation 620 and thus having more learning as to what modifications improve the first machine learning model 105 versus what modifications do not.

In some aspects, the process 600 includes applying various dropout configurations and/or parameter configurations (e.g., sets of parameter values to be changed) to different layers of the first machine learning model, evaluating each configuration based on its performance using machine learning techniques on a validation data set, and storing results of said evaluations in a database for future reference. In some aspects, the dropout configurations and/or parameter value configurations vary in which inputs (e.g., which neurons, nodes) are dropped from layers of the first machine learning model and/or which parameters are changed, and by how much. In some aspects, the evaluating operation is performed using at least one of: supervised learning, reinforcement learning, gradient descent, Monte Carlo methods, policy optimization, or a combination thereof. In some aspects, the process 600 includes selecting the optimal dropout configuration from the database based on performance measures including generalization error and accuracy. In some aspects, the dropout configurations and/or parameter value configurations are applied randomly or sequentially throughout the training process. In some aspects, the process 600 includes ceasing optimization of dropout configurations and/or parameter value configurations when a predefined criterion or threshold is reached or crossed (e.g., the predefined criterion or threshold associated with at least one of a specific generalization error rate, accuracy, and/or other processing characteristic, for instance to identify an improvement or downgrade in the processing characteristic). In some aspects, the machine learning techniques used for evaluation are further determined by a statistical significance test to assess the robustness of dropout impacts and/or parameter change impacts on the first machine learning model performance. In some aspects, the process 600 incorporates a context-specific adaptation approach that personalizes dropout configurations and/or parameter configurations based on the first machine learning model's evolving state during training phases.

In some aspects, the optimization system (or a subset or component thereof) includes a dropout management component (e.g., configuration management subsystem 210) configured to apply various dropout configurations and/or parameter value configurations (e.g., sets of parameter values to be changed) to the first machine learning model during training, an evaluation component (e.g., evaluation subsystem 215) configured to assess the performance of each dropout configuration and/or parameter value configuration using a validation data set, an optimization component (e.g., optimization subsystem 220) configured to select an optimal dropout configuration based on data from the evaluation component, and a storage component (e.g., storage subsystem 225) configured to record data related to dropout configurations and/or parameter value configurations and corresponding performance metrics. In some aspects, the dropout configurations involve disabling random inputs across different layers of the first machine learning model. In some aspects, the evaluation component utilizes at least one of: supervised learning, reinforcement learning, and/or contextual multi-arm bandit analysis, for assessing dropout configurations. In some aspects, the optimization component uses a contextual multi-arm bandit technique, which takes into account context such as dropout configuration, epoch count, batch identifier, step number, iteration number, cycle number, round number, stage number, and/or time unit number. In some aspects, the optimization system (or a subset or component thereof) includes a control component (e.g., control subsystem 230) that dynamically adjusts dropout configurations based on predefined performance thresholds. In some aspects, the performance thresholds include improvements in generalization error or accuracies between validated dataset performances. In some aspects, the dropout management component employs a supervised learning model to predict the effectiveness of dropout configurations based on past dropout performances. In some aspects, the optimization technique includes using a reinforcement learning approach where an agent learns to select dropout configurations that maximize a reward based on decreased generalization error or increased validation accuracy.

In some aspects, the process 600 includes dynamically adapting dropout rates and patterns, and/or parameter value configurations (e.g., sets of parameter values to be changed), based on performance feedback from an evaluation subsystem (e.g., optimization subsystem 220) using machine learning techniques, iteratively refining these dropout configurations and/or parameter value configurations through a learning process facilitated by an optimization subsystem, and storing and indexing these configurations for effective retrieval and reuse in training. In some aspects, the dropout configurations and/or parameter value configurations are managed in a way that explores all possible combinations before selecting an optimal configuration for application in subsequent training epochs. In some aspects, the adaptation involves machine learning techniques, such as gradient descent, Monte Carlo simulations, reinforcement learning models, other ML techniques, or combinations thereof.

In some aspects, the process 600 includes executing dropout changes and/or parameter changes during first machine learning model training based on historical data analyses, monitoring the live performance metrics to tweak the dropout configurations and/or parameter configurations (e.g., sets of parameter values to be changed) in real-time, and using a combination of contextual data elements (e.g., epoch number and/or batch number) to inform determination of dropout adjustments and/or parameter value changes that are directed to cause an optimization (e.g., improvement) in a specific performance metric or processing characteristic.

In some aspects, the process 600 includes collecting data on dropout configurations and/or parameter configurations and corresponding first machine learning model performance characteristics (e.g., via the configuration management subsystem 210 and the evaluation subsystem 215), storing this data in an organized manner for quick retrieval based on performance indices (e.g., via the storage subsystem 225), and using this data to inform decisions on future dropout strategies through an optimization subsystem (e.g., via the optimization subsystem 220 and/or the control subsystem 230). In some aspects, the stored data includes contextual information about the training process, and is used to predict future successful (e.g., predicted to result in improvements to processing characteristics and/or performance metrics) dropout configurations, parameter values, or combinations thereof.

In some aspects, the process 600 includes applying a sequence of dropout configurations and/or parameter value configurations to a first machine learning model, evaluating these configurations against a separate validation dataset to determine each configuration's effectiveness, and modifying future dropout configurations and/or parameter value configurations in response to acquired performance data for optimizing first machine learning model training outcomes. In some aspects, each dropout configuration is specifically tailored based on previous performances in similar contexts to refine the dropout application and/or parameter configuration during an ongoing training processes.

In some aspects, the process 600 includes ceasing optimization of dropout configurations and/or parameter configurations in a first machine learning model training process, based on criteria such as achieving a defined level of network performance on unseen data, and/or insufficient improvements (e.g., improvements providing a difference below a threshold difference) from further adjustments to dropout configurations and/or parameter value configurations.

Technical improvements that are brought about by the process 600 can include improvements to the first machine learning model (or other ML model that is being optimized) itself. For instance, the improvements can include improved (increased) accuracy of outputs, improved (increased) speed of generating outputs, improved (reduced) time to generate outputs, improved (increased) confidence in outputs, improved (reduced) generalization error, improved (reduced) heat generation, improved (reduced) power usage, improved (increased) energy efficiency, improved (reduced) need for heat dissipation (e.g., heatsinks, fans, or other coolers), improved (reduced) fan speed needed, improved (increased) longevity of equipment (e.g., drives, RAM, ROM, GPU, CPU, cores), improved (reduced) load for processing elements (e.g., cores, CPU, GPU), improved (reduced) memory use, improved (reduced) hard drive write or read rate, improved (reduced) hard drive errors, improved (reduced) RAM errors, improved (reduced) number of cores (e.g., CPU and/or GPU) needed, improved (reduced) number of files saved to and/or read from storage, improved (reduced) time of training, improved (reduced) loss, improved (increased) area under the curve (AUC), improved (increased) accuracy measures, improved (increased) sensitivity, improved (increased) specificity, improved (reduced) false positives, improved (reduced) false negatives, improved (increased) learning rate, improved (increased) context length, improved (increased) accuracy in long context (e.g. for LLM, transformers, autoencoders, GANs), improved (increased) accuracy in short context (e.g., for LLM, transformers, autoencoders, GANs), improved (increased) accuracy evaluated for a specific type of length of context (e.g., for LLM, transformers, autoencoders, GANs), improved (reduced) GAN rejection rate, improved (reduced) GAN rejection instances, improved other processing characteristics or performance metrics (e.g., assessed between intervals and/or between ranges such as comparison with a minimum threshold and a target threshold), or a combination thereof. The process 600 provides improves effectiveness and speed of optimization over grid search and/or other optimization techniques.

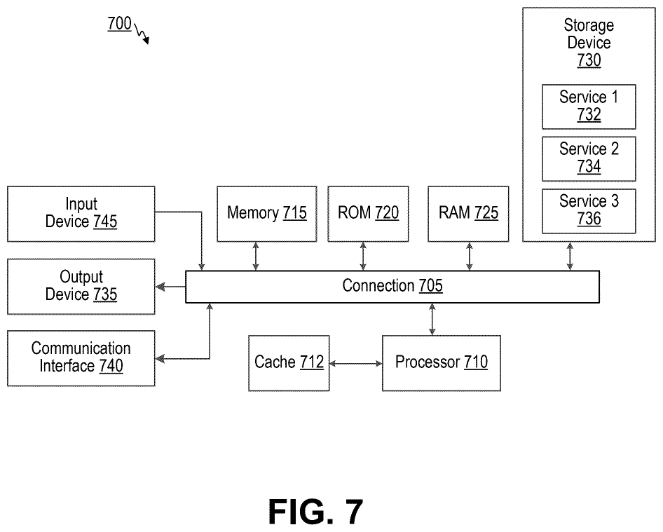

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communication interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity subsystem (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/etc.), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a subsystem, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, subsystems, circuits, and algorithm steps described in connection with the embodiments disclosed herein may be implemented as electronic hardware, computer software, firmware, or combinations thereof. To clearly illustrate this interchangeability of hardware and software, various illustrative components, blocks, subsystems, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as subsystems or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software subsystems or hardware subsystems configured for encoding and decoding, or incorporated in a combined video encoder-decoder (CODEC).

While various flow diagrams and block diagrams provided and described above may show a particular order of operations performed by some embodiments of the subject technology, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 700 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically in response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

Illustrative aspects of the disclosure include:
Aspect 1. A method of optimizing a first machine learning model using a second machine learning model, the method comprising: generating, during an exploration phase, a plurality of modifications to the first machine learning model, wherein each of the plurality of modifications is associated with at least one respective unit of the first machine learning model; tracking, during the exploration phase, respective changes to a processing characteristic corresponding to a plurality of modified variants of the first machine learning model processing a test dataset to generate a plurality of respective results, wherein each of the plurality of modified variants of the first machine learning model corresponds to one of the plurality of modifications to the first machine learning model; identifying, using a second machine learning model and during an optimization phase and based on context, a modification to the first machine learning model that adjusts the processing characteristic of the first machine learning model in a predetermined direction, wherein the context is associated with the plurality of modifications and the respective changes to the processing characteristic; and modifying the first machine learning model according to the modification to generate a modified first machine learning model.
Aspect 2. The method of aspect 1, wherein the modification to the first machine learning model includes removal of a unit from the first machine learning model, wherein the unit is missing from the modified first machine learning model.
Aspect 3. The method of aspect 1, wherein the modification to the first machine learning model includes removal of at least a portion of a layer from the first machine learning model, wherein at least the portion of the layer is missing from the modified first machine learning model.
Aspect 4. The method of aspect 1, wherein the modification to the first machine learning model includes a change of a parameter of the first machine learning model from a first value to a second value, wherein the parameter is set to the second value in the modified first machine learning model.
Aspect 5. The method of aspect 1, further comprising: identifying predicted changes to the processing characteristic for a plurality of modifications to the first machine learning model; and selecting the modification from the plurality of modifications based on the predicted changes to the processing characteristic.
Aspect 6. The method of aspect 1, further comprising: identifying, using the second machine learning model, a second modification to the first machine learning model that adjusts a second processing characteristic of the first machine learning model in a second predetermined direction, wherein modifying the first machine learning model according to the modification includes modifying the first machine learning model according to the modification and the second modification to generate the modified first machine learning model.
Aspect 7. The method of aspect 1, further comprising: identifying, using the second machine learning model, a second modification to the modified first machine learning model that adjusts the processing characteristic of the modified first machine learning model in the predetermined direction; and modifying the modified first machine learning model according to the second modification to generate a second modified first machine learning model.
Aspect 8. The method of aspect 1, further comprising: identifying, using the second machine learning model, a second modification to the modified first machine learning model that adjusts a second processing characteristic of the modified first machine learning model in a second predetermined direction; and modifying the modified first machine learning model according to the second modification to generate a second modified first machine learning model.
Aspect 9. The method of aspect 1, wherein the processing characteristic is an accuracy, and wherein the predetermined direction is an increase in the accuracy.
Aspect 10. The method of aspect 1, wherein the processing characteristic is a generalization error, and wherein the predetermined direction is a decrease in the generalization error.
Aspect 11. The method of aspect 1, wherein the processing characteristic is a processing time to output generation, and wherein the predetermined direction is a decrease in the processing time to output generation.
Aspect 12. The method of aspect 1, wherein the processing characteristic is a confidence, and wherein the predetermined direction is an increase in the confidence.
Aspect 13. The method of aspect 1, wherein the processing characteristic is heat generation, and wherein the predetermined direction is a decrease in the heat generation.
Aspect 14. The method of aspect 1, wherein the processing characteristic is power usage, and wherein the predetermined direction is a decrease in the power usage.
Aspect 15. The method of aspect 1, further comprising: training the second machine learning model based on the context before identifying the modification using the second machine learning model and based on the context, wherein the identifying the modification using the second machine learning model and based on the context includes identifying the modification using the second machine learning model and based on the training of the second machine learning model.
Aspect 16. The method of aspect 1, wherein generating the plurality of modifications to the first machine learning model includes generating the plurality of modifications based on one or more random values from a random number generator.
Aspect 17. The method of aspect 1, wherein generating the plurality of modifications to the first machine learning model includes generating the plurality of modifications using the second machine learning model.
Aspect 18. The method of aspect 1, further comprising: generating a second plurality of modifications to the modified first machine learning model using the second machine learning model; tracking second changes to a second processing characteristic corresponding to a second plurality of modified variants of the modified first machine learning model, wherein each of the second plurality of modified variants of the modified first machine learning model corresponds to one of the second plurality of modifications; identifying, using the second machine learning model and based on the second plurality of modifications, a second modification to the modified first machine learning model that adjusts the second processing characteristic of the modified first machine learning model in a second predetermined direction; and modifying the modified first machine learning model according to the second modification to generate a second modified first machine learning model.
Aspect 19. A system for optimizing a first machine learning model using a second machine learning model, the system comprising: a memory storing instructions; and a processor that executes the instructions, wherein execution of the instructions by the processor causes the processor to: generate, during an exploration phase, a plurality of modifications to the first machine learning model, wherein each of the plurality of modifications is associated with at least one respective unit of the first machine learning model; track, during the exploration phase, respective changes to a processing characteristic corresponding to a plurality of modified variants of the first machine learning model process a test dataset to generate a plurality of respective results, wherein each of the plurality of modified variants of the first machine learning model corresponds to one of the plurality of modifications to the first machine learning model; identify, using the trained second machine learning model and during an optimization phase and based on context, a modification to the first machine learning model that adjusts the processing characteristic of the first machine learning model in a predetermined direction, wherein the context is associated with the plurality of modifications and the respective changes to the processing characteristic; and modify the first machine learning model according to the modification to generate a modified first machine learning model.
Aspect 20. The system of aspect 19, wherein the modification to the first machine learning model includes removal of a neuron from the first machine learning model, wherein the unit is missing from the modified first machine learning model.
Aspect 21. The system of aspect 19, wherein the modification to the first machine learning model includes removal of at least a portion of a layer from the first machine learning model, wherein at least the portion of the layer is missing from the modified first machine learning model.
Aspect 22. The system of aspect 19, wherein the modification to the first machine learning model includes a change of a parameter of the first machine learning model from a first value to a second value, wherein the parameter is set to the second value in the modified first machine learning model.
Aspect 23. The system of aspect 19, wherein the execution of the instructions by the processor causes the processor to: identify predicted changes to the processing characteristic for a plurality of modifications to the first machine learning model; and select the modification from the plurality of modifications based on the predicted changes to the processing characteristic.
Aspect 24. The system of aspect 19, wherein the execution of the instructions by the processor causes the processor to: identify, using the second machine learning model, a second modification to the first machine learning model that adjusts a second processing characteristic of the first machine learning model in a second predetermined direction, wherein modifying the first machine learning model according to the modification includes modifying the first machine learning model according to the modification and the second modification to generate the modified first machine learning model.
Aspect 25. The system of aspect 19, wherein the execution of the instructions by the processor causes the processor to: identify, using the second machine learning model, a second modification to the modified first machine learning model that adjusts the processing characteristic of the modified first machine learning model in the predetermined direction; and modify the modified first machine learning model according to the second modification to generate a second modified first machine learning model.
Aspect 26. The system of aspect 19, wherein the execution of the instructions by the processor causes the processor to: identify, using the second machine learning model, a second modification to the modified first machine learning model that adjusts a second processing characteristic of the modified first machine learning model in a second predetermined direction; and modify the modified first machine learning model according to the second modification to generate a second modified first machine learning model.
Aspect 27. The system of aspect 19, wherein the processing characteristic is an accuracy, and wherein the predetermined direction is an increase in the accuracy.
Aspect 28. The system of aspect 19, wherein the processing characteristic is a generalization error, and wherein the predetermined direction is a decrease in the generalization error.
Aspect 29. The system of aspect 19, wherein the processing characteristic is a processing time to output generation, and wherein the predetermined direction is a decrease in the processing time to output generation.
Aspect 30. The system of aspect 19, wherein the processing characteristic is a confidence, and wherein the predetermined direction is an increase in the confidence.
Aspect 31. The system of aspect 19, wherein the processing characteristic is heat generation, and wherein the predetermined direction is a decrease in the heat generation.
Aspect 32. The system of aspect 19, wherein the processing characteristic is power usage, and wherein the predetermined direction is a decrease in the power usage.
Aspect 33. The system of aspect 19, wherein the execution of the instructions by the processor causes the processor to: train the second machine learning model based on the context before identifying the modification using the second machine learning model and based on the context, wherein the identifying the modification using the second machine learning model and based on the context includes identifying the modification using the second machine learning model and based on the training of the second machine learning model.
Aspect 34. The system of aspect 19, wherein generating the plurality of modifications to the first machine learning model includes generating the plurality of modifications based on one or more random values from a random number generator.
Aspect 35. The system of aspect 19, wherein generating the plurality of modifications to the first machine learning model includes generating the plurality of modifications using the second machine learning model.
Aspect 36. The system of aspect 19, wherein the execution of the instructions by the processor causes the processor to: generate a second plurality of modifications to the modified first machine learning model using the second machine learning model; track second changes to a second processing characteristic corresponding to a second plurality of modified variants of the modified first machine learning model, wherein each of the second plurality of modified variants of the modified first machine learning model corresponds to one of the second plurality of modifications; identify, using the second machine learning model and based on the second plurality of modifications, a second modification to the modified first machine learning model that adjusts the second processing characteristic of the modified first machine learning model in a second predetermined direction; and modify the modified first machine learning model according to the second modification to generate a second modified first machine learning model.
Aspect 37. A non-transitory computer-readable medium having stored thereon instructions that, when executed by at least one processor, cause the at least one processor to perform operations according to any of aspects 1 to 36.
Aspect 38. An apparatus for wireless communications, comprising one or more means for performing operations according to any of aspects 1 to 36.

What is claimed is:

1. A method of optimizing a first machine learning model using a second machine learning model, the method comprising:
generating, during an exploration phase, a plurality of modifications to the first machine learning model, wherein each of the plurality of modifications is associated with at least one respective unit of the first machine learning model;
tracking, during the exploration phase, respective changes to a processing characteristic corresponding to a plurality of modified variants of the first machine learning model processing a test dataset to generate a plurality of respective results, wherein each of the plurality of modified variants of the first machine learning model corresponds to one of the plurality of modifications to the first machine learning model;
identifying, using a second machine learning model and during an optimization phase and based on context, a modification to the first machine learning model that adjusts the processing characteristic of the first machine learning model in a predetermined direction, wherein the context is associated with the plurality of modifications and the respective changes to the processing characteristic; and
modifying the first machine learning model according to the modification to generate a modified first machine learning model.

2. The method of claim 1, wherein the modification to the first machine learning model includes removal of a unit from the first machine learning model, wherein the unit is missing from the modified first machine learning model.

3. The method of claim 1, wherein the modification to the first machine learning model includes removal of at least a portion of a layer from the first machine learning model, wherein at least the portion of the layer is missing from the modified first machine learning model.

4. The method of claim 1, wherein the modification to the first machine learning model includes a change of a parameter of the first machine learning model from a first value to a second value, wherein the parameter is set to the second value in the modified first machine learning model.

5. The method of claim 1, further comprising:
identifying predicted changes to the processing characteristic for a plurality of modifications to the first machine learning model; and
selecting the modification from the plurality of modifications based on the predicted changes to the processing characteristic.

6. The method of claim 1, further comprising:
identifying, using the second machine learning model, a second modification to the first machine learning model that adjusts a second processing characteristic of the first machine learning model in a second predetermined direction, wherein modifying the first machine learning model according to the modification includes modifying the first machine learning model according to the modification and the second modification to generate the modified first machine learning model.

7. The method of claim 1, further comprising:
identifying, using the second machine learning model, a second modification to the modified first machine learning model that adjusts the processing characteristic of the modified first machine learning model in the predetermined direction; and
modifying the modified first machine learning model according to the second modification to generate a second modified first machine learning model.

8. The method of claim 1, further comprising:
identifying, using the second machine learning model, a second modification to the modified first machine learning model that adjusts a second processing characteristic of the modified first machine learning model in a second predetermined direction; and
modifying the modified first machine learning model according to the second modification to generate a second modified first machine learning model.

9. The method of claim 1, wherein the processing characteristic is an accuracy, and wherein the predetermined direction is an increase in the accuracy.

10. The method of claim 1, wherein the processing characteristic is a generalization error, and wherein the predetermined direction is a decrease in the generalization error.

11. The method of claim 1, wherein the processing characteristic is a processing time to output generation, and wherein the predetermined direction is a decrease in the processing time to output generation.

12. The method of claim 1, wherein the processing characteristic is a confidence, and wherein the predetermined direction is an increase in the confidence.

13. The method of claim 1, wherein the processing characteristic is heat generation, and wherein the predetermined direction is a decrease in the heat generation.

14. The method of claim 1, wherein the processing characteristic is power usage, and wherein the predetermined direction is a decrease in the power usage.

15. The method of claim 1, further comprising:
training the second machine learning model based on the context before identifying the modification using the second machine learning model and based on the context, wherein the identifying the modification using the second machine learning model and based on the context includes identifying the modification using the second machine learning model and based on the training of the second machine learning model.

16. The method of claim 1, wherein generating the plurality of modifications to the first machine learning model includes generating the plurality of modifications based on one or more random values from a random number generator.

17. The method of claim 1, wherein generating the plurality of modifications to the first machine learning model includes generating the plurality of modifications using the second machine learning model.

18. The method of claim 1, further comprising:
generating a second plurality of modifications to the modified first machine learning model using the second machine learning model;
tracking second changes to a second processing characteristic corresponding to a second plurality of modified variants of the modified first machine learning model, wherein each of the second plurality of modified variants of the modified first machine learning model corresponds to one of the second plurality of modifications;
identifying, using the second machine learning model and based on the second plurality of modifications, a second modification to the modified first machine learning model that adjusts the second processing characteristic of the modified first machine learning model in a second predetermined direction; and
modifying the modified first machine learning model according to the second modification to generate a second modified first machine learning model.

19. A system for optimizing a first machine learning model using a second machine learning model, the system comprising:
a memory storing instructions; and
a processor that executes the instructions, wherein execution of the instructions by the processor causes the processor to:
generate, during an exploration phase, a plurality of modifications to the first machine learning model, wherein each of the plurality of modifications is associated with at least one respective unit of the first machine learning model;
track, during the exploration phase, respective changes to a processing characteristic corresponding to a plurality of modified variants of the first machine learning model process a test dataset to generate a plurality of respective results, wherein each of the plurality of modified variants of the first machine learning model corresponds to one of the plurality of modifications to the first machine learning model;
identify, using the second machine learning model and during an optimization phase and based on context, a modification to the first machine learning model that adjusts the processing characteristic of the first machine learning model in a predetermined direction, wherein the context is associated with the plurality of modifications and the respective changes to the processing characteristic; and
modify the first machine learning model according to the modification to generate a modified first machine learning model.

20. A non-transitory computer readable storage medium having embodied thereon a program, wherein the program is executable by a processor to perform a method of optimizing a first machine learning model using a second machine learning model, the method comprising:
generating, during an exploration phase, a plurality of modifications to the first machine learning model, wherein each of the plurality of modifications is associated with at least one respective unit of the first machine learning model;
tracking, during the exploration phase, respective changes to a processing characteristic corresponding to a plurality of modified variants of the first machine learning model processing a test dataset to generate a plurality of respective results, wherein each of the plurality of modified variants of the first machine learning model corresponds to one of the plurality of modifications to the first machine learning model;
identifying, using the second machine learning model and during an optimization phase and based on context, a modification to the first machine learning model that adjusts the processing characteristic of the first machine learning model in a predetermined direction, wherein the context is associated with the plurality of modifications and the respective changes to the processing characteristic; and
modifying the first machine learning model according to the modification to generate a modified first machine learning model.
